(19) United States
(12) Patent Application Publication
(10) Pub. No.: US 2026/0075341 A1
(43) Pub. Date: Mar. 12, 2026

(54) System And Method For Dynamic Network Device Configuration And Management Using Transformer Models And Federated Learning

(71) Applicant: VEEA INC., New York, NY (US)

(72) Inventor: Clint SMITH, New York, NY (US)

(21) Appl. No.: 19/321,725

(22) Filed: Sep. 8, 2025

Related U.S. Application Data
(60) Provisional application No. 63/691,501, filed on Sep. 6, 2024.
(60) Provisional application No. 63/691,522, filed on Sep. 6, 2024.
(60) Provisional application No. 63/691,537, filed on Sep. 6, 2024.
(60) Provisional application No. 63/691,560, filed on Sep. 6, 2024.
(60) Provisional application No. 63/691,649, filed on Sep. 6, 2024.

(51) Int. Cl. H04Q 9/00; G06N 3/0455; G06N 3/098; H04L 67/12

(52) U.S. Cl. CPC H04Q 9/00; G06N 3/0455; G06N 3/098; H04L 67/12

(57) ABSTRACT

Systems and methods for configuring and managing a network device with a transformer model under control of a network control function (NCF) are disclosed. A processor of the NCF receives a request that identifies a network management task and associated service targets. The processor forms a token set of schema-defined tokens that represent network context, applies positional encodings to generate an ordered token sequence, and invokes the transformer model to produce a configuration patch. The configuration patch is validated against a schema-constrained decoder that enforces device grammar and is applied to the target network device. Device state and telemetry are read back to obtain a read-back state, which is evaluated against the service targets. When telemetry deviates, the processor generates a further configuration patch that modifies a bounded subset of parameters relative to the read-back state to restore compliance

### RELATED APPLICATIONS

This application claims the benefit of priority to each of U.S. Provisional Patent Application No. 63/691,522 entitled “System And Method for Dynamically Configuring and Managing a Heterogeneous Network with Artificial Intelligence (AI)” filed on Sep. 6, 2024; U.S. Provisional Patent Application No. 63/691,501 entitled “System And Method For Dynamically Configuring And Managing A Network Using A Generative Artificial Intelligence (AI) Model” filed on Sep. 6, 2024; U.S. Provisional Patent Application No. 63/691,537 entitled “System And Method For Dynamic Network Device Configuration And Management Using Transformer Models And Federated Learning” filed on Sep. 6, 2024; U.S. Provisional Patent Application No. 63/691,560 entitled “System And Method For Artificial Intelligence (AI) Federated Learning Based Dynamic Network Device Configuration And Management” filed on Sep. 6, 2024; and U.S. Provisional Patent Application No. 63/691,649 entitled “System And Method For AI Driven Dynamic Network Device Configuration And Optimization” filed on Sep. 6, 2024, the entire contents of each of which are hereby incorporated by reference in their entirety for all purposes.

### BACKGROUND

Modern communication networks interconnect diverse devices including routers, switches, access points, base stations, and user equipment across wired, wireless, and satellite domains. These devices operate under a variety of protocols and standards that define routing, switching, security, and quality-of-service (QoS) enforcement. The growing use of fifth-generation (5G), Wi-Fi 6, and multi-access edge computing (MEC) infrastructures has increased the density and heterogeneity of network environments.

Network management practices involve provisioning device configurations, monitoring performance, and ensuring compliance with service level agreements (SLAs). These operations may depend on data such as device identifiers, firmware versions, hardware capabilities, and observed performance metrics including throughput, latency, jitter, and packet loss. Such data may be produced continuously by devices and collected for analysis and adjustment of operational parameters.

Artificial intelligence (AI) and machine learning (ML) techniques are being explored to process structured and unstructured network data, to model network behavior, and to improve orchestration of services across domains. Approaches such as transformer-based models, tokenization of input parameters, and federated learning have been developed in other fields and are increasingly studied in the context of communications networks. These developments highlight the technical challenges of operating heterogeneous infrastructures while maintaining predictable service quality.

Conventional automation relies on static templates and manual crosswalks between domains and lacks closed-loop correction and provenance control. A need remains for tokenized control with transformer-driven inference and federated updates that produce minimal device-specific patches with audit support.

### SUMMARY

Various aspects include methods executed by one or more processors of a network control function (NCF) that operate an integrated control path for a target network device, the method which may include receiving a request that identifies a network management task and associated service targets, forming a token set which may include schema-defined tokens that represent network context, in which the network context may include the service targets and at least one or more of device capability, policy, topology, or telemetry, assigning positional encodings to the token set to generate an ordered token sequence, invoking a transformer model to process the ordered token sequence and to generate a configuration patch, validating the configuration patch via a schema-constrained decoder that enforces a device grammar, applying the configuration patch to the target network device, reading back applied device state and telemetry from the target network device to obtain a read-back state, determining whether the telemetry deviates from the service targets, and generating a further configuration patch that modifies only a bounded subset of parameters relative to the read-back state responsive to determining that the telemetry deviates from the service targets.

In some aspects, executing the transformer model to process the ordered token sequence and to generate the configuration patch may further include invoking, by one or more processors, a large network model (LNM) that computes embeddings, computing, by the LNM, embeddings of a problem-feature vector derived from the ordered token sequence and embeddings of a plurality of algorithm-feature vectors maintained by the LNM, determining, by the LNM, a similarity score between the problem-feature vector embedding and each algorithm-feature vector embedding and selecting a configuration algorithm responsive to determining a similarity score meets a defined threshold, and generating, by the transformer model, the configuration patch according to the selected configuration algorithm.

In some aspects, assigning positional encodings may further include assigning weighting values that bias attention toward tokens representing congestion, device proximity, or available bandwidth. In some aspects, generating the further configuration patch may include computing a difference between an intended state and the read-back state. In some aspects, validating the configuration patch may include verifying token types, field ranges, and command order against a device grammar. In some aspects, the configuration patch may include an ordered sequence of device-specific commands in a syntax selected from command line interface (CLI), yet another next generation (YANG) data modelling language, JavaScript object notation (JSON) format, or application programming interface (API) calls.

In some aspects, applying the configuration patch may further include executing rollback guards responsive to a failed precondition. In some aspects, further which may include attaching provenance metadata which may include a hash, timestamp, and model version identifier to each configuration patch. In some aspects, the transformer model enforces per-token positional encodings that preserve dependency among device capability, policy, and telemetry tokens.

Further aspects may include a computing device having a processor configured with processor-executable instructions to perform various operations corresponding to the methods discussed above.

Further aspects may include a computing device having various means for performing functions corresponding to the method operations discussed above.

Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary aspects of the embodiments, and together with the general description given above and the detailed description given below, serve to explain the features of the embodiments.

FIG. 1 is a block diagram illustrating input network tokens to a transformer and an output configuration script for a network element in accordance with some embodiments.

FIG. 2 is a flow diagram illustrating an active feedback loop from a network element to the transformer for configuration refinement in accordance with some embodiments.

FIG. 3 is a block diagram illustrating a slice controller that receives transformer outputs and applies network configuration in accordance with some embodiments.

FIGS. 4A and 4B are flowchart diagrams illustrating device boot, discovery, policy intake, transformer processing, and configuration update in accordance with some embodiments.

FIG. 5 is a block diagram illustrating the components of a large network model (LNM), including pre-training, fine-tuning, tokenization, embedding, and attention, in accordance with some embodiments.

FIG. 6 is a process diagram illustrating a bidirectional algorithm selection approach based on problem features and algorithm features in accordance with some embodiments.

FIG. 7 is a decision diagram illustrating algorithm matching to a problem set and selection when correlation thresholds vary in accordance with some embodiments.

FIG. 8 is a sequence diagram illustrating a network control function (NCF) that submits a problem set to a transformer and receives a patch in accordance with some embodiments.

FIG. 9 is a block diagram illustrating a NCF with bandwidth service class, QoS, policy, preplan, topology, deployment, monitoring, maintenance, configuration, and end functions in accordance with some embodiments.

FIGS. 10A and 10B are system diagrams illustrating a cloud-hosted controller and transformer with an edge computing device and Wi-Fi access point in accordance with some embodiments.

FIGS. 11A and 11B are system diagrams illustrating a controller embedded at the edge computing device with a cloud transformer in accordance with some embodiments.

FIGS. 12A and 12B are system diagrams illustrating both controller and transformer local to an edge computing device in accordance with some embodiments.

FIGS. 13A and 13B are system diagrams illustrating local controller and transformer with learning updates exchanged with a cloud model in accordance with some embodiments.

FIG. 14 is a flow diagram illustrating token weighting and positional encoding for device and service selection during configuration in accordance with some embodiments.

FIG. 15 is a process flow diagram illustrating dynamic configuration and management of a heterogeneous network in accordance with some embodiments.

FIG. 16 is a process flow diagram illustrating dynamic configuration using an algorithm selection method aligned to a device and problem set in accordance with some embodiments.

FIG. 17 is a process flow diagram illustrating another depiction of dynamic configuration and management of a heterogeneous network in accordance with some embodiments.

FIG. 18 is a process flow diagram illustrating a method of tokenized closed-loop configuration of a network device with a network control function (NCF) and a transformer model that invokes a large network model (LNM) for similarity-scored algorithm selection and emits schema-constrained configuration patches with read-back telemetry and diff-based refinement in accordance with some embodiments.

FIG. 19 is a process flow diagram illustrating a method of autonomous local configuration at an edge device with a local transformer that generates schema-constrained patches and transmits model-delta updates for federated aggregation in accordance with some embodiments.

FIG. 20 is a process flow diagram illustrating a method of federated aggregation at an aggregator server in accordance with some embodiments.

FIG. 21 is a process flow diagram illustrating a method of configuring and managing a network device under an integrated control path in accordance with some embodiments.

FIG. 22 is a process flow diagram illustrating a method of dynamic configuration and management with a network orchestration transformer model (NOTM) that tokenizes device attributes in accordance with some embodiments.

FIG. 23 is a process flow diagram illustrating a method of edge-resident configuration that sustains operation without cloud connectivity and synchronizes model-delta updates when connectivity returns in accordance with some embodiments.

FIG. 24 is a process flow diagram illustrating a method of federated learning and dynamic network management in accordance with some embodiments.

FIG. 25 is a process flow diagram illustrating a method of enhancing configuration patches for a network device with weighted information in accordance with some embodiments.

FIG. 26 is a process flow diagram illustrating a method of enforcing slice service targets across heterogeneous network domains with an AI slice controller in accordance with some embodiments.

FIG. 27 is a process flow diagram illustrating a method of autonomous configuration of a local network component at an edge device with a NOTM in accordance with some embodiments.

FIG. 28 is a process flow diagram illustrating a method of multi-domain orchestration across radio access Wi-Fi edge and non-terrestrial segments in accordance with some embodiments.

FIG. 29 is a process flow diagram illustrating a method of per-slice scheduling enforcement in a Wi-Fi access point in accordance with some embodiments.

FIG. 30 is a process flow diagram illustrating a method of federated learning and parameter synchronization across distributed nodes in accordance with some embodiments.

FIG. 31 is a process flow diagram illustrating a method of generating selective configuration patches with predictive weighting in accordance with some embodiments.

FIG. 32A is a component block diagram that illustrates an example computing and processing system suitable for implementing the various embodiments.

FIG. 32B is a component block diagram that illustrates an edge device that interconnected modules designed for specialized and general-purpose computations in distributed edge computing systems.

FIG. 33 is a block diagram illustrating a server computing device with processors, memory, storage, and network interfaces in accordance with some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

The word “exemplary” may be used herein to mean “serving as an example, instance, or illustration”. Any implementation described herein as “exemplary” is not necessarily to be construed as preferred or advantageous over other implementations.

In overview, the embodiments include a processing system that executes a network control function (NCF). The processing system may receive a request that specifies a network-management task and service targets and form a token set of schema-defined tokens that represent network context. The network context may include the service targets and at least one of device capability, policy, topology, or telemetry. The processing system may assign positional encodings to the token set to generate an ordered token sequence. The processing system may invoke a transformer model to process the ordered token sequence and to generate a configuration patch, validate the configuration patch through a schema-constrained decoder that enforces device grammar, apply the validated configuration patch to a target network device through a transactional interface, read back applied device state and telemetry from the target network device to obtain a read-back state, and determine whether the telemetry deviates from the service targets. When deviation is present, the processing system generates a further configuration patch that modifies a bounded subset of parameters relative to the read-back state. As such, the embodiments provide a closed-loop, token-driven, transformer-based orchestration process that adapts device behavior while preserving safety, auditability, and consistency across heterogeneous network elements.

The embodiments provide a network controller that configures routers, switches, or access points in an adaptive manner. The processing system may interpret service goals and policies, translate the service goals and policies into schema-defined tokens, generate configuration patches that comply with device grammar, and apply the configuration patches to the device. The processing system may verify the configuration outcome through read-back telemetry and adjust bounded subsets of parameters when drift from service targets occurs. As such, the system operates as an automated control path for network devices that receives service goals, generates patches, verifies application, and applies bounded corrections without service disruption.

The embodiments include a technical arrangement that differs from conventional systems. Conventional automation systems generate broad templates or static scripts. The disclosed embodiments implement schema-defined tokens that capture device and service context, positional encodings that preserve dependencies, and an algorithm-selection process that uses feature embeddings and similarity scoring. The processing system may apply configuration patches that are validated against device grammar and issue bounded corrections relative to read-back state. The embodiments integrate machine learning with strict device grammar enforcement and diff-based patching under common control. The combination of transformer-based inference, schema validation, and bounded patching under a single control path crosses technical boundaries between machine-learning models, device protocols, and transactional safety.

The embodiments may improve the performance of computing and networking systems. The processing system reduces downtime by generating minimal configuration patches instead of full device reconfigurations. Transactional application shortens commit time and avoids traffic disruption. Schema-constrained decoding prevents unsafe or invalid commands and lowers configuration error rates. Read-back evaluation with bounded patching allows the processing system to adapt to network conditions such as latency or congestion while maintaining service targets. Federated updates for the large network model permit distributed devices to share improvements without exporting raw data, improving consistency and convergence. The combined effect increases reliability, adaptability, and efficiency compared to conventional configuration approaches.

The term “computing device” may be used herein to refer to a physical apparatus that includes at least one programmable processing unit that executes processor-executable instructions stored in non-transitory memory. A computing device may include memory, storage, and one or more interfaces for wired or wireless data exchange. A computing device may include an interconnect that couples components. Examples of a computing device include a general-purpose computer, an edge node, a gateway, a router, a switch, an access point, a modem, a laptop, a tablet, a smartphone, a wearable, a media player, a gaming system, an industrial controller, and an Internet-of-Things (IoT) device.

The term “processing system” may be used herein to refer to one processor or a plurality of processors that execute processor-executable instructions from non-transitory memory. A processor may include a central processing unit (CPU), a graphics processing unit (GPU), a digital signal processor (DSP), an application-specific integrated circuit (ASIC), a field-programmable gate array (FPGA), a tensor processing unit (TPU), or another programmable processor. A processing system may coordinate device input and output operations and may manage memory access and interconnect resources.

The term “neural network” may be used herein to refer to a machine-implemented arrangement of processing nodes with weighted connections that represent a learned function. Each node may apply a mathematical function to input values and may produce an activation as output. A neural network may be trained to update weight values and once trained may perform inference by applying stored weight values to new input values.

The term “inference” may be used herein to refer to execution of a trained machine learning model by a processing system to compute output values from input values at runtime. Inference may include applying stored weight values to traverse nodes along a forward path and may include feedback paths.

The term “deep neural network” (DNN) may be used herein to refer to a neural network that includes multiple layers of nodes between input and output. A DNN may include an input layer, intermediate layers, and an output layer. Intermediate layers may include convolutional, recurrent, attention-based, or feed-forward layers with activation functions.

The term “transformer” may be used herein to refer to a neural network architecture that includes a self-attention mechanism for computing contextual relationships among tokens. A transformer may include an encoder, a decoder, or both, and may process tokens in parallel. A transformer may learn attention weights and feed-forward weights during training and may generate ordered outputs at inference.

The term “large AI model” may be used herein to refer to a machine-implemented model stored in non-transitory memory and executed by a processing system that includes a high number of parameters and that performs complex tasks across one or more domains. A large AI model may include a transformer, a recurrent neural network, a long short-term memory network, or a combination thereof. Examples of a large AI model include a large language model (LLM), a large speech model (LSM), a large vision model (LVM), a vision-language model (VLM), and a multimodal model.

The term “embedding layer” may be used herein to refer to a neural network layer executed by a processing system that maps tokens into continuous vector representations. An embedding layer may convert tokens into vectors of fixed dimension and may update the vectors during training so that the vectors capture semantic or structural attributes.

The term “token” may be used herein to refer to a machine-readable data structure that represents a minimal unit of information for training or inference by a model. A token may represent a text unit such as a word, a subword, or a character, an audio unit such as a phoneme or a frame, or a vision unit such as an image patch or a video segment. A token may include metadata such as a type identifier, a position index, a timestamp, or a provenance identifier.

The term “sequence data processing” may be used herein to refer to a process performed by a processing system that operates on an ordered set of tokens while preserving dependencies among the tokens. Sequence data processing may include generating a probability distribution over candidate next tokens, selecting or sampling from that distribution, and appending the token to extend the sequence.

The term “network token” (nToken) may be used herein to refer to a machine-readable data structure that encodes a network-related entity, attribute, or policy. A network token may include a type identifier, capability attributes, protocol attributes, policy attributes, integrity metadata, or a sequence index. A processing system may input a network token to a transformer or a controller to generate device configuration directives.

The term “network-context token set” may be used herein to refer to a collection of machine-readable data structures that together describe network context for inference. A network-context token set may include one or more network tokens that represent device capabilities, service targets, policy rules, topology, telemetry, identity, cross-domain mappings, algorithm selection hints, and provenance.

The term “device-identity token” may be used herein to refer to a machine-readable data structure that encodes a device identifier for use in orchestration and audit. A device-identity token may include a salted hash of a media access control (MAC) address, a serial number, or another hardware identifier, thereby preserving uniqueness while preventing disclosure of the raw identifier. A device-identity token may be included in a network-context token set, a configuration patch, or a tamper-evident log.

The term “group service token” (GST) may be used herein to refer to a machine-readable data structure that encodes a service class together with quality-of-service bounds. A group service token may include throughput, latency, jitter, and packet-loss targets associated with a defined service class.

The term “service level agreement token” (SLA token) may be used herein to refer to a machine-readable data structure that encodes contractual service terms. A service level agreement token may include a guaranteed bit rate, a maximum bit rate, an allocation or retention priority, a maximum delay, and admission rules.

The term “key performance indicator token” (KPI token) may be used herein to refer to a machine-readable data structure that encodes one or more performance metrics. A key performance indicator token may include latency, jitter, packet loss, or throughput values together with timestamps.

The term “5G quality-of-service identifier token” (5QI token) may be used herein to refer to a machine-readable data structure that represents a 5G-defined quality class. A 5QI token may encode a packet-delay budget, a packet-error rate, and a flow type. A processing system may map a 5QI token to differentiated services code point (DSCP) values and Wi-Fi user priorities.

The term “mapping token” may be used herein to refer to a machine-readable data structure that represents a correspondence among identifiers across domains. A mapping token may define relationships among DSCP values, Wi-Fi user priorities, and 5QI values.

The term “virtual local area network token” (VLAN token) may be used herein to refer to a machine-readable data structure that encodes VLAN-related configuration or policy. A VLAN token may include policing thresholds, shaping rates, queue mappings, and DSCP rewrite rules.

The term “traffic shaping token” may be used herein to refer to a machine-readable data structure that encodes shaping parameters for traffic control. A traffic shaping token may include shaping rate, burst size, excess burst size, and buffer depth.

The term “service pack token” may be used herein to refer to a machine-readable data structure that encodes device capabilities and baseline key performance indicator bounds. A service pack token may include firmware versions, feature sets, and minimum performance thresholds.

The term “virtual token-based assignment” (vTBA) may be used herein to refer to a process executed by a processing system that creates a binding between a group service token (GST) and a network segment identifier. A vTBA may bind a GST to a virtual local area network (VLAN) identifier or a virtual private network (VPN) identifier across uplink and downlink paths. A vTBA may carry a committed information rate and a peak information rate per slice and per direction, and may be used to enforce consistent service treatment across wired and wireless segments.

The term “vTBA token” may be used herein to refer to a machine-readable data structure that encodes a binding between a GST and a network segment identifier. A vTBA token may include fields that represent a throughput target, a latency target, and a service class for a user or device group.

The term “resource unit assignment” (RU assignment) may be used herein to refer to allocation of frequency-domain resource units to slices under control of a Wi-Fi access point scheduler. A resource unit assignment may bind a GST to a pool of resource units and may schedule packets within that pool so that each slice is given dedicated physical resources for uplink and downlink transmissions.

The term “model-delta vector” may be used herein to refer to a machine-readable data structure that encodes parameter updates produced by a machine learning model during training or refinement. A model-delta vector may represent numerical differences between an earlier parameter set and a current parameter set. A processing system in an edge device may generate a model-delta vector and transmit it to an aggregator, which may compute a weighted average, validate the aggregated vector, and distribute updated parameters.

The term “customized generative pre-trained transformer” (vGPT) may be used herein to refer to a transformer-based model implemented by a processing system that is trained and adapted for network configuration and orchestration. A vGPT may include an embedding layer, a position-encoding module, a transformer backbone, and an output mapper constrained by a schema. A vGPT may accept sequences of network tokens including GSTs, SLA tokens, VLAN tokens, mapping tokens, 5QI tokens, KPI tokens, and device-identity tokens, and may generate device directives as CLI commands, API calls, or equivalent outputs. A vGPT may enforce schema constraints during decoding, may attach provenance metadata, may operate as a containerized service, and may accept model-delta vectors for federated learning updates.

The term “large network model” (LNM) may be used herein to refer to a machine-implemented model stored in non-transitory memory and executed by a processing system for network orchestration. An LNM may include a tokenizer for network tokens, an embedding layer, a position-encoding module, a transformer backbone, an algorithm-selection module, and a cross-domain mapping module. An LNM may accept network tokens representing SLA terms, service targets, topology, and telemetry, and may output network tokens representing configuration patches, scheduling parameters, resource allocations, and mapping entries across Wi-Fi, Ethernet, and cellular domains.

The term “containerized large network model” (cLNM) may be used herein to refer to an LNM packaged as a signed container image stored in non-transitory memory and executed under a container runtime. A cLNM may accept network tokens, compute attention across them, and output network tokens representing device-configuration patches, router updates, scheduler values, or mapping rows. A cLNM may expose REST or RPC interfaces, may enforce container resource limits, may accept model-delta vectors, and may maintain tamper-evident logs of inputs and outputs.

The term “schema-constrained decoder” may be used herein to refer to a decoder executed by a processing system that enforces a declared grammar during generation of network tokens. A schema-constrained decoder may validate token types, field ranges, and command order for a device family and may reject a sequence of tokens that fails validation.

The term “small large network model” (SLNM) may be used herein to refer to a reduced LNM stored in non-transitory memory and executed by a processing system suitable for constrained devices. An SLNM may perform tasks such as Wi-Fi scheduling, VLAN enforcement, or rate limiting.

The term “network orchestration transformer model” (NOTM) may be used herein to refer to a transformer-based model system for tokenized configuration and orchestration of networks. A NOTM may be implemented as a vGPT, an LNM, a cLNM, or an SLNM, and may also include coordinated arrangements of those models. A NOTM may accept network tokens such as GSTs, SLA tokens, KPI tokens, mapping tokens, VLAN tokens, 5QI tokens, device-identity tokens, and topology tokens. A NOTM may output network tokens representing device-configuration patches, scheduling parameters, resource allocations, and mapping entries for Wi-Fi, Ethernet, cellular, and non-terrestrial domains. A NOTM may enforce schema constraints, may attach provenance metadata, may operate as a containerized service, and may participate in federated learning using model-delta vectors.

The term “service targets” may be used herein to refer to a machine-readable data structure that encodes performance objectives for a service class. Service targets may include latency, jitter, packet loss, throughput, and admission rules, and may be derived from an SLA token.

The term “network control function” (NCF) may be used herein to refer to a computing component executed by a processing system that orchestrates provisioning, deployment, monitoring, and termination of configurations and slices. An NCF may generate problem sets, form network tokens, invoke a transformer model, receive a configuration patch, apply the configuration patch to devices, and expose APIs and counters for verification.

The term “configuration patch” may be used herein to refer to a machine-readable data structure that encodes device directives to update a bounded subset of configuration parameters. A configuration patch may be represented as a configuration script or API calls and may be applied relative to a read-back state.

The term “configuration script” may be used herein to refer to a machine-readable data structure that encodes a configuration patch as CLI commands or API calls for a target device family.

The term “bounded subset” may be used herein to refer to a defined group of configuration parameters that a configuration patch modifies while unrelated parameters remain unchanged.

The term “radio access network intelligent controller” (RIC) may be used herein to refer to a controller executed by a processing system in a radio access network that hosts machine learning modules, enforces policies, and optimizes resource allocation.

The term “federated learning” may be used herein to refer to a training process in which a plurality of devices compute local model-delta vectors and transmit them to an aggregator that averages and validates them into a global model.

The term “federated control layout” may be used herein to refer to an architecture in which local machine learning modules on edge devices exchange model-delta vectors with a coordinator for aggregation and redistribution.

The term “functional plane” (FP) may be used herein to refer to a logical layer in a network that hosts inference engines and transformers in parallel with a control plane and a data plane.

The term “multi-access edge computing” (MEC) may be used herein to refer to an architecture that places computing and storage resources near access points to host applications and models.

The term “edge device” may be used herein to refer to a computing device that executes MEC functions and may host orchestration models for localized configuration.

The term “quality of service” (QoS) may be used herein to refer to latency, jitter, packet loss, throughput, and the policies that govern those metrics.

The term “key performance indicator” (KPI) may be used herein to refer to a measurable performance metric such as latency, packet-error rate, or throughput.

The term “non-terrestrial network” (NTN) may be used herein to refer to a domain that includes satellites in low Earth orbit, medium Earth orbit, geostationary orbit, or very low Earth orbit, that interoperates with terrestrial networks.

The term “Wi-Fi access point scheduler” may be used herein to refer to a process executed by a processing system in a Wi-Fi access point that assigns airtime, resource units, and queues. A Wi-Fi access point scheduler may use network tokens to inform scheduling.

The term “orthogonal frequency-division multiple access token” (OFDMA token) may be used herein to refer to a machine-readable data structure that encodes subcarrier units, coding schemes, and queues for multi-user transmissions.

The term “multi-user multiple-input multiple-output token” (MU-MIMO token) may be used herein to refer to a machine-readable data structure that encodes antenna counts, modulation schemes, and stream allocations for simultaneous transmissions.

The term “dynamic flow inspection” (DFI) may be used herein to refer to a process executed by a processing system that classifies flows based on packet length, inter-arrival times, and directionality without payload decryption. DFI may use header metadata and timing features, and classifiers may be updated using federated learning without exporting raw traffic.

The term “bidirectional algorithm selection” may be used herein to refer to a process executed by a processing system that compares a problem feature vector and an algorithm feature vector to select a solution.

The term “retrieval-augmented generation” (RAG) may be used herein to refer to a transformer executed by a processing system that integrates external retrieval with generation of tokens to produce outputs that reflect up-to-date information without retraining.

The term “bidirectional feedback loop” may be used herein to refer to a process executed by a processing system in which monitoring data is converted into tokens, processed by a transformer, and used to refine device configuration with new monitoring data providing further inputs.

The term “AI slice controller” (AISC) may be used herein to refer to a processing system implemented in hardware, software, or both that manages the lifecycle of network slices using tokens and transformers. An AI slice controller may tokenize slice requests into SLA tokens, GSTs, device-identity tokens, topology tokens, and other tokens, may input the tokens into a NOTM, may generate configuration patches, and may distribute those configuration patches to routers, switches, access points, and base stations. An AI slice controller may aggregate model-delta vectors, compute a weighted average, validate the result, and distribute updated parameters.

The term “network slice” may be used herein to refer to a logically defined partition of a communications network with reserved resources and policies that enforce throughput, latency, jitter, and packet-loss bounds. A network slice may include computing devices, virtual functions, and policies represented by tokens such as GSTs, SLA tokens, and KPI tokens.

The term “network slicing” may be used herein to refer to a process executed by a processing system to generate, deploy, and manage multiple network slices across shared infrastructure. Network slicing may allocate resources, instantiate virtual functions, apply slice-specific policies, and adjust allocations based on KPI tokens.

The term “salted hash” may be used herein to refer to a machine-readable data structure generated by applying a hash function to an input combined with a random or pseudo-random salt. A salted hash may ensure that identical inputs produce distinct values, may be used in a device-identity token, and may provide forward integrity in a tamper-evident log.

The term “tamper-evident log” may be used herein to refer to a machine-readable data structure that records entries in sequence, each entry including a cryptographic value derived from a previous entry, so that modification of an earlier entry is detectable. A tamper-evident log may include timestamps, device identifiers, model version identifiers, and salted hashes.

The term “schema-defined token” may be used herein to refer to a machine-readable data structure that conforms to a declared schema specifying field names, field types, value ranges, and serialization order. A schema-defined token may include a type identifier, payload fields, a provenance tag, a position index, and an integrity value.

The term “network context” may be used herein to refer to a normalized information set expressed as schema-defined tokens. A network context may include tokens representing device capability, service targets, policy, topology, telemetry, identity, cross-domain mappings, algorithm selection hints, and provenance.

The term “positional encodings” may be used herein to refer to numeric codes assigned to tokens by a processing system to preserve sequence order and class so that a transformer interprets dependencies across tokens.

The term “problem feature vector” may be used herein to refer to a machine-readable data structure that encodes attributes derived from a problem set for comparison with algorithm feature vectors. A problem feature vector may encode service objectives, constraints, device type, load indicators, and KPI values.

The term “algorithm feature vector” may be used herein to refer to a machine-readable data structure that encodes attributes of a candidate algorithm for comparison against a problem feature vector. An algorithm feature vector may encode expected accuracy, inference latency, memory footprint, execution cost, and compatibility constraints.

The term “read-back state” may be used herein to refer to a machine-readable data structure that records configuration values and runtime counters obtained from a device after application of a configuration patch. A read-back state may include applied parameter values, KPI values, timestamps, and identifiers, and may serve as a baseline for computing a bounded subset for a subsequent configuration patch.

The embodiments include a multi-tiered AI system for tokenized, transformer-driven, federated, and closed-loop configuration of heterogeneous networks. The multi-tiered AI system may include a processing system (which may be implemented within an edge device such as a MEC node, a router, a Wi-Fi access point, a smart switch, a smartphone, etc.) that is configured to dynamically configure and manage heterogeneous network devices by transforming device and network context into typed tokens and processing those tokens through a transformer pipeline. During a device boot or discovery sequence, the processing system may obtain metadata such as a Media Access Control (MAC) address, device serial number, firmware version, operating system, port availability, and supported protocols. The processing system may tokenize this information along with network context data (e.g., topology, load, quality-of-service (QoS) requirements, and resource constraints) and construct a position-encoded token sequence. A NOTM may process the sequence and generate device-specific configuration outputs. The outputs may include configuration for access control lists (ACLs), routing protocols, virtual private networks (VPNs), bandwidth allocations, or traffic-shaping rules. The processing system may apply the outputs to local elements through command line interface (CLI) transactions, application programming interface (API) calls, or controller intents and may record each applied directive in a tamper-evident log that includes a timestamp, a hash, and a model version identifier.

Conventional network configuration systems rely on static templates, vendor-specific syntax, and siloed controllers. A processing system in such an environment parses pre-defined configuration files without context from real-time telemetry or cross-domain dependencies. This creates long reaction times when network conditions change because configuration updates are reapplied in bulk rather than as incremental patches. These conventional solutions often cause churn and downtime as devices reload full templates. Manual crosswalks between Wi-Fi user priority values, Ethernet differentiated services code point (DSCP) values, and Fifth-Generation (5G) quality-of-service (QoS) identifiers are typically maintained in spreadsheets or static tables and deviate from real conditions over time. As a result, service treatment becomes inconsistent across access domains. Conventional solutions also lack provenance metadata, limiting the ability to audit whether changes satisfied SLA targets. These deficiencies restrict both agility and reliability in large-scale, heterogeneous networks.

The embodiments overcome these and other technical challenges and limitations of conventional solutions by using a unified token schema and transformer-based inference to emit minimal, device-specific configuration patches rather than wholesale reconfigurations. The processing system may embed tokens with positional encodings so that dependencies among tokens remain explicit and reproducible. An AISC may maintain a mapping table that aligns Wi-Fi user priorities, DSCP values, and 5QI identifiers. The AISC may update the mapping table when telemetry tokens such as KPI tokens show deviation from SLA thresholds (e.g., increased jitter, packet loss, or latency). A cLNM may execute under a runtime such as Docker or Kubernetes and may accept model-delta updates through a federated learning framework, allowing locally observed improvements to propagate globally without transferring raw data. Interfaces and artifacts may be secured through mTLS, signed container images, and authenticated service accounts. Each configuration directive may be logged in a tamper-evident record that supports end-to-end auditability.

The embodiments improve the functioning of network orchestration through measurable performance gains. Configuration convergence may be achieved with fewer transactions per change, thereby reducing device overhead and minimizing disruptions to live traffic. Schema-constrained decoding may reduce misconfigurations by validating outputs against device capabilities and policy rules before deployment. Closed-loop refinement using KPI tokens may allow the system to restore SLA compliance quickly during congestion or device failures. Cross-domain mappings maintained by the AISC may ensure consistent treatment of flows across Wi-Fi, Ethernet, and cellular segments, thereby reducing jitter and packet loss for latency-sensitive applications such as real-time voice or video. Containerized deployment with provenance logging may permit safe rollouts and controlled rollbacks of model updates without service interruption. In aggregate, these operations yield a processing system that addresses configuration complexity, improves resilience to dynamic conditions, and enhances the technical functioning of heterogeneous network infrastructure. The tamper-evident log may use hash chaining. Each entry may contain a hash of the previous entry, a timestamp, a device identifier, a model version identifier, and a checksum of the applied patch. A secure boot process or a hardware root of trust may anchor the log signer on supported devices.

In addition, schema-constrained decoding reduces configuration errors. Delta patches shorten commit time and lower disruption. Cross-domain mappings maintain QoS alignment. Edge autonomy sustains service during controller loss. A federated process improves model quality without raw data export. These operations enhance throughput and stability and shorten recovery after a disturbance.

Some embodiments may include a processing system configured to represent network elements and functions as network tokens that encode routing attributes, packet treatment rules, and flow-adjustment logic. The processing system may process the tokens through a transformer or LNM to generate configurations that dynamically adjust routing behavior based on service demands.

Some embodiments may include a processing system configured to execute both a transformer and a cLNM. The processing system may receive tokens representing topology (e.g., port availability, routing protocols, link states), policy (e.g., access control lists, QoS rules, traffic-shaping rules), and service class (e.g., platinum, gold, silver). The processing system may embed the tokens into high-dimensional vectors with positional encodings that preserve contextual order. The transformer and cLNM may process the vectors and output device-specific configuration patches. The processing system may format the scripts as CLI commands, API calls, or controller intents and may apply them to local devices such as routers, switches, or Wi-Fi access points.

Some embodiments may include a processing system configured to enforce end-to-end QoS across heterogeneous segments, including Wi-Fi, Ethernet, and cellular networks. The processing system within an AISC may maintain a mapping table that aligns Wi-Fi user priorities, 5QI tokens, and Ethernet DSCP values. The AISC may update the mapping table when telemetry encoded as KPI tokens indicates deviation from service targets, such as increased jitter or packet loss. By maintaining accurate mappings, the AISC may enforce consistent cross-domain QoS.

In some embodiments, a processing system within a Wi-Fi access point may be configured to support multi-user multiple-input multiple-output (MU-MIMO) scheduling. The processing system may generate tokens that encode device attributes, such as antenna count and modulation scheme, and may process those tokens through a transformer. The transformer output may define a schedule script that allocates spatial streams across devices in a way that satisfies QoS objectives. The processing system may apply the schedule script to the access point's radio scheduler.

In some embodiments, a processing system within a Wi-Fi 6 (802.11ax) access point may be configured to tokenize orthogonal frequency-division multiple access (OFDMA) parameters such as resource-unit (RU) size, modulation and coding scheme (MCS), and client queue depth. The transformer may process these tokens and generate configuration commands that assign RUs to clients based on service class. The processing system may dynamically adapt allocations when KPI tokens reveal changes in channel utilization or latency, thereby maintaining SLA compliance.

In some embodiments, a processing system within a centralized RIC may execute a transformer to coordinate multiple base stations and access points. In federated deployments, processing systems embedded in local edge devices may also execute AI functions and report model-delta updates. A processing system in an overlay coordinator may aggregate the updates and distribute them across the network. This architecture may support fast local inference with global consistency.

Some embodiments may include a processing system configured to implement an AI cube with three operational planes: a control plane, a data plane, and a functional plane. The processing system may process input tokens through a transformer and generate policies for each plane. For example, the transformer may output a control-plane script for slice admission, a data-plane script for packet-forwarding rules, and a functional-plane script for KPI targets. The AISC may collect telemetry, encode KPI tokens, compare them against SLA tokens, and re-invoke the transformer to refine policies, thereby maintaining end-to-end QoS.

Some embodiments may include a processing system configured to configure routing functions across diverse devices, including routers, MEC nodes, smart switches, and smartphones. The processing system may treat routing as a tokenized process, generating device-specific outputs aligned to SLA and policy objectives.

In some embodiments, a processing system embedded in a router may process tokens that represent relationships among network elements and policies. Based on the context, the processing system may generate updated configurations including packet treatment rules, traffic-shaping directives, and prioritization policies. The router may apply these outputs to enforce differentiated service handling based on slice assignment and QoS policy.

Some embodiments may include a processing system configured to generate network tokens that represent hardware elements such as ports, memory, processors, and accelerators, and protocols including routing, Wi-Fi, Bluetooth, or legacy protocols such as X.25 or frame relay. Tokens may also represent ACL and session border controller (SBC) policies. The processing system may convert the tokens into configuration outputs that specify how traffic should be routed, shaped, or prioritized.

Some embodiments may include a processing system configured to interpret tokens not only for an individual device but across a network ecosystem. Tokens may include cooperative behaviors among multiple devices that collectively provide access, apply treatment, and enforce service targets across heterogeneous segments.

Some embodiments may include a processing system configured to execute a NOTM to organize tokens into ordered sequences. The system may output configuration patches as structured sets of commands, each mapped to an intended network element or function.

Some embodiments may include a processing system configured to apply positional encoding to network tokens so that relationships among tokens remain preserved during processing. The transformer may generate outputs that dynamically configure network elements based on SLA terms and traffic conditions.

Some embodiments may include a processing system configured to generate router configuration outputs as examples of NOTM execution. Outputs may include routing table adjustments, QoS policies, ACL entries, SBC directives, and prioritization rules. The router may apply these outputs to adjust packet paths and allocate resources in real time.

Some embodiments may include a processing system configured to continuously monitor network KPIs such as latency, jitter, and packet loss. The processing system may convert telemetry into KPI tokens, reprocess them through the transformer, and output refined configurations. This feedback loop may allow real-time or near real-time adaptation to changing conditions.

Some embodiments may include a processing system configured to adjust routing rules when traffic conditions change, even if the set of network devices remains static. By altering packet treatment policies, the processing system may sustain service targets.

Some embodiments may include a processing system configured to adjust configurations when network elements are added or removed. The processing system may update routing and policy scripts so that traffic continues to comply with SLA terms.

Some embodiments may include a processing system configured to generate traffic-shaping and prioritization rules through NOTM inference. For example, the outputs may include slice-specific traffic policies that are refined through reprocessing of updated KPI tokens.

Some embodiments may include a processing system configured to coordinate transformers executing across multiple devices. Routers may exchange tokenized information such that their NOTM instances remain synchronized and output consistent policies.

Some embodiments may include a processing system configured to embed network tokens into vectors with positional encodings. This embedded sequence may serve as input to transformers for configuration generation.

Some embodiments may include a processing system configured to assign unique numerical or symbolic identifiers to tokens representing elements or functions. The processing system may convert the tokens into dense vectors in a high-dimensional space to preserve semantic relationships.

Some embodiments may include a processing system configured to apply positional encoding to each vector to preserve ordering information. The final embedded tokens may retain both identity and sequence position. The processing system may process the embedded tokens through NOTM to generate configuration outputs for network devices, and the same embedded tokens may be used for subsequent processing stages within the system.

Some embodiments may implement a transformer-driven configuration. The processing system may input token sequences into a NOTM and output device-specific configuration patches. The outputs may be structured as CLI commands, API calls, or controller intents. By emitting minimal patches instead of full templates, the processing system may reduce disruption and improve agility in dynamic network environments.

Some embodiments may implement closed-loop telemetry refinement. The processing system may generate KPI tokens from telemetry such as latency, jitter, packet loss, and throughput. The processing system may reprocess the KPI tokens through a transformer and may update configurations in response to deviations from service targets. This closed-loop approach may allow networks to adapt continuously to traffic and performance conditions.

Some embodiments may implement cross-domain slice enforcement. The processing system may operate as an AISC that maintains a mapping table aligning Wi-Fi priorities, Ethernet DSCP values, and 5QI identifiers. The processing system may update the mapping table dynamically when KPI tokens show SLA deviations. This mapping may maintain consistent end-to-end treatment of flows across heterogeneous domains.

Some embodiments may implement edge and access-point scheduling. A processing system within a Wi-Fi access point may tokenize device capabilities and radio resources and supply those tokens to a transformer. The transformer may output scheduling scripts for MU-MIMO and OFDMA assignments. The scripts may allocate spatial streams and resource units while maintaining QoS targets across multiple clients.

Some embodiments may implement federated and containerized deployment. The processing system may execute a cLNM under a runtime such as Docker or Kubernetes. The cLNM may accept model-delta updates through federated learning, allowing local improvements to propagate globally without sharing raw data. Interfaces and artifacts may be secured through signed images and mTLS.

Some embodiments may implement multi-plane orchestration. The processing system may operate within an AI cube comprising a control plane, a data plane, and a functional plane. The transformer may generate separate scripts for slice admission in the control plane, forwarding policies in the data plane, and performance targets in the functional plane. This separation may support coordinated orchestration across operational layers.

Some embodiments may implement distributed coordination across devices. The processing system may exchange tokenized information among routers and access points so that NOTM instances on each device remain synchronized. By aligning outputs across distributed transformers, the system may enforce consistent policies throughout the network.

Some embodiments may implement an audit and security framework. The processing system may attach provenance metadata to each output directive and store it in a tamper-evident log. Each entry may include a hash, a timestamp, and a model version identifier. Interfaces may be authenticated through mTLS, and container images may be validated with digital signatures. These safeguards may improve auditability and operational trust.

Some embodiments may implement traffic shaping and prioritization. The processing system may be configured to process tokens through a transformer and output slice-specific traffic rules. These outputs may define shaping rates, queue priorities, and per-slice enforcement policies. The processing system may refine outputs dynamically in response to updated KPI tokens.

Some embodiments may implement positional encoding for contextual awareness. The processing system may be configured to assign identifiers and positional values to each token, generating embedded vectors that preserve both identity and order. Transformers may process the embedded tokens and output context-aware configuration patches. This positional framework may allow the system to generate reproducible outputs while maintaining semantic and relational accuracy across tokens.

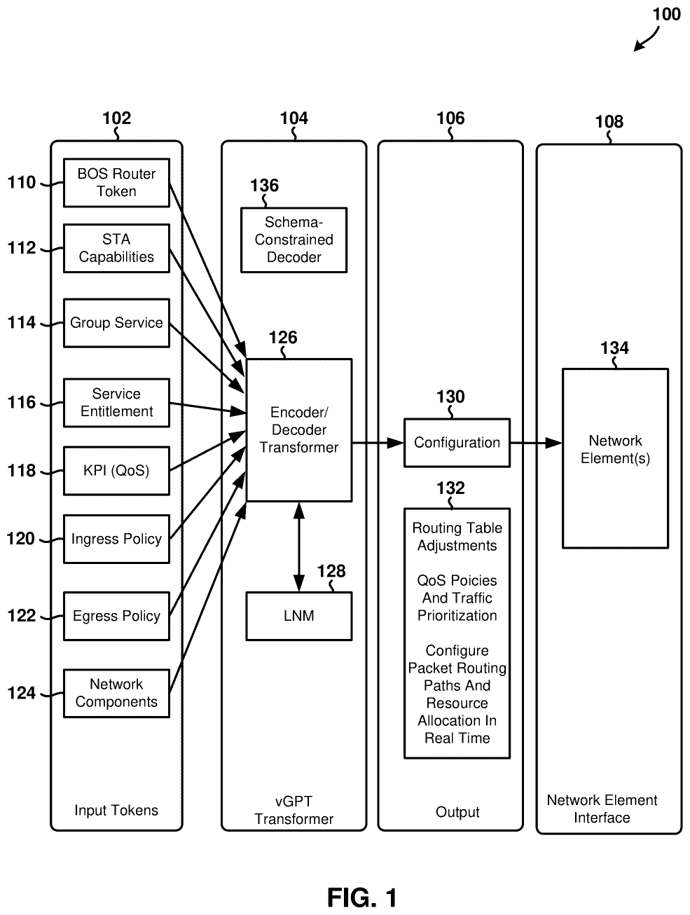

FIG. 1 is a block diagram illustrating the generation of device-specific configurations from network tokens processed by a transformer in accordance with some embodiments. In the example illustrated in FIG. 1, the system 100 includes input tokens 102, vGPT transformer 104, output 106, network element interface 108. The Input Tokens 102 may include a begin-of-sequence (BOS) router configuration token 110, STA capabilities 112, group service token 114, service-entitlement token 116, KPI token 118, ingress policy 120, egress policy 122, and network components 124. The vGPT transformer 104 may include an encoder/decoder transformer 126, LNM 128, and schema-constrained decoder 136. The output 106 may include a configuration artifact 130 and policy actions 132. The network element interface 108 may include network element(s) 134.

System 100 may be configured to orchestrate the dynamic configuration of heterogeneous devices using a transformer that consumes position-encoded tokens and emits executable directives. A processing system may read tokens representing device capabilities, network policies, and service requirements, compute attention across the sequence, and output a CLI or API script that a target device accepts natively. System 100 may provide closed-loop control that aligns configuration with service intent, unlike conventional template-based systems that push static scripts without regard to current capabilities or measured telemetry.

The input tokens 102 may encapsulate device, policy, and service context as discrete, typed data structures. Each token may include a type field, a payload (e.g., VLAN ID, rate limit, MCS index), a provenance tag, and a position index that fixes order for embedding. Input tokens 102 may normalize diverse telemetry and policy sources into a structured input stream, replacing ad hoc fields and free-form inputs with schema-constrained representations.

The vGPT transformer 104 may host the inference pipeline that converts embedded tokens into configuration sequences. The pipeline may include embedding, multi-head self-attention, feedforward projection, and constrained decoding. vGPT transformer 104 may learn cross-domain relationships such as mapping Wi-Fi priorities to DSCP values, and may reuse that knowledge across device families, producing repeatable and device-specific outputs.

The output 106 may present model emissions as transaction-safe directives. Outputs may include ordered scripts with idempotent steps, rollback guards, and device selectors bound to identifiers such as MAC addresses or management URIs. Output 106 may ensure reliable enactment of transformer intent.

The network element interface 108 may deliver directives to target devices and apply them to forwarding, queueing, and control functions. For example, a router may accept a REST call to set DSCP rewrite rules, verify success through state queries, and confirm changes with a return code.

BOS router configuration 110 may define a begin-of-sequence token that primes decoding with correct syntax and scope. The token may set a global or interface context and a command namespace for the target platform. The component may stabilize decoding across device families that expect strict command order.

STA capabilities 112 may encode station attributes such as antenna count and supported modulation and coding scheme (MCS). A Wi-Fi token may declare MCS-11 support and spatial stream count so downstream schedulers assign capacity accurately. The component may align radio parameters with client capability.

Group service token 114 may compactly encode SLA terms such as allocation and retention priority, guaranteed bit rate, maximum bit rate, maximum packet loss, and maximum delay. The token may serve as a portable representation of service intent across Wi-Fi, Ethernet, and cellular domains. The transformer may map the fields to queue policies and shaping targets.

Service entitlement 116 may encode per-user or per-group admission rights, including allowed application categories and maximum concurrent flows. The token may bind an identity to a slice and a service class. Ingress evaluators may enforce the entitlement deterministically at the first hop.

KPI token 118 may carry measured or target metrics with timestamps including latency, jitter, packet loss, and throughput. The processing system may convert device telemetry into KPI tokens on a cadence and may re-invoke a transformer when values drift from service targets. The loop may drive precise corrections without wholesale reconfiguration.

Ingress policy 120 may describe treatment at entry ports including access control list evaluation and policing with token-bucket parameters. The policy may match header fields such as protocol and port and may set committed rate and burst values. Early enforcement may shape traffic before contention develops deeper in the path.

Egress policy 122 may describe departure handling including queue mapping, shaping rates, and differentiated services code point rewrite. The policy may assign weights to queues, set a shaping rate for a class, and map voice to expedited forwarding. Deterministic departure behavior may preserve per-slice budgets and latency bounds.

Network components 124 may enumerate device features that constrain script generation, including port lists, ASIC queues, virtual switch instances, accelerator presence, and firmware versions. The processing system may read these values during discovery and may gate directives on capability checks. Accurate enumeration may prevent unsafe operations and mismatched commands.

Encoder or decoder transformer 126 may process embedded tokens, compute attention weights, and emit configuration tokens in sequence. The encoder may convert input tokens into context vectors that capture relationships across device, policy, and service parameters. The decoder may predict the next directive by applying cross-attention between context vectors and previously generated outputs. Encoder or decoder transformer 126 may provide the translation of service intent and device state into actionable configuration steps.

LNM 128 may supply domain knowledge for algorithm selection and cross-device mapping. The model may maintain learned associations among identifiers such as DSCP, 5QI, and Wi-Fi user priorities and may output scheduling or shaping directives appropriate for the target device type. LNM 128 may accumulate knowledge across deployments through federated updates and may generalize learned behavior to new devices or environments, unlike conventional solutions that rely on static templates.

Configuration artifact 130 may hold the final device-specific script together with metadata such as checksum values, version identifiers, and preconditions. The artifact may contain an ordered set of configuration steps including interface edits, queue settings, and policy rules. Preconditions may verify the presence of a port, firmware version, or protocol capability before execution. The configuration artifact 130 may provide a reliable container that preserves integrity and allows replay, rollback, or audit of applied directives.

Policy actions 132 may summarize the intended operational outcomes of a configuration sequence, including routing table updates, QoS settings, traffic prioritization, and resource allocation. For example, the block may declare a new route preference, a weighted fair queue (WFQ) profile, and an airtime distribution plan. Policy actions 132 may provide an explicit link between the script steps defined in configuration artifact 130 and the higher-level service intent expressed by tokens.

Network element(s) 134 may execute the configuration artifacts on live traffic and may generate telemetry for the feedback loop. The devices may include routers, switches, Wi-Fi access points, or gateways. Each device may expose counters, latency probes, and status APIs that confirm whether configuration directives succeeded. Network element(s) 134 may provide the operational enforcement of model outputs and continuous measurement of service performance.

Schema-constrained decoder 136 may enforce a device grammar for output sequences. The grammar may define token types, field ranges, and command order per device family. The decoder may reject a nonconformant sequence and may request a replacement and may record a provenance tag for audit. The decoder may pass a conformant sequence to output 106 so configuration artifact 130 stores the script with provenance.

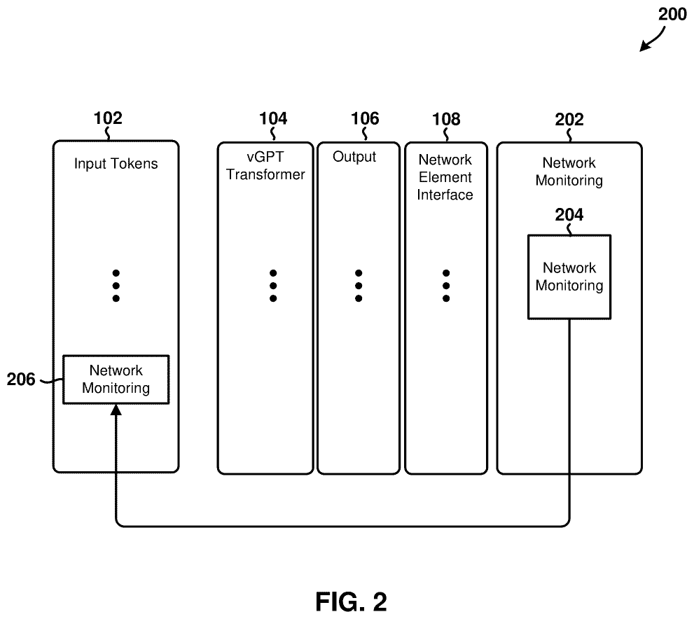

FIG. 2 is a flow diagram illustrating an active feedback loop that returns monitoring data to the transformer for configuration refinement. In the example illustrated in FIG. 2, the system 200 includes input tokens 102, vGPT transformer 104, output 106, network element interface 108, network monitoring 202 with a monitoring submodule 204, and local monitoring 206 components.

System 200 may circulate telemetry from devices back into the transformer input so that incremental updates are generated rather than full reconfigurations. A controller may subscribe to counters, encode changes as KPI tokens, and resubmit sequences for refinement. The system may provide responsive adaptation to dynamic load conditions.

Input tokens 102 may accept feedback tokens generated by monitoring components. Output 106 may encode patch-level directives with transaction identifiers to avoid conflicts. For example, output 106 may reference a policy object by ID and adjust one numeric parameter while leaving unrelated configuration intact. Network element interface 108 may stream telemetry to the controller and accept incremental updates without service interruption.

Network monitoring 202 may aggregate metrics and events across the network and publish them as tokens. For example, the module may compute latency windows, detect outliers, and encode results for input to the transformer. The network monitoring 202 component may provide situational awareness at scale.

Network monitoring submodule 204 may compute domain-specific analytics such as Wi-Fi airtime distribution or radio access network (RAN) 5QI compliance. The submodule may publish congestion indicators that influence the allocation of scheduling tokens. Network monitoring submodule 204 may improve the fidelity of feedback for cross-domain orchestration.

Local network monitoring 206 may run on devices and capture counters with minimal delay. An access point may measure inter-packet intervals, encode a DFI feature vector, and transmit the vector as a token. Local network monitoring 206 may provide low-latency updates that support timely corrective action.

The transformer output may define a configuration patch that maps to device syntax as a configuration script for a target device family. The NCF applies the script and reads back state. A subsequent patch modifies a bounded subset of parameters relative to the read-back state. This narrow-delta behavior reduces churn and shortens commit time.

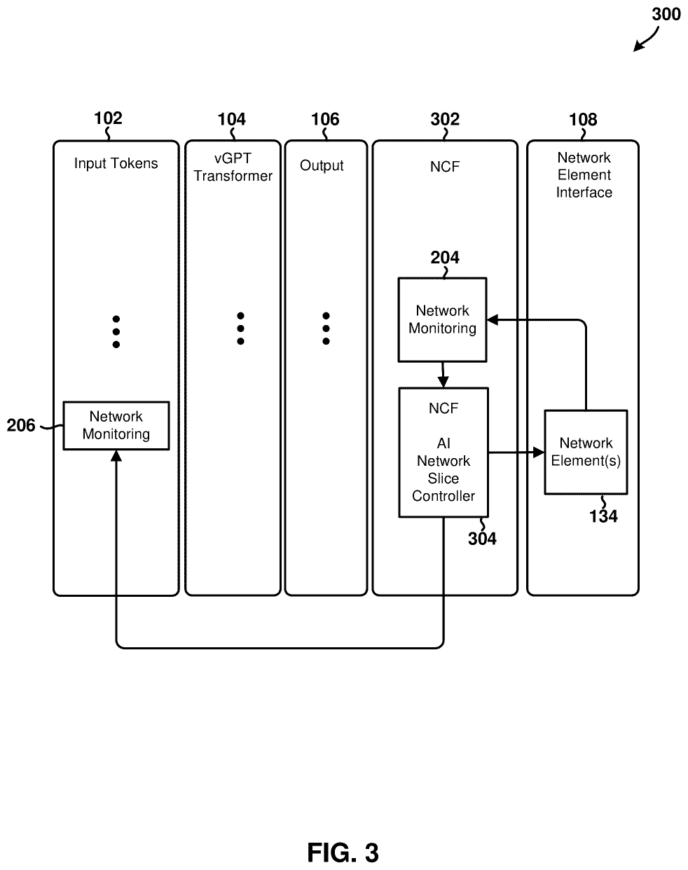

FIG. 3 may illustrate a NCF that applies transformer outputs with slice-aware feedback. System 300 may include input tokens 102, vGPT transformer 104, output 106, network element interface 108, NCF 302, monitoring 204, and AI Slice Controller (AISC) 304.

System 300 may insert a controller tier between transformer outputs and devices to coordinate slice policy and execution. The controller may map global outputs into device-specific transactions, stage them, commit them in order, and validate compliance with telemetry. System 300 may provide reliable orchestration at scale.

Input tokens 102 may include slice identifiers, SLA tokens, and topology tokens that define scope. For example, the tokens may identify VLAN 101 for a gold slice and list device IDs for update. vGPT transformer 104 may produce cross-device mappings such as DSCP-to-5QI translation and per-AP EDCA profiles. Output 106 may structure emissions as controller intents with dependencies and rollback conditions.

NCF 302 may translate controller intents into device-protocol calls, track execution state, and relay feedback. For example, the controller may call a RAN controller API for slice creation, push QoS rules through NETCONF, and confirm success before updating state. NCF 302 may decouple model logic from device-protocol specifics.

The monitoring 204 component may collect slice-scoped telemetry from network element(s) 134 and publish tokens when SLA bounds are exceeded. The monitoring 204 component may compute per-slice latency, jitter, and loss, and provide tokens that re-enter the model input. The monitoring 204 component may maintain compliance visibility for slice orchestration.

AISC 304 may manage slice lifecycle and apply transformer directives to slice resources. The controller may allocate bandwidth, program DSCP-to-queue mappings, set EDCA parameters, and maintain unified cross-domain policy. AISC 304 may prevent fragmentation of Wi-Fi, Ethernet, and cellular into silos.

The network element interface 108 component may provide access to operational devices during configuration and validation. The interface may expose APIs for transaction submission and counters for verification. Network element interface 108 may support orchestration across multiple device types.

Network element(s) 134 may execute directives such as scheduler adjustments, route updates, and admission rules while confirming success through counters and telemetry. A router may apply a new WFQ profile and report updated queue depth and drop counters. The network element(s) 134 may provide the measurable enforcement of slice-aware directives.

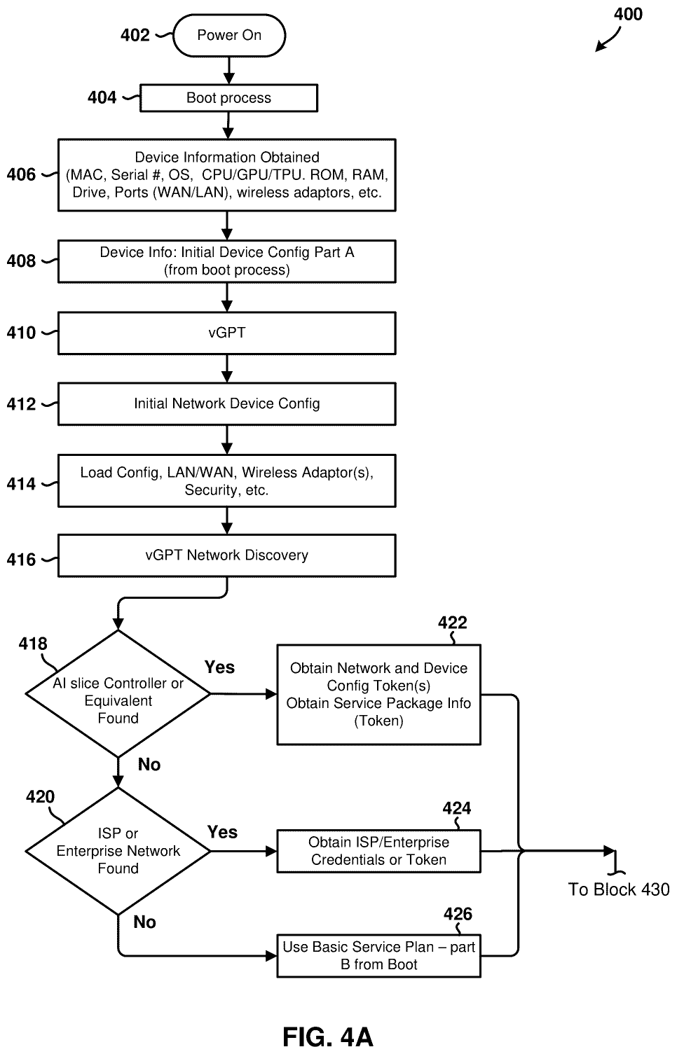

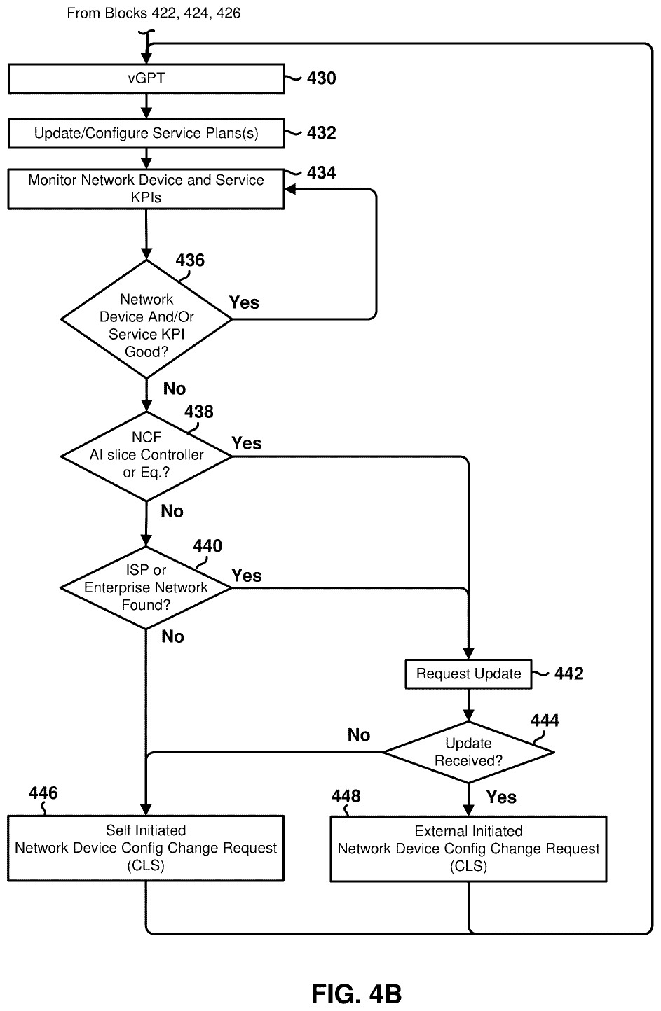

FIGS. 4A and 4B illustrate a method for configuring and updating a router or network element using a NOTM in accordance with some embodiments. The flow may show how a processing system in a device progresses from secure boot to discovery, authority selection, token retrieval, and transformer-driven configuration.

In block 402, a processor in a network device powers on and transfers control to immutable boot code. The processor may execute ROM-stage instructions, initialize memory, and prepare the hardware platform for later software stages. These operations may establish a trusted foundation for onboarding.

In block 404, the processor may continue the boot process. The processor may perform self-tests, verify a signed bootloader through secure boot, and load a trusted operating system image from persistent storage. This may ensure that subsequent configuration and token operations occur in a tamper-resistant environment.

In block 406, the processor may collect device identity and capability information. The processor may read identifiers such as a MAC address and serial number, discover CPU and memory resources, enumerate ports, and detect radios or accelerators. The processor may format this information as capability data that may be tokenized for the transformer.

In block 408, the processor may generate an “initial configuration part A” using boot data. The processor may enable management access, establish temporary security settings, and install protective ACLs to block unsolicited traffic. These steps may provide a secure baseline for discovery and model interaction.

In block 410, a processor in the NOTM runtime may embed device information into typed tokens and generate a configuration patch. The runtime may apply encoder-decoder attention and output directives such as a YANG patch or CLI sequence. Unlike template-based approaches, this process may yield device-specific outputs derived from structured tokens.

In block 412, the processor may apply the initial configuration to the device. The processor may commit edits that create baseline VLANs, configure WAN access, and synchronize time with trusted sources. This may establish connectivity and system readiness.

In block 414, the processor may load LAN, WAN, radio, and security settings. These may include SSID creation with WPA3, virtual PSK assignment, NAT setup, DSCP mapping, and TLS-secured routes to controllers. This may activate data and control paths with baseline protection.

In block 416, the processor may perform discovery for orchestration domains. The processor may parse DHCP options, query DNS SRV records, listen for LLDP advertisements, and attempt mutual TLS with candidate endpoints. These actions may identify authoritative controllers.

In decision block 418, the processor may determine whether an AI slice controller (AISC) remains present. Discovery may include certificate validation, API version checks, and health queries. When present, the device may select a slice-aware control path.

In decision block 420, the processor may determine whether an ISP or enterprise network has been discovered. The processor may authenticate with enterprise infrastructure, detect delegated prefixes, or receive enrollment responses. This may select an operator domain for control when a slice controller is not present.

In block 422, the processor may retrieve configuration and service tokens. The processor may contact a controller API and receive structured tokens such as GST, SLA, policy, and topology tokens. Tokens may be verified and securely stored. These structured inputs may serve as the basis for transformer processing.

In block 424, the processor may obtain ISP or enterprise credentials when operating under an operator domain. The processor may complete secure authentication, retrieve access tokens, and store refresh credentials.

In block 426, the processor may select a fallback “service plan part B” when no authority is reachable. The processor may load a default GST representing best-effort treatment with conservative security and scheduling settings.

In block 430, the NOTM runtime may consume tokens from blocks 422, 424, or 426 and generate a configuration update. The runtime may combine SLA, GST, capability, and policy tokens, select an algorithm from the NOTM, and decode a minimal patch set with integrity metadata. This may produce precise directives consistent with service intent.

In block 432, a processor in an NCF may update service plan objects. The processor may create or update VLAN or virtual pre-shared key (vPSK) policies with parameters such as CIR, PIR, queue weights, and DSCP mappings. The updates may be delivered through NETCONF or RESTCONF with confirmation. The processor may dynamically enforce the service tiers.

In block 434, a monitoring service may collect device and service KPIs. The service may poll counters, run probes, compute performance percentiles, and encode the results as KPI tokens. These tokens may drive corrective actions.

In decision block 436, the monitoring service may evaluate KPI tokens against SLA thresholds. A pass state may continue monitoring, while a failure state may trigger remediation steps.

In decision block 438, the processor may determine whether a controller remains reachable for remediation. Connectivity checks may include heartbeats, token freshness, and API queries. A positive result may delegate correction to the controller, while a negative result may trigger local autonomy.

In decision block 440, the processor may determine whether an ISP or enterprise operator is reachable for assistance. The processor may renew connectivity and validate secure channels. This may allow fallback to operator-supplied corrections.

In block 442, the processor may request an update from the detected authority. The request may include KPI tokens, fault codes, and policy hashes, and may receive a transaction identifier in return. This allows for coordinated updates across multiple devices.

In decision block 444, the processor may determine whether an update has been received within a defined window. If received, the processor may verify the patch, stage it safely, and apply it. If not, the processor may initiate a local corrective action.

In block 446, the processor may create a local change request when authority updates remain unavailable. The processor may construct a token sequence that requests corrective actions, run the sequence through a local NOTM runtime, and apply the resulting patch with rollback guards. The processor may maintain SLA compliance.

In block 448, the processor may process external change requests received from an authority. The processor may validate signatures, check preconditions, apply patches, confirm state, and report updated KPIs. Each change may be tied to provenance metadata for auditability.

Thus, during the boot sequence, the processing system may collect device information. The information may include a MAC address, a serial number, an operating system build, a firmware level, a memory size, a storage type, and a port inventory for Ethernet wide area network (WAN), Ethernet local area network (LAN), universal serial bus (USB), and small form-factor pluggable (SFP) interfaces. The information may also include radio capabilities for internal modems or external wireless adapters. When an initial device configuration exists, the processing system may load it. When no configuration exists, a NOTM may generate an initial configuration. The initial configuration may establish basic communication and set baseline security. The processing system may remove default passwords, disable unused ports, and activate a management interface with mTLS. The processing system may configure WAN and LAN interfaces, as well as wireless adapters, so that the device may reach a controller.

A NOTM runtime may generate a configuration token or patch that the processing system may load on the device. After enablement, the processing system may advertise the device for discovery and attempt to join a network. During discovery, the processing system may test for control domains. When the device operates as a standalone node, the processing system may supply a basic service plan token from boot to the NOTM runtime for an updated patch. When the processing system locates a network slice controller, the processing system may retrieve a device configuration token and a service package with treatments and KPI targets and provide them to the NOTM runtime for an updated patch. When the processing system locates an ISP or an enterprise network, the processing system may retrieve a device configuration token and a service package with treatments and KPI targets and provide them to the NOTM runtime for an updated patch.

The NOTM may process the new tokens and generate router configuration updates. The processing system may configure service plans, service plans per VLAN or vPSK, network resources, security functions, LAN and WAN interfaces, wireless adapters, wireless client parameters, wireless access-point parameters, multi-SSID functions, vPSK groupings, ingress policies, egress policies, routing parameters, QoS parameters, KPI parameters, and other device parameters. For example, the NOTM runtime may emit a NETCONF patch that configures VLAN 101 with a committed information rate of 50 megabits per second, a peak information rate of 100 megabits per second, a mapping of DSCP EF to queue 1 with a weight of 40, EDCA values for a gold slice on a 5 GHz radio, and WPA3 security with a controller-issued PSK on an SSID labeled “Gold.” These operations may align device behavior with a GST and an SLA token across Wi-Fi and Ethernet domains. Unlike template-based approaches, these embodiments generate minimal and device-specific transactions that reflect current capabilities and active service intent.

After configuration, a processing system in the router may monitor for device state or service state changes. The monitored states may include interface faults, KPI violations, or slice-level and VLAN-level performance degradations. When the processing system detects a deviation, the processing system may initiate corrective action to restore SLA compliance. When a network slice controller, an equivalent orchestration platform, or an ISP or enterprise network remains reachable, the processing system may send a request for instructions. When no authority responds, the processing system may encode the KPI deviation and the fault as tokens and submit the tokens to the NOTM runtime for an updated patch. For example, the processing system may report latency above a maximum delay target and a drop rate above a maximum packet loss target for a voice slice. In response, the NOTM runtime may return a patch that increases the weight of queue 1, decreases the weight of best-effort traffic, and adjusts a shaping rate on the WAN port. This feedback loop may operate on a short cadence so the device sustains service goals in real time. Unlike conventional systems that wait for manual intervention, some embodiments may apply safe incremental patches with preconditions and rollback guards to maintain service continuity.

Generally, an LNM and/or its components collectively enable it to efficiently and effectively configure, manage, and orchestrate a network and its various network elements, or a standalone network device.

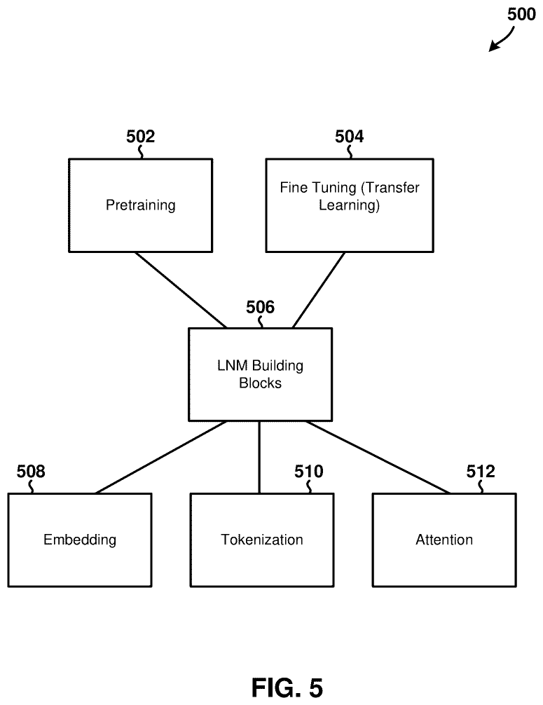

FIG. 5 illustrates an LNM 500 and its building blocks. LNM 500 may include pre-training 502 and fine-tuning 504 that produce learned parameters used by LNM building blocks 506. The building blocks 506 may include embedding 508, tokenization 510, and attention 512. A processing system may execute these components so that LNM 500 configures, manages, and orchestrates a standalone device or an entire network.

The pre-training 502 component may train the LNM 500 with a large dataset that may be unsupervised or self-supervised. During pre-training, the processing system may learn generalized patterns, device relationships, and foundational knowledge about network behavior. Pre-training 502 may provide a foundation that enables LNM 500 to process diverse network tasks more efficiently.

The fine-tuning 504 component may apply knowledge from the pre-training 502 component to a smaller dataset that addresses a specific task. The processing system may refine the pretrained parameters with the smaller dataset so LNM 500 produces more accurate outputs for that task. The fine-tuning 504 component may operate continuously so that knowledge gained from a local LNM or from federated updates contributes to the refinement of LNM 500.

The tokenization 510 component may convert sequences of device and network configuration data into tokens. Each token may correspond to a discrete configuration value, policy field, or script element. Tokenization 510 may reduce the complexity of the configuration space and allow LNM 500 to process network state through structured network tokens.

The embedding 508 component may convert tokens into continuous vector representations in a high-dimensional space. Each vector may encode attributes and relationships of the original token. Embedding 508 may allow LNM 500 to capture contextual meaning across device capabilities, policies, and service parameters. The processing system may refine embeddings during training so LNM 500 preserves semantic relationships between tokens and produces accurate outputs.

The attention 512 component may compute weights across tokens in a sequence so that LNM 500 emphasizes relevant tokens and de-emphasizes less relevant tokens. Attention 512 may allow the transformer to focus on tokens that influence service objectives, such as latency or admission control, while ignoring unrelated tokens. Attention 512 may improve the ability of LNM 500 to generate outputs that reflect current service intent and device state.

Some embodiments may include generating a group service token (GST) from a service catalog. A processing system may read a catalog entry (e.g., for bronze, silver, gold, or platinum) and construct GST fields that encode throughput, latency, jitter, packet-loss bounds, etc. The processing system may output the GST as a typed token that a transformer may embed in a position-encoded sequence. A validation module may compare the GST to device-capability tokens and flag any field that exceeds a capability so that downstream decoding remains bounded by what the device supports.

Some embodiments may include the generation of a network-slice configuration token from constituent tokens. A processing system may combine a GST, one or more KPI tokens, one or more network-component tokens, and one or more policy tokens into an ordered input. A network component token may reference a router model or an access point firmware version. A policy token may reference a firewall rule or an ingress rule. A transformer encoder may process the ordered tokens, and a transformer decoder may output configuration patches that target multiple devices. In a federated arrangement, edge devices may compose partial scripts from local tokens (e.g., local Wi-Fi load) and transmit these partial scripts to an aggregator. The aggregator may merge the partial scripts into a single network configuration. In a layered composition variant, local transformers may handle physical-layer scheduling, regional transformers may handle slice orchestration, and a central transformer may handle inter-domain routing.

Some embodiments may include positional encoding that preserves token order for dependency interpretation. An embedding layer may assign position codes so that a processing system encodes device type at position 1, firmware capability at position 2, service class at position 3, and policy at position 4. The preserved order may guide the transformer to honor dependencies among tokens and to emit script sequences in the correct order.

Some embodiments may include decoding that produces script sequences mapped to executable transactions. A processing system may translate each output sequence into CLI transactions, API calls, or controller intents. The processing system may deploy each sequence to a target network element and confirm application through a return code or a state query so that the control loop maintains verifiable enactment of service intent.

Some embodiments may address limitations in conventional algorithm selection for large AI models. Unlike conventional solutions that model only problem features and treat the algorithm as a label, the processing system may instead model algorithm characteristics as explicit features. Example algorithm features may include expected accuracy for a specific traffic class, inference latency for a particular device type, memory footprint, and hardware support. By representing both sides, the processing system may avoid one-way mappings that overlook constraints and tradeoffs present in real networks.

Some embodiments may implement bidirectional algorithm selection. A processing system may construct a problem feature vector and an algorithm feature vector and may compute a selection score that reflects their correlation, subject to device and policy constraints. The vectors may include KPIs, slice targets, traffic mix, device capability, and algorithm cost. The processing system may select an algorithm, a parameter set, or a variant that maximizes the score while satisfying the constraints. The processing system may treat algorithms as feature-bearing entities rather than labels, which may produce configurations that better match service intent and hardware limits.

In some embodiments, the LNM may embed a problem feature vector and an algorithm feature vector and compute a similarity score. The bidirectional algorithm selector may accept an algorithm when the score meets a defined threshold and otherwise triggers a refinement cycle that adjusts parameters or evaluates a different algorithm. The NCF may record the score, the threshold, and the selection outcome for audit.

Some embodiments may incorporate performance data into the selection loop and may refine the NOTM through federated learning. A processing system at an edge device may record post-deployment KPIs for the chosen algorithm, construct update vectors, and transmit model-delta data to an aggregator. The aggregator may compute a weighted average across devices and may distribute updated parameters to edge devices. This process may localize learning to device observations while improving the global selector over time.

An aggregator that receives model-delta vectors from multiple nodes computes a weighted average to form aggregated parameters and validates those parameters on a holdout dataset before distribution. The aggregator records validation metrics and version identifiers and rejects an update that fails validation.

Some embodiments may include execution of a cLNM within a container. A processing system may deploy the container on an edge device, allocate processor and memory resources, and start a transformer runtime. This architecture may allow the processing system to execute the cLNM across heterogeneous devices while enforcing processor, memory, and accelerator quotas and hiding unassigned resources to support safe resource sharing and rapid updates.

Some embodiments may include training of an SLNM at an edge device. A processing system may train the SLNM using locally observed KPI data. The processing system may compute a model-delta vector that encodes parameter updates derived from the training and may transmit the model-delta vector to an aggregator according to a schedule or in response to a performance event such as packet loss above a defined threshold. The aggregator may compute a weighted average of model-delta vectors received from multiple edge devices and may distribute an updated model to each edge device. Federated learning updates may use secure aggregation so the aggregator receives masked model-delta vectors. Differential privacy may bound information leakage in each update before aggregation.

Some embodiments may include role assignment among edge devices that execute containerized transformers. A processing system at one edge device may operate as a lead node that aggregates KPI values, while processing systems at other edge devices contribute secondary inputs. Each processing system may collect metrics such as processor load, memory consumption, and slice performance. Each processing system may transmit the metrics to an NCF, which may redistribute workloads or reassign node roles based on the reported metrics.

Some embodiments may include the execution of an SLNM for a specialized task. A processing system within a Wi-Fi access point may run an SLNM that outputs a scheduler configuration at an interval in the range of 10 to 100 milliseconds based on load. A cloud processing system may execute a full LNM that performs cross-domain mapping such as DSCP to 5QI translation and long-term learning updates. SLNMs and LNMs may exchange tokens and model-delta update(s) so that operations remain consistent across domains.

Some embodiments may include distinct feature extraction for problems and algorithms. A processing system may construct a problem feature vector and an algorithm feature vector so that the algorithm selected for a function aligns with service objectives and hardware limits. This separation may allow the processing system to leverage pretrained LNMs with greater accuracy.

Some embodiments may include embedding of both problem feature vectors and algorithm feature vectors into a common space. A processing system may generate embedded vectors for problem features and algorithm features, compare correlations among the vectors, and select the algorithm associated with the highest correlation score. This embedding process may allow the processing system to align algorithm selection with problem features through contextual embeddings.

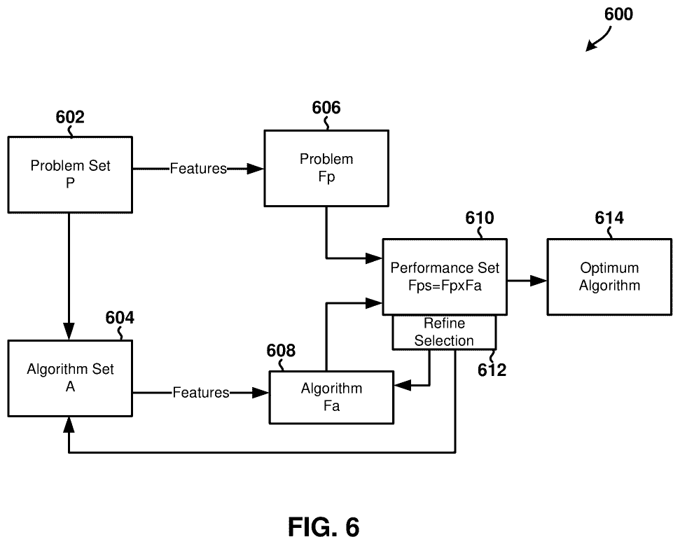

FIG. 6 illustrates a system 600 that may be configured for bidirectional algorithm selection in accordance with some embodiments. In the example illustrated in FIG. 6, the system 600 includes a problem set 602 component, an algorithm set 604 component, a problem-feature vector 606 component, an algorithm-feature vector 608 component, a performance set 610 component, a refine-selection 612 component, and an optimum algorithm 614 component.

As discussed, an LNM may embed a problem feature vector and an algorithm feature vector and compute a similarity score. The bidirectional algorithm selector may accept an algorithm when the score meets a defined threshold and otherwise triggers a refinement cycle that adjusts parameters or evaluates a different algorithm. The NCF may record the score, the threshold, and the selection outcome for audit.

The problem set 602 component may include a tokenized problem input provided to the processing system. The processing system may extract structured attributes from the problem set, including statistical measures, constraints, and service targets.

The algorithm set 604 component may include a collection of candidate algorithms. The processing system may treat each algorithm in the set as a distinct entity described by feature fields, such as expected accuracy, latency, or memory footprint. The algorithm set 604 component may provide a pool of potential solutions against which the problem set 602 is evaluated.

The problem feature vector 606 component may include a structured embedding of attributes derived from the problem set 602. The processing system may generate the vector by extracting statistical features, decision-tree parameters, or observed KPI values. The problem feature vector 606 component may allow the transformer to represent problem context in a structured form.

The algorithm feature vector 608 component may include structured embeddings of attributes describing algorithms in the algorithm set 604. The processing system may encode each algorithm's cost, accuracy, and execution profile as numerical features. The algorithm feature vector 608 component may allow the transformer to compare algorithms based on quantified characteristics rather than treating them as labels.

The performance set 610 component may compute a similarity score between the problem feature vector 606 and the algorithm feature vector 608. One implementation may compute cosine similarity between normalized vectors. Another implementation may compute a bilinear score

$$s = {F}_{p}^{⊤} W {F}_{a}$$

with a learned matrix W. The performance set 610 component may produce a ranked ordering of algorithm candidates.

The refine-selection component 612 may include a corrective loop when the correlation score from the performance set 610 does not meet a threshold. The processing system may test algorithm variants, adjust parameters, or revise the algorithm set 604 to improve the match. The refine-selection component 612 may ensure that the selection process adapts dynamically rather than returning a static output.

The optimum algorithm 614 component may include the final selection produced by process 600. The processing system may output the selected algorithm as the best match for the current problem set 602 based on correlation scoring and refinement steps. The optimum algorithm 614 component may allow the system to apply the most suitable algorithm while maintaining auditability of the selection process.

The processing system may include the problem set 602 as a problem feature vector 606 (Fp) and the algorithm set 604 as an algorithm feature vector 608 (Fa). The processing system may form a performance set 610 (Fps) by computing the correlation between Fp and Fa. When the correlation score exceeds a threshold, the processing system may identify the optimum algorithm 614. When the score falls below the threshold, the processing system may refine selection 612 by evaluating algorithm variants or by revising the algorithm set 604. If repeated searches do not produce an optimal match, the processing system may select the best available algorithm and continue fine-tuning through future iterations.

Some embodiments may use problem instances and their extracted features as training samples. A processing system may continuously fine-tune the selection model with observed data, thereby improving correlation scoring and algorithm assignment accuracy over time.

Some embodiments may address new problem sets by performing feature extraction from the incoming problem instance. A processing system may tokenize the problem data, construct a problem feature vector 606, and supply it to the selection model to identify a matching algorithm feature vector 608.

Some embodiments may define problem features as attributes derived from specific instances of the problem. Problem features may include statistical measures such as the number of objectives or variables, decision-tree attributes associated with the problem, or historical performance data observed in similar contexts. A processing system may incorporate these features into the problem feature vector 606.

Some embodiments may include algorithm features explicitly for use in selection. A processing system may treat each algorithm in algorithm set 604 as a distinct category and may construct algorithm feature vectors 608 that describe expected accuracy, execution latency, memory footprint, or other performance attributes. In some cases, a regression model may predict expected performance values, and in other cases, clustering may partition the problem space into subsets that map to different algorithm categories.

Some embodiments may allow a NOTM to apply bidirectional selection across diverse problem types without being constrained to predefined scenarios. By representing both problem and algorithm features as vectors, and by computing correlation scores in performance set 610, a processing system may select algorithms that align with device capabilities, service objectives, and contextual constraints across heterogeneous networks.

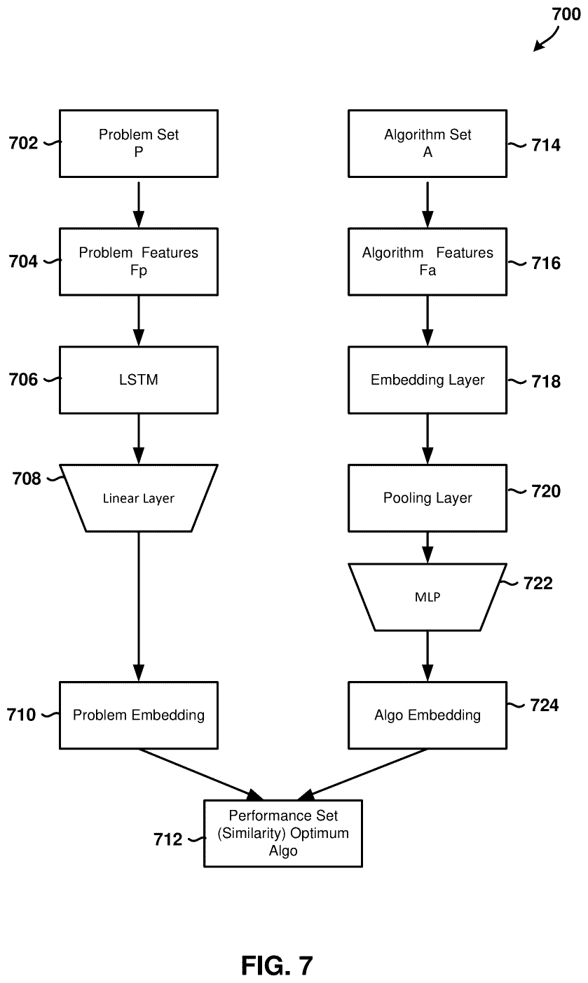

FIG. 7 illustrates a process 700 for determining an optimum algorithm in accordance with some embodiments. In the example illustrated in FIG. 7, process 700 includes a problem set 702, a problem feature vector 704, a long short-term memory (LSTM) layer 706, a linear layer 708, a problem embedding 710, a performance set 712, an algorithm set 714, an algorithm feature vector 716, an embedding layer 718, a pooling layer 720, a multilayer perceptron (MLP) 722, and an algorithm embedding 724.

The problem set 702 component may include the structured input describing a network orchestration task. A processing system may tokenize objectives, constraints, and statistical attributes of the task into problem-set tokens. The problem set 702 component may provide the raw input for downstream feature extraction.

The problem feature vector 704 component may include attributes extracted from the problem set 702. A processing system may generate a vector that encodes parameters such as the number of variables, SLA bounds, and observed KPI values. The problem feature vector 704 component may allow subsequent layers to treat the problem context as a structured embedding input.

The LSTM layer 706 component may process the problem feature vector 704 to capture sequential dependencies. A processing system may propagate context across operations so that each intermediate state incorporates historical features. The LSTM layer 706 component may preserve temporal structure and relational continuity in the problem representation.

The linear layer 708 component may project the output of the LSTM layer 706 into a continuous vector space suitable for comparison with algorithm features. A processing system may adjust dimensionality through linear transformation to normalize the representation. The linear layer 708 component may prepare the vector for downstream embedding.

The problem embedding 710 component may include the dense vector encoding of the problem set 702. A processing system may combine feature attributes and sequential relationships from preceding layers into a unified representation. The problem embedding 710 component may serve as the problem-side input for similarity comparison with algorithm embeddings.

The performance set 712 component may compare the problem embedding 710 and the algorithm embedding 724 using the same similarity rule defined for the performance set 610. A processing system may rank candidate algorithms by score and may select the highest-scoring algorithm when the score meets a threshold.

The algorithm set 714 component may include the pool of candidate algorithms. A processing system may tokenize algorithm entities, describing each with attributes such as expected accuracy, runtime cost, memory use, and device compatibility. The algorithm set 714 component may provide the structured basis for selection.

The algorithm feature vector 716 component may include extracted attributes of the algorithm set 714. A processing system may encode algorithm properties into feature vectors suitable for embedding. The algorithm feature vector 716 component may allow algorithms to be compared based on structured metrics rather than as categorical labels.

The embedding layer 718 component may transform the algorithm feature vector 716 into a dense representation. A processing system may map each algorithm's features into the same high-dimensional space as the problem embedding 710. The embedding layer 718 component may preserve algorithm relationships in a comparable form.

The pooling layer 720 component may aggregate dimensions of the embedding output. A processing system may compress attributes while preserving key patterns, producing a representation that is compact yet expressive. The pooling layer 720 component may support stability and efficiency in later transformations.

The MLP 722 component may refine the pooled algorithm representation using nonlinear transformations. A processing system may apply multilayer perceptron operations to capture higher-order interactions among algorithm attributes. The MLP 722 component may output a normalized embedding for final comparison.

The algorithm embedding 724 component may include the dense vector encoding of an algorithm from the algorithm set 714. A processing system may compare the algorithm embedding 724 with the problem embedding 710 to compute correlation scores. The algorithm embedding 724 component may allow identification of the algorithm that best matches the problem set 702.

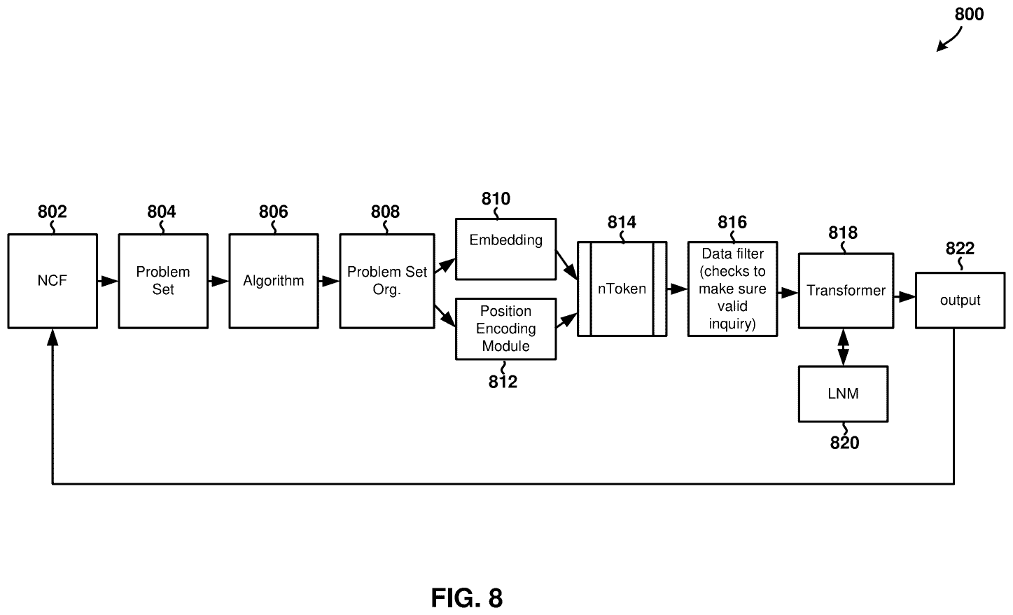

FIG. 8 illustrates a process 800 for matching an algorithm to a problem set and producing a transformer output in accordance with some embodiments. In the example illustrated in FIG. 8, process 800 includes a NCF 802, a problem set 804, an algorithm 806, a problem-set organization 808, an embedding 810, a position-encoding module 812, an nToken 814, a data filter 816, a transformer 818, a LNM 820, and an output 822.

The NCF 802 component may initiate an algorithm-selection request and a configuration request. A processing system in the NCF may assemble inputs, submit tokens to the pipeline, receive results from output 822, and dispatch device-specific directives to network elements. The NCF 802 component may also collect telemetry and route feedback to the pipeline for refinement.

The problem set 804 component may represent a structured description of the orchestration task. A processing system may tokenize objectives, constraints, topology attributes, and service targets so the downstream stages receive typed fields with antecedent basis.

The algorithm 806 component may represent a candidate algorithm reference or an index into an algorithm set. A processing system may bind this reference to features that describe cost, latency, accuracy, memory footprint, and device compatibility so later stages compare problem features to algorithm features.

The problem-set organization 808 component may arrange fields from the problem set 804 into a canonical order and may normalize units and ranges. A processing system may remove ambiguous fields, apply schema checks, and prepare the ordered record for embedding.

The embedding 810 component may map ordered fields into continuous vectors. A processing system may convert discrete tokens into high-dimensional representations that preserve relationships among device capabilities, policies, and service parameters.

The position-encoding module 812 may assign positional indices and classification tags. A processing system may encode positions for device type, firmware capability, service class, and policy so the transformer interprets dependencies and emits steps in the correct sequence.

The nToken 814 component may package the embedded vector and the positional codes into a single token record with provenance metadata. A processing system may add a timestamp, a request identifier, and a calling context so later stages trace the origin of outputs.

The data filter 816 component may validate the request before inference. A processing system may verify schema compliance, authentication, authorization, rate limits, and field bounds. Invalid records may be rejected, and valid records may advance to the transformer 818.

The transformer 818 component may perform inference on the validated nToken 814. A processing system may compute attention across problem and algorithm features, invoke the LNM 820 for domain mappings, and decode a minimal configuration patch that matches service intent and device constraints.

The LNM 820 component may supply domain knowledge and learned mappings. A processing system may reference tables that relate Wi-Fi priorities, DSCP values, and 5QI identifiers, and may apply parameters received through federated updates so selections and patches remain current.

The output 822 component may present results as executable directives and as a selection report. A processing system may format device-specific commands as command line interface transactions, application programming interface calls, or controller intents, and may return the results to the NCF 802. The feedback path shown in FIG. 8 may route post-deployment telemetry back to the pipeline so future requests benefit from observed performance.

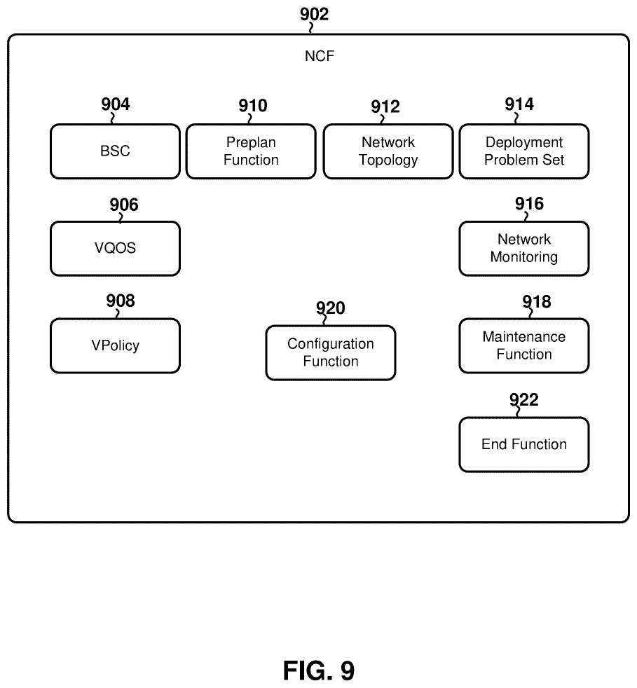

FIG. 9 illustrates an NCF 902 that may be configured in accordance with some embodiments. In the example illustrated in FIG. 9, the NCF 902 includes a bandwidth service class (BSC) 904 component, a virtual quality-of-service (vQoS) 906 component, a virtual policy (vPolicy) 908 component, a preplan function 910 component, a network topology 912 component, a deployment problem set 914 component, a network monitoring 916 component, a maintenance function 918 component, a configuration function 920 component, and an end function 922 component.

The BSC 904 component may classify and manage bandwidth allocations for devices, slices, or services. A processing system may evaluate traffic demands, generate problem sets, and submit them to a NOTM for script generation. The BSC 904 component may maintain per-slice bandwidth enforcement consistent with service targets.

The vQoS 906 component may represent a module for ensuring that QoS parameters remain consistent across devices or slices. A processing system may generate problem sets encoding latency, jitter, or reliability targets, submit them to a NOTM, and apply revised directives to the devices. The vQoS 906 component may ensure real-time compliance with defined service targets.

The vPolicy 908 component may define admission, routing, or access rules for devices or slices. A processing system may tokenize policy attributes, generate problem sets, and process them through a NOTM to receive validated configuration patches. The vPolicy 908 component may enforce consistent policy application across heterogeneous elements.

The preplan function 910 component may reserve resources and prepare configurations for upcoming deployments. A processing system may create a problem set representing planned allocations, submit it to a NOTM, and store validated outputs. The preplan function 910 component may allow proactive orchestration of devices or slices.

The network topology 912 component may describe and maintain the logical and physical arrangement of network elements. A processing system may generate problem sets that encode topology changes, transmit them to a NOTM, and receive updated scripts. The network topology component may ensure that the configuration aligns with the current infrastructure.

The deployment problem set 914 component may activate devices or slices in a target domain. A processing system may apply scripts generated by the configuration function 920 to initialize connectivity, configure routing paths, allocate bandwidth, and enforce SLA parameters. The deployment problem set 914 component may coordinate slice or sub-slice activation.

The network monitoring 916 component may observe device and slice performance. A processing system may collect telemetry such as latency, packet loss, and throughput, tokenize the measurements, and submit problem sets to a NOTM. The network monitoring 916 component may support closed-loop adjustment of network states.

The maintenance function 918 component may manage ongoing network health. A processing system may process telemetry tokens, evaluate performance against service targets, and re-invoke a NOTM to generate corrective configurations. The maintenance function 918 component may allow continual optimization of device and slice behavior.

The configuration function 920 component may provide the interface between the NCF 902 and a NOTM. A processing system may generate problem sets, receive scripts in response, and forward the scripts to the deployment problem set 914 component. The configuration function 920 component may ensure configuration patches are validated, schema-constrained, and consistent with service objectives.

The end function 922 component may release network resources at the conclusion of a device or slice lifecycle. A processing system may terminate active sessions, reclaim compute and bandwidth allocations, and update the resource pool for reuse. The end function 922 component may ensure orderly teardown and reallocation of network capacity.

In some embodiments, the NCF 902 may operate in coordination with an AI slice controller (AISC) to achieve both local device enforcement and global orchestration. A processing system within the NCF 902 may generate problem sets that encapsulate service requirements, topology changes, or policy updates and may submit them to a NOTM for resolution. A processing system within the AISC may receive the resulting configuration patches, distribute them to network elements such as routers, Wi-Fi access points, and 5G base stations, and monitor slice telemetry for compliance. AISC agents on local devices may enforce per-element configurations, while the NCF 902 provides higher-level lifecycle management through functions such as preplanning, deployment, maintenance, and termination. Together, the NCF 902 and AISC may provide a closed-loop control system in which global service intent, tokenized as problem sets, is continuously reconciled with observed telemetry and updated through transformer-generated outputs.

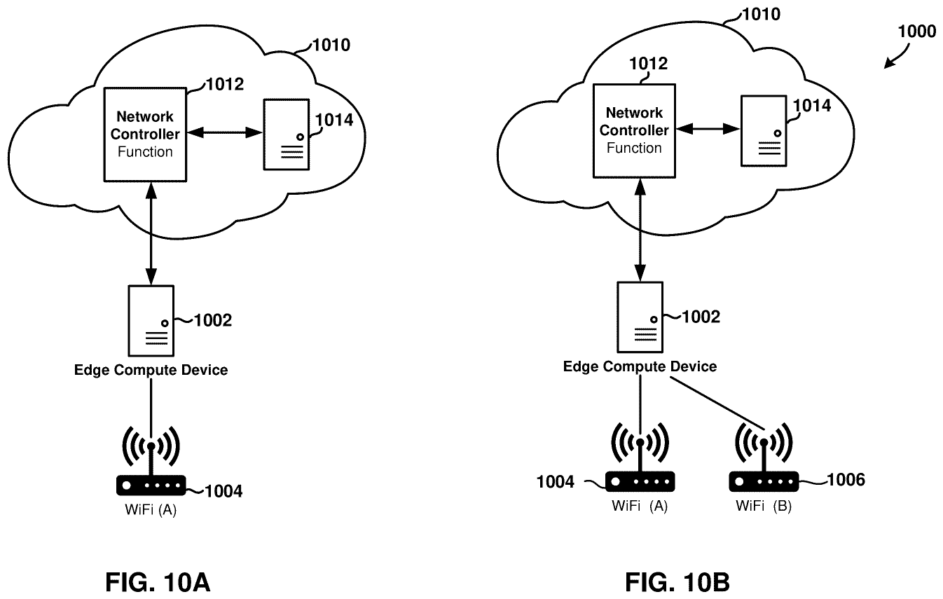

FIGS. 10A and 10B illustrate an NCF and NOTM deployed in a cloud environment or remote data center. In particular, FIGS. 10A and 10B illustrate a system 1000 in which a network control function (NCF) 1012 and a network orchestration transformer model (NOTM) 1014 reside in a cloud 1010 and interact with an edge compute device 1002 that manages Wi-Fi access points 1004 and 1006. In FIG. 10A, the edge compute device 1002 connects to Wi-Fi (A) 1004. The NCF 1012 submits a problem set to the NOTM 1014, receives a provisioning output, and delivers a configuration patch to the edge compute device 1002, which applies the configuration patch to Wi-Fi (A) 1004. In FIG. 10B, the edge compute device 1002 manages both Wi-Fi (A) 1004 and Wi-Fi (B) 1006. When the edge compute device 1002 detects Wi-Fi (B) 1006, a processing system in the edge compute device 1002 reports the discovery to the NCF 1012. The NCF 1012 submits the problem set to the NOTM 1014, receives a provisioning output, and delivers a device-specific configuration patch that the edge compute device 1002 applies to Wi-Fi (B) 1006

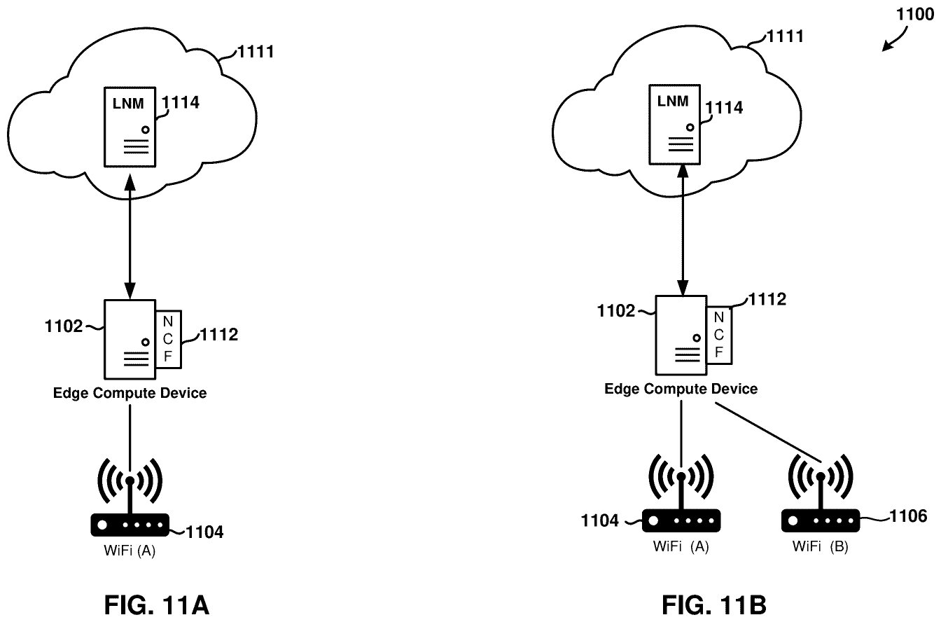

FIGS. 11A and 11B illustrate a variant of FIG. 10 in which the NCF resides within the edge device, while the NOTM resides in the cloud. That is, FIGS. 11A and 11B illustrate a system 1100 in which an NCF 1112 is embedded within an edge compute device 1102 while a NOTM 1114 resides in a cloud 1111. In the example illustrated in FIG. 11A, the edge device manages Wi-Fi (A) and communicates with the NOTM for provisioning support. In the example illustrated in FIG. 11B, when Wi-Fi (B) is introduced, a processing system in the local NCF detects the new device, submits a problem set to the cloud NOTM, and receives provisioning scripts that the edge device applies to Wi-Fi (B). Said another way, in FIG. 11A, the edge compute device 1102 executes the NCF 1112 and manages Wi-Fi (A) 1104. The edge compute device 1102 communicates with the NOTM 1114 in the cloud 1111 to receive provisioning information and configuration patches for Wi-Fi (A) 1104. In FIG. 11B, the edge compute device 1102 manages both Wi-Fi (A) 1104 and Wi-Fi (B) 1106. When Wi-Fi (B) 1106 is introduced, the NCF 1112 in the edge compute device 1102 detects the new device, submits a problem set to the NOTM 1114 in the cloud 1111, and receives a provisioning script that the edge compute device 1102 applies to Wi-Fi (B) 1106.

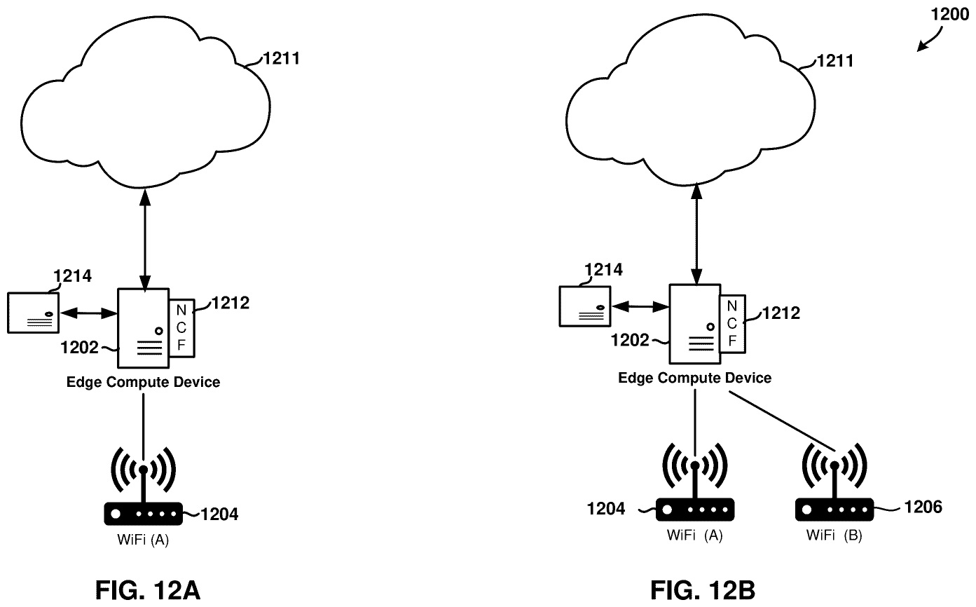

FIGS. 12A and 12B illustrate a second variant in which both the NCF and the NOTM are resident within the edge device. In particular, FIGS. 12A and 12B illustrate a system 1200 in which both an NCF 1212 and an NOTM 1214 reside within an edge compute device 1202, while a cloud 1211 provides connectivity. In the example illustrated in FIG. 12A, the edge device 1202 includes both the NCF 1204 and the NOTM 1206 and manages Wi-Fi (A) 1208. In the example illustrated in FIG. 12B, the edge device detects Wi-Fi (B) 1210, processes the discovery event through the local NCF 1204, and performs provisioning locally by invoking the NOTM 1206 embedded on the device. The processing system may tokenize device attributes, apply positional encoding, process the tokens through the NOTM 1206, and output configuration patches for immediate application to Wi-Fi (B) 1210.

In FIG. 12A, the edge compute device 1202 hosts the NCF 1212 and the NOTM 1214 and manages Wi-Fi (A) 1204. The edge compute device 1202 processes discovery events, tokenizes device attributes, and applies provisioning outputs to Wi-Fi (A) 1204 locally. In FIG. 12B, when Wi-Fi (B) 1206 is introduced, the edge compute device 1202 detects the new access point and invokes the NCF 1212 together with the NOTM 1214 to produce device-specific configuration patches that the edge compute device 1202 applies to Wi-Fi (B) 1206. The edge compute device 1202 continues to communicate with the cloud 1211 for coordination but sustains full provisioning operations locally

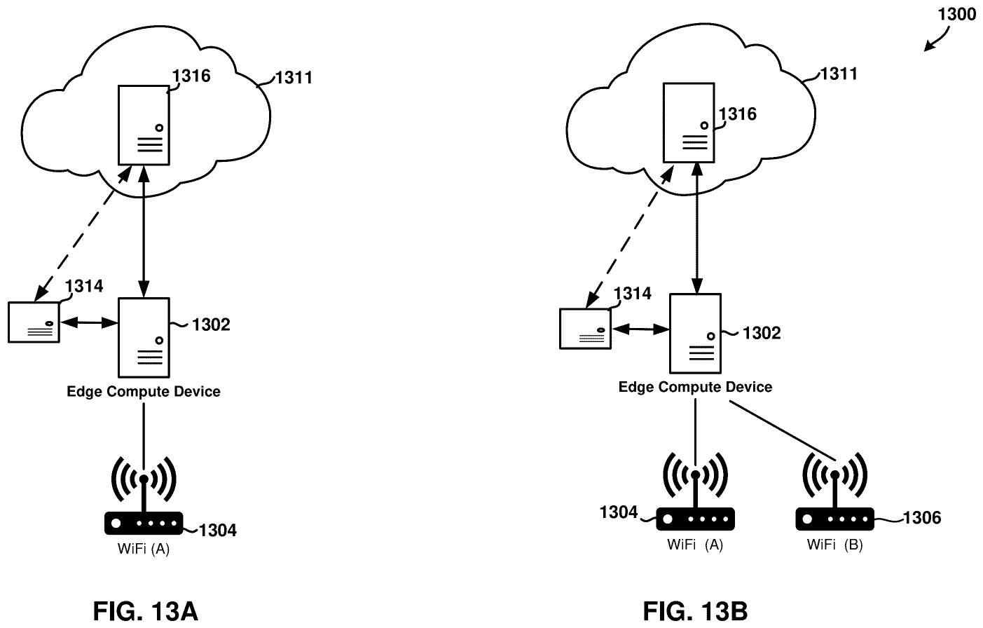

FIGS. 13A and 13B illustrate another variant in which the NCF and one NOTM instance are resident on the edge device 1302, while an additional NOTM 1316 instance resides in a cloud or remote environment. In the example illustrated in FIG. 13A, the edge device manages Wi-Fi (A) 1304 using its local NCF and NOTM. In particular, FIGS. 13A and 13B illustrate a system 1300 in which an edge compute device 1302 includes a local NCF and a local NOTM 1314, while a cloud 1311 hosts an additional NOTM 1316. In the example illustrated in FIG. 13B, when Wi-Fi (B) 1306 is introduced, the local NCF processes the event, requests provisioning information from the local NOTM 1314, and applies configuration patches to Wi-Fi (B) 1306. In parallel, the local NOTM 1314 may exchange learned model updates with the remote NOTM 1316 in the cloud. The remote NOTM 1316 may aggregate updates from multiple edge devices and return revised parameters. A processing system in the edge device may load the updated parameters into the local NOTM 1314 without downtime.

In FIG. 13A, the edge compute device 1302 manages Wi-Fi (A) 1304 using its local NCF and NOTM 1314. The NOTM 1314 exchanges learned model updates with the cloud NOTM 1316. In FIG. 13B, when Wi-Fi (B) 1306 is introduced, the local NCF in the edge compute device 1302 detects the new access point, processes the event through the local NOTM 1314, and applies a configuration patch to Wi-Fi (B) 1306. In parallel, the local NOTM 1314 transmits model-delta updates to the cloud NOTM 1316, which aggregates updates from multiple edge devices and distributes revised parameters. The edge compute device 1302 receives the revised parameters and loads them into the local NOTM 1314 without service interruption, enabling federated learning across the system.

The examples illustrated in FIGS. 10A through 13B illustrate alternative deployment architectures for integrating an NCF with a NOTM runtime in accordance with some embodiments. A processing system may select among these architectures based on latency tolerance, resource availability, and federation goals. When both the NCF and NOTM reside in the cloud, as in FIGS. 10A-10B, the processing system may leverage centralized compute resources at the expense of higher round-trip delays. When the NCF is local and the NOTM remains cloud-based, as in FIGS. 11A-11B, the processing system may reduce control latency while still drawing on cloud inference capacity. When both the NCF and NOTM are local to an edge computing device, as in FIGS. 12A-12B, the processing system may achieve the lowest possible latency and maintain service continuity even without cloud connectivity. When both a local and a remote NOTM operate in tandem, as in FIGS. 13A-13B, the processing system may benefit from local inference speed while also participating in federated learning across multiple domains. These deployment variants may provide system designers with a spectrum of choices to balance responsiveness, scalability, and cross-domain optimization in heterogeneous networks.

A processing system may orchestrate Wi-Fi, 6G, and wired domains using a NOTM. The NOTM may execute within a RIC or may interoperate with an AISC. The processing system may manage radio resources inside one domain and may coordinate slice policies across domains.

A processing system may extend orchestration across Wi-Fi, 6G, Ethernet, and NTN domains such as low Earth orbit satellites. The processing system may tokenize topology attributes across domains, may distribute tokens to transformers, and may output configuration patches. The configuration patches may adjust settings on satellite gateways, terrestrial routers, and access points.

A processing system at an AISC and a processing system at a RIC may exchange KPI tokens to coordinate slice creation. One processing system may enforce radio latency below 10 ms, and another processing system may enforce WAN packet loss below 0.1%. Feedback loops may align policies across domains so that end-to-end service targets remain within bounds.

A NOTM may detect common network faults before impact. A processing system may infer impending resource exhaustion from expected observations rather than fixed thresholds on dependent variables. Example observations may include queue-depth trajectories, buffer-occupancy gradients, CPU-load trends, airtime contention, and memory-pressure vectors. Threshold-driven triggers may either leave capacity idle or miss short peak bursts, resulting in inconsistent performance. In contrast, model-based inference may predict saturation and request corrective patches in advance.

Some embodiments may manage heterogeneous networks by pairing a NOTM with an NCF so that network orchestration operates in real time without depending on over-provisioned capacity. Conventional solutions allocate excess “headroom” in device or link resources to absorb peak traffic, but edge devices often lack the processor, memory, and bandwidth to support such unused reserves. Instead, the processing system may rely on schema-constrained decoding, explicit preconditions, idempotent transactions, read-back verification, and provenance tags to generate precise and minimal configuration patches. The processing system may compare the intended state to the observed state, compute a bounded difference, and issue a corrective patch that closes the gap.

In some embodiments, the processing system may operate a bidirectional feedback loop in which KPI tokens capture telemetry, transformer outputs provide updated directives, and post-change telemetry confirms successful correction. This closed loop may limit configuration drift, reduce recurring errors, and maintain service continuity across devices and domains.

Sources of configuration sequence errors may be grouped into three categories: problem definition, transformer processing, and output generation. Errors in problem definition may arise when the problem set does not focus on a dependent variable but instead on an expected observation, when no dependent variable exists, when the problem consists only of independent variables, or when no problem set is proposed at all. Errors in transformer processing may occur when configuration information is missing, when the underlying network configuration changes unexpectedly, or when minimal configurations are used that fail to capture the necessary scope. Errors in output generation may appear when the configuration script emphasizes an optimal outcome rather than a correct one, when incorrect directives are produced, or when no configuration is generated.

Conventional AI systems that use large language models (LLMs) generally emphasize generalized tasks such as explanation or argumentation. These systems do not typically analyze configuration errors or issue corrective updates. Some embodiments address this limitation by introducing a bidirectional feedback loop that enables a NOTM to adapt continuously. The feedback loop may operate at the device level, at a centralized controller, or across a federated network so that deviations are detected and corrected in real time.

Training of LNMs may remain continuous because products and software evolve. Pre-training may use self-supervised objectives on corpora that include configuration artifacts, device manuals, YANG models, and synthetic controller traces. Fine-tuning may use smaller curated datasets that target a specific task. Prompt engineering may apply at inference time and may shape outputs without parameter updates.

A further challenge arises when configuration patches must be generated from complex, incomplete, or contradictory data. Heterogeneous environments that span on-net and off-net devices often introduce such inconsistencies, which may reduce the accuracy of a NOTM. Some embodiments use a bidirectional feedback loop to improve output accuracy and relevance by refining results based on telemetry. Additional improvements may come from continuous updates contributed by other LNMs through federated learning, which propagate locally observed gains into the global model.

The effectiveness of a NOTM may also depend on how input information is represented before inference. Task classification using dependent and independent variables provides structure to the model. Dependent variables define measurable outcomes, and independent variables supply contextual features that influence those outcomes. This structured classification improves reproducibility and accuracy in configuration tasks.

To capture these relationships, a NOTM that employs an LNM with attention or self-attention may identify dependencies across distant elements in a sequence. The process begins when the input problem set is converted into numerical embeddings. Each embedding encodes the semantic meaning of a token and provides a representation that the model may interpret. Positional encoding complements embeddings by assigning values that indicate the order of tokens in the sequence. Together, embeddings and positional encodings preserve both semantic meaning and contextual order. By combining these techniques, a NOTM may generate configuration outputs that maintain accuracy, reflect contextual dependencies, and remain consistent with service intent and device constraints.

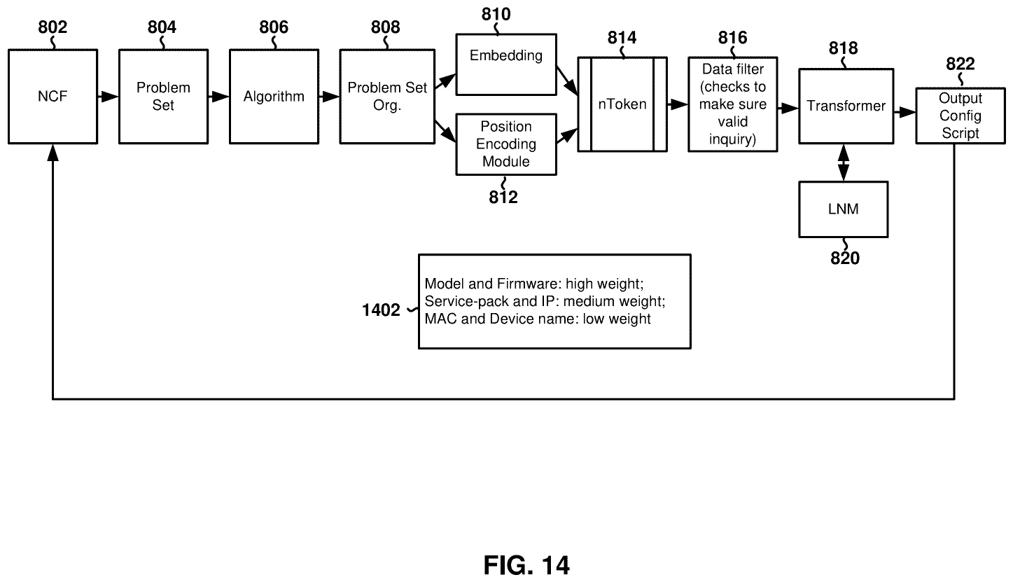

FIGS. 14 through 17 illustrate an integrated control path. The NCF uses the transformer model under common control to generate a configuration patch. These figures illustrate token weighting, positional encodings, similarity threshold selection, read-back state evaluation, and narrow-delta patch emission.

FIG. 14 illustrates a process 1400 for matching an algorithm to a problem set and producing a transformer output. In the example illustrated in FIG. 14, process 1400 includes a NCF 802, a problem set 804, an algorithm 806, a problem-set organizer 808, an embedding module 810, a position-encoding module 812, an eToken 814, a data filter 816, a transformer 818, a LNM 820, and an output configuration script 822. The process 1400 also includes a biasing component 1402 that influences token weighting during problem-set preparation and embedding.

The biasing component 1402 may assign relative importance to input attributes such as model number, firmware level, service pack, IP address, and device identity. The component may apply high weight to model and firmware attributes, medium weight to service pack and IP address attributes, and low weight to device identity attributes such as MAC address. These weights may guide the embedding module 810 and the position-encoding module 812 so that capability attributes drive inference.

Some embodiments may include an NCF 802 that organizes a problem set 804, selects an algorithm 806, and structures the problem set for tokenization and embedding through a problem-set organizer 808. The structured problem set may pass into the embedding module 810 and the position-encoding module 812. The embedding module 810 may convert attributes into numerical vectors that encode semantic meaning, and the position-encoding module 812 may apply positional values that preserve ordering and dependency. The nToken 814 may encapsulate the embedded vectors with metadata such as provenance and identifiers. The data filter 816 may validate the nToken for schema compliance and input integrity before forwarding it to the transformer 818. The transformer 818 may invoke the LNM 820 and may generate an output configuration script 822 that the NCF may apply to network devices. Telemetry from the devices may return to the NCF and may drive a closed-loop refinement cycle.

Some embodiments may assign greater weight to model number and firmware level than to descriptive identifiers or device identity. The model and the firmware may identify device capability with precision. The processor may apply high bias to the model and firmware, medium bias to the IP address and service pack, and low bias to the device name and MAC address.

Some embodiments may use the weighted tokens to select a configuration algorithm. A processing system may compute an attention matrix that reflects the relative influence of attributes such as model number, firmware version, service pack, and device name. The attention matrix may weight the model and firmware more than the service pack, and the service pack more than the device name. A transformer may apply the attention matrix during decoding so that device-critical parameters drive the configuration process.

Some embodiments may treat a service-pack token as a contextual modifier of a model token. The service-pack token may encode allocation and retention priority, guaranteed bit rate, maximum bit rate, maximum packet loss, and maximum delay. When no service-pack token appears, default values associated with the model may apply. The NCF may introduce a service-pack token in later feedback iterations when prior iterations do not converge to a desired configuration.

Some embodiments may tokenize the model number and the MAC together with firmware, hardware capabilities, and feature sets and may link them to device classes such as routers, switches, or access points. This classification may provide context for interpreting additional tokens. A problem-set token that represents the selected algorithm may be included so that the transformer applies a method suitable for configuration generation. The service pack token may combine with the model and MAC tokens to populate parameters such as allocation priority and throughput bounds in a manner that reflects service requirements and device capabilities.

Some embodiments may tokenize the IP address and may reuse it across multiple inference passes. Device characterization may include firmware signatures and BIOS or UEFI values obtained during boot. The processing system may express these characterizations in positional dimensions that reference device type, vendor, and model. A salted hash of the MAC address may supply a stable identity token for provenance without use as a positional anchor.

Some embodiments may extend positional encoding to service-pack tokens, configuration tokens, and QoS tokens. Each characterization may occupy a distinct position so that contextual relationships remain explicit. Algorithms may occupy unique positional spaces grouped by function and differentiated by vendor and model.

Some embodiments may implement a NOTM by combining bidirectional encoder representations from transformers (BERT) with retrieval-augmented generation (RAG). The BERT component may provide bidirectional encoding through self-attention and feedforward layers, and the RAG component may integrate external knowledge sources. By combining these components, a NOTM may generate outputs that reflect historical and forward-looking context and may incorporate real-time network conditions into configuration results. Thus, two transformer embodiments may be used. Embodiment A uses an encoder-decoder transformer that generates configuration patches. Embodiment B uses an encoder-only model such as BERT with a constrained decoder head and retrieval-augmented generation. Embodiment B may integrate external knowledge sources during inference. Both embodiments may process the token types defined in this document.

Some embodiments may generate specialized tokens for enforcing service policies. For example, a VLAN token may encode ingress policing thresholds, egress shaping rates, queue mappings, and DSCP rewrite rules. A transformer may process the VLAN token and may produce a configuration script that enforces the encoded policies. A per-port per-VLAN service policy token may encode committed information rate, peak information rate, and queue depth. A transformer may process this token and may generate CLI commands or API calls that configure bandwidth and queuing parameters on a specified port.

Some embodiments may generate a 5QI token that encodes packet delay budget, packet error rate, and flow type and may also generate a mapping token that links a 5QI value to a DSCP value and a Wi-Fi user priority. For example, a processing system may map a conversational voice flow with 5Q1=1 to DSCP=EF and Wi-Fi user priority=6. An AI slice controller may maintain mapping tables that relate 5QI, DSCP, and Wi-Fi priorities and may update the mappings dynamically when KPI telemetry indicates SLA deviation. By integrating these tokenized relationships, a NOTM may align problem sets, embeddings, positional encodings, and attention weighting so that configuration outputs remain accurate, relevant, and consistent with device capabilities and service requirements, as illustrated in FIG. 14.

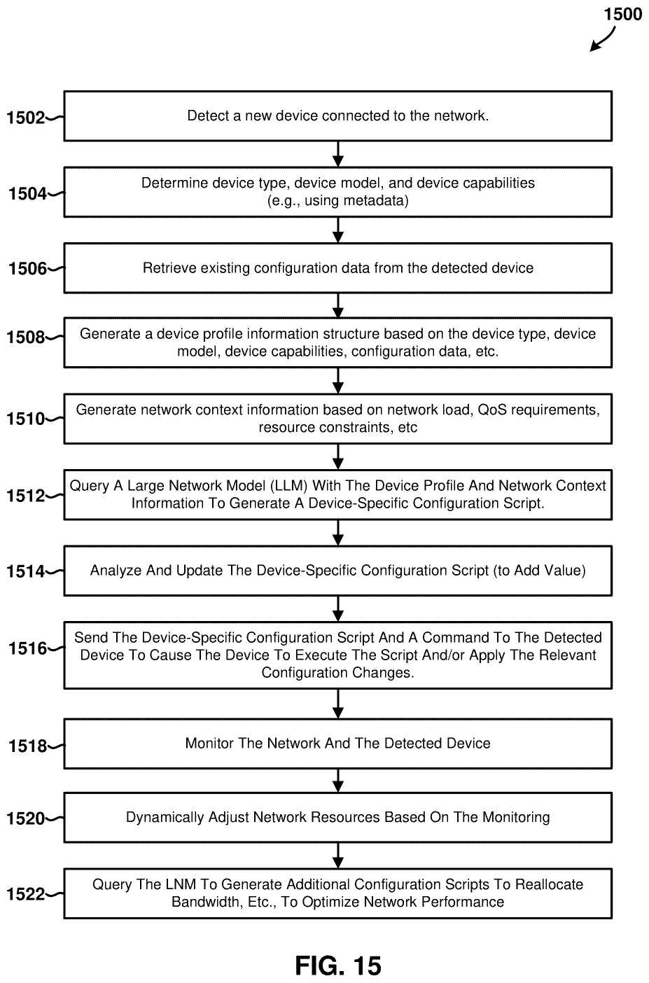

The processes of FIG. 14 may operate as a preparation and weighting pipeline that structures device and network attributes into schema-constrained tokens. These tokens may serve as standardized inputs for the dynamic configuration method illustrated in FIG. 15. In this manner, FIG. 14 may define input-side embedding and attention logic, and FIG. 15 may define application-side orchestration and closed-loop adjustment.

FIG. 15 is a process flow diagram illustrating a method 1500 of dynamic configuration and management of a heterogeneous network in accordance with some embodiments. The method 1500 may consume weighted and embedded tokens prepared according to the pipeline of FIG. 14. While FIG. 14 illustrates how problem sets, device attributes, and context are tokenized and processed by a transformer to produce configuration outputs, FIG. 15 illustrates how those outputs may be applied to devices, validated by telemetry, and refined in a continuous feedback loop.

In block 1502, a processor in a network controller may detect a new device connected to the network. For example, the processor may monitor link-layer discovery protocol messages, DHCP requests, or secure bootstrapping beacons and may identify a previously unknown MAC address. The processor may also query a switch or an access point for port activity to confirm attachment. Unlike conventional detection systems that rely on static pre-provisioned device lists, this approach may allow automatic discovery at the moment of connection and may reduce administrative overhead and response latency. As illustrated in FIG. 14, the biasing component 1402 assigns the lowest weight to device-identity attributes (e.g., MAC address and device name), lower than service-pack and IP attributes and much lower than model and firmware attributes.

In block 1504, a processor in the controller may determine device type, device model, and device capabilities. For example, the processor may parse metadata fields embedded in DHCP options, may query SNMP object identifiers, or may extract attributes from device certificates presented during mutual TLS authentication. The attributes may reveal CPU type, memory size, firmware level, and radio capabilities. By gathering such data automatically, the system may build an accurate profile without manual entry unlike methods that depend on administrator templates that lag behind firmware releases. The problem-set organizer 808 of FIG. 14 may structure these values for embedding and classification across heterogeneous vendors.

In block 1506, a processor in the controller may retrieve existing configuration data from the detected device. For example, the processor may issue NETCONF or RESTCONF requests to collect interface assignments, VLAN tables, or routing entries already active on the device. The processor may also query CLI output through an API bridge. This retrieval step may prevent overwriting valid local settings and may allow reconciliation between current and intended states, unlike approaches that push full templates regardless of device condition. The retrieved configuration data may be tokenized as input for embedding, consistent with the pipeline illustrated in FIG. 14.

In block 1508, a processor in the controller may generate a device profile information structure. For example, the processor may combine metadata such as device type and model, capability tokens such as supported modulation schemes, and configuration data such as active VLAN IDs into a schema-constrained object. The device profile may serve as a normalized input across heterogeneous vendors. This approach may replace ad hoc spreadsheets or vendor-specific syntax with a tokenized representation that a transformer may consume directly. As shown in FIG. 14, the embedding module 810 and the position-encoding module 812 may convert this device profile into numerical vectors and positional codes for inference.

In block 1510, a processor in the controller may generate network context information. For example, the processor may collect telemetry from routers, access points, and switches to determine aggregate load, latency values, jitter distribution, and available bandwidth. The processor may encode these values into KPI tokens that capture instantaneous and historical performance. Unlike static policies that assume fixed conditions, this approach may reflect dynamic network states and may allow configuration outputs that match service demand. The KPI tokens may be weighted and embedded in accordance with the biasing and embedding flow of FIG. 14 so that real-time telemetry receives appropriate influence during inference.

In block 1512, a processor in the controller may query an LNM using the device profile and the network context to generate a device-specific configuration script. For example, the processor may submit a sequence of tokens that represent model number, service pack, interface attributes, and QoS constraints to the transformer backbone of the LNM. The LNM may output a patch script in YANG or JSON that aligns with device capabilities and SLA requirements. This differs from approaches that map SLAs to one-size-fits-all templates that ignore vendor differences and that foster misconfigurations. The interaction among tokens, positional encodings, and attention weighting described in FIG. 14 may guide script generation so that device-critical attributes dominate configuration logic.

In block 1514, a processor in the controller may analyze and update the device-specific configuration script before deployment. For example, the processor may compare the script against policy rules that enforce WPA3 for Wi-Fi or deny specific ports and may insert annotations for rollback or compliance logging. Unlike controllers that push outputs without validation, this approach may improve the reliability and traceability of applied changes. The configuration artifact described in FIG. 14 may serve as the structured container for validated outputs.

In block 1516, a processor in the controller may send the device-specific configuration script and a command to the detected device so that the device executes the script or applies configuration changes. For example, the processor may use NETCONF edit-config operations to insert ACL entries, to assign DSCP rewrite policies, or to adjust interface queue parameters. The device may acknowledge each change with a transaction identifier and a return code. This approach may deliver incremental patches that minimize disruption, unlike methods that overwrite full configuration files.

An AISC may normalize QoS class mapping to AC_VO, AC_VI, AC_BE, and AC_BK and may derive device-specific queue identifiers during deployment. The mapping from DSCP and 5QI to EDCA classes may follow this normalization and utilize per-device tables in the device adapter layer.

In block 1518, a processor in the controller may monitor the network and the detected device after configuration. For example, the processor may poll counters such as packet drops, may run latency probes, or may collect wireless airtime distribution and may encode the observed data into KPI tokens. This monitoring step may feed the closed-loop feedback system and may allow continuous evaluation of SLA compliance. By contrast, systems that depend on manual operator checks delay correction. As illustrated in FIG. 14, KPI tokens may reenter the embedding and tokenization pipeline so that corrective patches are generated when thresholds are violated.

In block 1520, a processor in the controller may dynamically adjust network resources based on monitoring results. For example, the processor may reallocate queue weights, may adjust VLAN shaping rates, or may reassign resource units in Wi-Fi OFDMA scheduling. The processor may reprioritize traffic flows when telemetry shows latency or loss above bounds. Unlike static QoS assignments, these adjustments may respond in real time to observed conditions and may improve service stability.

In block 1522, a processor in the controller may query the LNM to generate additional configuration patches for resource optimization. For example, the processor may request an updated bandwidth allocation across VLANs or slices or a DSCP-to-5QI mapping that aligns with observed traffic. The LNM may return a configuration patch that redistributes capacity among gold, silver, and bronze service classes. This differs from systems in which optimization occurs during scheduled maintenance windows and reduces operational agility. By incorporating token weighting from FIG. 14 and the iterative feedback process of FIG. 15, the system may sustain continuous closed-loop optimization across heterogeneous networks.

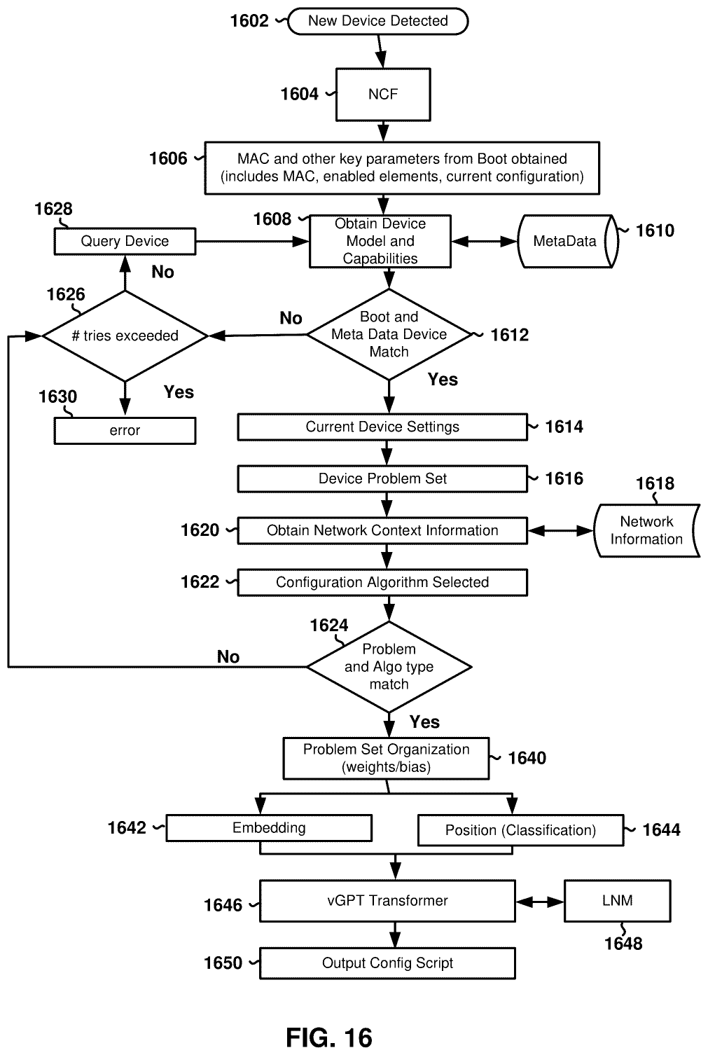

FIG. 16 is a process flow diagram illustrating a method 1600 for dynamically configuring and managing a heterogeneous network in accordance with some embodiments. The method may include an algorithm selection process that identifies a configuration algorithm suitable for a desired function and that matches device type and the defined problem set. The process may move from device detection and capability verification through algorithm alignment, problem-set organization, embedding, and transformer inference and may end with a device-specific configuration script.

In block 1602, a processor in a network controller may detect a new device connected to the network. For example, the processor may identify a DHCP discovery message that contains a new MAC address or may detect an LLDP advertisement on a switch port and may confirm presence with port activity counters. This allows discovery at connection time unlike methods that depend on static device inventories.

In block 1604, a processor in the network controller may activate a NCF to orchestrate onboarding. For example, the processor may assign a discovery session identifier, may establish a secure management channel, and may set retry thresholds. This function may unify authentication, capability retrieval, and algorithm matching unlike siloed device managers.

In block 1606, a processor in the controller may obtain parameters from the device boot process. For example, the processor may capture the MAC address, enabled interface identifiers, firmware version, and initial configuration values through secure boot exchange or BIOS or UEFI records. Controllers that query only after initialization miss transient data that influence later steps.

In block 1608, a processor in the controller may obtain device model and capabilities. For example, the processor may parse vendor metadata, query SNMP MIBs, or request attributes from device certificates and may discover supported routing protocols, radios, or accelerators. Metadata 1610 may supply throughput ceilings or VLAN ranges.

In block 1612, a processor in the controller may verify that boot parameters align with metadata records. For example, the processor may confirm that the MAC address and the model string reported at boot match vendor metadata. When no match appears, the processor may re-query 1628 until a retry limit 1626 is reached and may raise an error 1630. Systems that skip cross-verification risk misconfiguration due to spoofing or misreporting.

In block 1614, a processor in the controller may retrieve current device settings. For example, the processor may issue NETCONF get-config requests or CLI queries to capture VLAN assignments, routing tables, and ACL entries and may normalize the settings into schema-constrained tokens. This avoids overwriting valid configurations, unlike provisioning that reloads templates regardless of state.

In block 1616, a processor in the controller may construct a device problem set. For example, the processor may encode VLAN isolation, queue assignment for video, and guaranteed throughput for emergency services as tokens that describe required functions.

In block 1618, a processor in the controller may obtain network context information. For example, the processor may collect telemetry for load, jitter, latency, and bandwidth and may encode the values as KPI tokens that describe current and historical performance. Static policies that ignore telemetry often misalign with real network state.

In block 1620, a processor in the controller may merge network context into device onboarding. For example, the processor may align SLA latency bounds with observed jitter so that new configurations remain compliant with existing slices.

In block 1622, a processor in the controller may select a configuration algorithm based on the problem set and device profile. For example, the processor may choose a Wi-Fi OFDMA scheduler for radio assignments or a shaping algorithm for queue enforcement unlike controllers that apply uniform logic to every function.

In block 1624, a processor in the controller may confirm that the selected algorithm matches the problem type. For example, a shaping algorithm may pair with a shaping problem set and a routing algorithm may pair with a routing problem set. When no match appears, the processor may reselect a suitable algorithm.

In block 1640, a processor in the controller may organize the problem set with weights and biases. For example, the processor may apply high weight to model and firmware tokens, medium weight to service pack tokens, and low weight to manufacturer strings so that embeddings emphasize predictive parameters.

In block 1642, a processor in the controller may embed the organized tokens. For example, the processor may convert tokens into high-dimensional vectors that capture relationships among device attributes, policies, and service targets.

In block 1644, a processor in the controller may apply positional classification to the embedded tokens. For example, the processor may encode a router as coordinates (x, y, z), a Wi-Fi access point as (x1, y1, z1), and a smart switch as (x4, y4, z4) so that order and dependency remain preserved for transformer processing.

In block 1646, a processor in the controller may process the embedded and classified tokens using a vGPT transformer. For example, the transformer may apply multi-head self-attention, may query the LNM 1648 for cross-domain mappings, and may decode a minimal configuration patch. Unlike template-based controllers that overwrite configuration files, this step may generate incremental device-specific patches.

In block 1648, a processor in the controller may query an LNM for learned relationships. For example, the LNM may provide mappings between DSCP values, 5QI identifiers, and Wi-Fi access categories and may deliver federated updates from other nodes.

In block 1650, a processor in the controller may output the configuration script. For example, the script may include CLI commands, YANG patches, or RESTCONF calls that configure VLAN policing, DSCP rewrite rules, or queue shaping and may be logged with transaction identifiers for rollback and audit.

In block 1652, a processor in the controller may generate a traffic-shaping token to enforce flow control. For example, the token may encode shaping rate 10 megabits per second, burst size 1 megabyte, excess burst size 500 kilobytes, and buffer depth 100 packets, and a transformer may output traffic shape rate 10 m burst 1 m excess 500 k buffer 100.

In block 1654, a processor in the controller may generate an access control list token or an SBC token. For example, the token may encode a rule that matches UDP port 5060 for voice and may map the flow to a shaping class, and a transformer may output a script that installs the ACL on ingress ports or updates SBC policy.

The process of FIG. 16 may complement FIG. 15 by emphasizing algorithm selection and function-specific token generation. FIG. 15 addresses orchestration and closed-loop management, and FIG. 16 focuses on algorithm alignment and token-driven precision in device configuration.

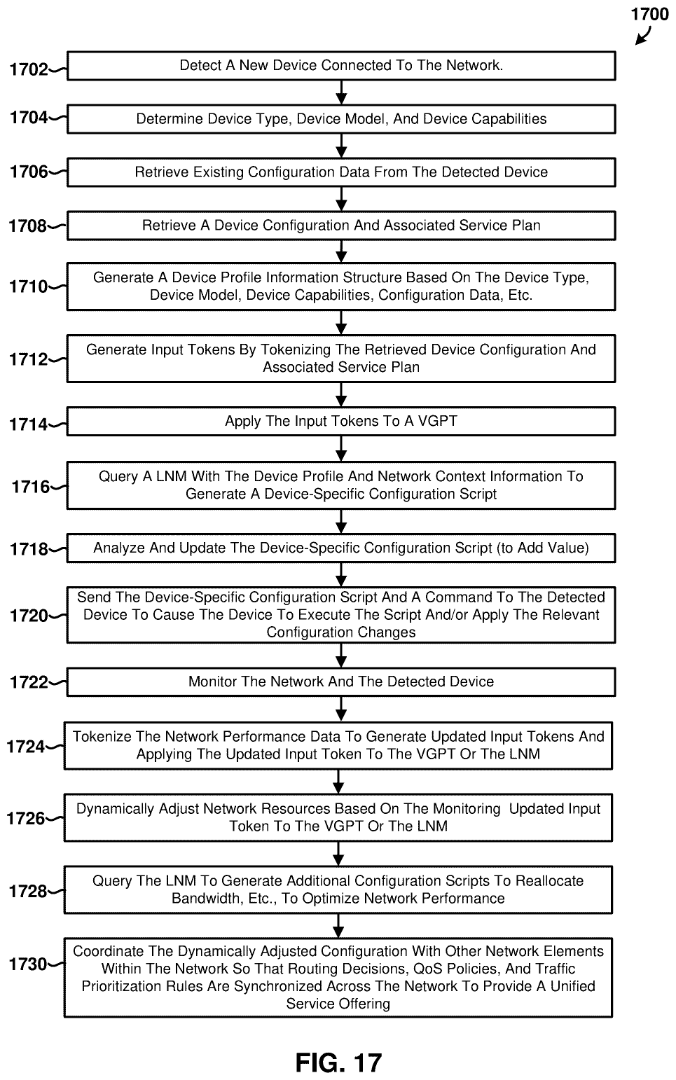

FIG. 17 is a process flow diagram illustrating a method 1700 for dynamic configuration and management of a heterogeneous network in accordance with some embodiments. The method includes tokenization of device configuration and service plans, application of those tokens to a vGPT transformer and an LNM, and synchronization of configuration changes across multiple network elements to provide a unified service offering.

In block 1702, a processor in a network controller may detect a new device connected to the network. For example, the processor may monitor DHCP discovery messages, LLDP advertisements, or switch-port activity and may identify a previously unseen MAC address. This enables dynamic onboarding at connection time unlike workflows that depend on manual registration.

In block 1704, a processor in the controller may determine device type, device model, and device capabilities. For example, the processor may parse DHCP options, may query SNMP MIBs, or may examine device certificates during TLS authentication to derive CPU capacity, memory, supported protocols, and radio bands.

In block 1706, a processor in the controller may retrieve existing configuration data from the detected device. For example, the processor may use NETCONF get-config, RESTCONF APIs, or CLI output capture to collect routing tables, VLAN assignments, and ACL entries and may reconcile actual and intended state.

In block 1708, a processor in the controller may retrieve a device configuration and an associated service plan. For example, the processor may pull SLA tokens or service-pack data from a subscriber system and may merge them with the device configuration so that bandwidth entitlements, latency targets, and feature activations shape downstream outputs.

In block 1710, a processor in the controller may generate a device profile information structure. For example, the processor may combine device model, capability data, configuration values, and SLA attributes into a schema-constrained representation that a tokenizer may consume directly.

In block 1712, a processor in the controller may generate input tokens by tokenizing the retrieved device configuration and the associated service plan. For example, VLAN IDs, ACL rules, bandwidth ceilings, and latency targets may be encoded as structured tokens with payload fields, positional indices, and provenance metadata.

In block 1714, a processor in the controller may apply the input tokens to a vGPT transformer. For example, the transformer may embed tokens, may compute attention scores, and may decode an ordered sequence of directives constrained by device syntax.

In block 1716, a processor in the controller may query an LNM with the device profile and network context information to generate a device-specific configuration script. For example, the processor may provide tokens that encode device capabilities, service targets, and KPI values, and the LNM may output a YANG patch or a CLI command sequence that reflects global knowledge and local conditions.

In block 1718, a processor in the controller may analyze and update the device-specific configuration script before deployment. For example, the processor may enforce WPA3, may block untrusted ports, and may attach rollback checkpoints to improve auditability and safety.

In block 1720, a processor in the controller may send the device-specific configuration script and an execution command to the detected device. For example, the processor may use NETCONF edit-config or RESTCONF calls to configure VLAN policing, DSCP rewrite rules, or queue scheduling and may receive a transaction identifier and a status code as confirmation.

In block 1722, a processor in the controller may monitor the network and the configured device after deployment. For example, the processor may collect packet-loss counters, jitter measurements, and Wi-Fi airtime distribution and may encode the results into KPI tokens for feedback.

In block 1724, a processor in the controller may tokenize network performance data to generate updated input tokens and may apply the updated tokens to the vGPT or the LNM. For example, when latency exceeds an SLA threshold, KPI tokens may be resubmitted and a corrective patch may be produced.

In block 1726, a processor in the controller may dynamically adjust network resources based on monitoring results. For example, the processor may reassign queue weights, may adjust bandwidth among VLANs, or may redistribute Wi-Fi OFDMA resource units in response to updated tokens.

In block 1728, a processor in the controller may query the LNM to generate additional configuration patches for network optimization. For example, the processor may request recalculation of DSCP-to-5QI mappings, redistribution of bandwidth among gold, silver, and bronze slices, or an updated shaping schedule during live operation.

In block 1730, a processor in the controller may coordinate dynamically adjusted configuration with other network elements so that routing decisions, QoS rules, and traffic-prioritization policies remain synchronized across routers, switches, and access points and so that devices enforce the same SLA treatment across the heterogeneous network.

The process of FIG. 17 may extend the workflows of FIG. 15 and FIG. 16 by combining closed-loop optimization with cross-device synchronization. FIG. 15 depicts orchestration and feedback-driven refinement, and FIG. 16 emphasizes algorithm selection and function-specific token generation. FIG. 17 integrates these elements into a network-wide control framework. Each figure may operate as a silo or as a stage in a unified system for transformer-driven configuration and management of heterogeneous networks.

The embodiments include computing devices and processing systems configured for real-time configuration and management of network devices using a network orchestration transformer model (NOTM). The NOTM may transform schema-defined tokens into device-specific patches that adjust routing behavior, enforce QoS policies, and apply traffic-prioritization rules. A network device or controller may generate tokens representing device capabilities, service objectives, policies, topology, and telemetry, and a processing system may process those tokens through a transformer to produce validated configuration outputs that directly alter device operation.

In some embodiments, the token schema may represent available resources and service demands. A capability token may encode processor cores, memory capacity, accelerator type, and storage volume, while a service token may encode required CPU, memory, bandwidth, and latency parameters. For example, a capability token may specify four virtual CPUs, 8 GB RAM, one GPU, and 200 GB SSD, while a service token may specify two CPUs, 2 GB RAM, 1 Gbps bandwidth, and 10 ms latency. A processing system may compare service tokens to capability tokens to generate a placement plan, and the NOTM may emit container deployment instructions for selected nodes. Other tokens may capture leadership or redundancy, such as a dominance token that identifies the node in a cluster with the lowest end-to-end latency as leader, configuring others as backups with health checks and takeover thresholds.

When a network device boots, it may retrieve identifiers and state such as MAC address, serial number, firmware level, memory size, storage type, and port inventory. If no stored configuration exists, a NOTM may generate a default configuration that enables management access, baseline security, and basic connectivity. After initialization, the device may discover and authenticate to access points, ISPs, enterprise controllers, or slice controllers. The device may then retrieve configuration artifacts and service plans, tokenize them, and submit them to the NOTM for inference. The NOTM, implemented as an encoder-decoder transformer, may generate device-specific outputs including routing-table adjustments, QoS policies, and path selections, which the device may apply as CLI commands, API calls, or controller intents.

The system may operate in a closed loop. A device may monitor traffic rate, latency, jitter, and packet-loss values and encode them as KPI tokens. The NOTM may process the KPI tokens and emit incremental patches that adjust only the affected parameters while preserving unrelated configuration. If a slice controller is reachable, the device may request guidance and apply received patches; if no authority responds, the device may invoke a local NOTM instance to generate updated patches autonomously. Adjustments may be propagated across peer devices so that routing, QoS, and prioritization remain synchronized within the network.

In some embodiments, the NOTM may delegate subproblems to SLNMs at the edge. For example, an SLNM on a Wi-Fi access point may schedule OFDMA resource units, an SLNM on a router may enforce VLAN QoS, and an SLNM on a firewall may enforce user-based rate limiting. A cloud NOTM may aggregate SLNM outputs to refine a global model. Model updates may be propagated on a schedule or in response to KPI deviation, such as when measured latency exceeds an SLA bound. A federated-learning aggregator may compute weighted averages of model-delta vectors from multiple nodes and distribute updated parameters back to those nodes, enabling consistent adaptation across deployments.

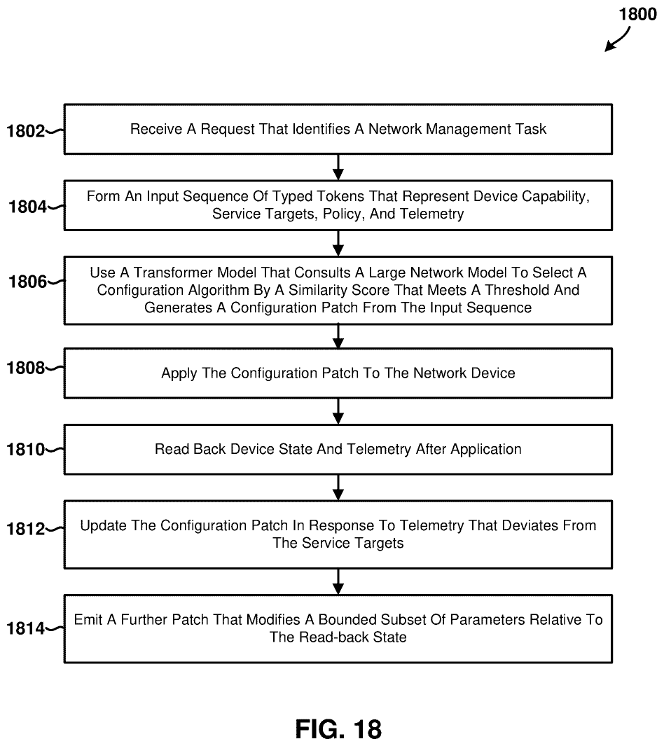

The system described in FIGS. 18-20 provides an integrated framework for dynamic and federated network management. A NCF may tokenize device capabilities, service requirements, and telemetry into structured inputs, weight and encode those inputs, and generate schema-validated configuration patches that directly adjust device operation. Edge devices may apply patches locally, monitor performance in real time, and refine patches incrementally, while also transmitting model-delta update(s) to aggregators. Aggregators may compute weighted averages across updates, validate the aggregates on holdout datasets, and redistribute synchronized parameters with tamper-evident provenance records. Unlike conventional systems that rely on static templates or centralized controllers, this architecture enables closed-loop adaptation, distributed learning, and federated consistency across heterogeneous devices and domains. The result is a resilient network management system that applies precise, bounded, and auditable configuration changes while continuously improving through validated collaboration.

FIG. 18 illustrates a method 1800 of configuring and managing a network device in accordance with some embodiments. Method 1800 may be performed by a processor or processing system in a NCF and integrates transformer-based inference with schema-constrained patching. The method enables dynamic updates that align configuration with service targets while avoiding disruptive bulk reloads.

In block 1802, the processor may receive a request that identifies a network management task, such as QoS evaluation or policy enforcement. The request may specify service targets and device identifiers so that subsequent inference aligns with explicit objectives.

In block 1804, the processor may form a network-context token set that includes typed tokens representing device capability, service targets, policy, and telemetry. The tokens may include positional encodings to preserve ordering and dependencies and may also include a device-identity token derived from a salted hash of a MAC address for provenance. A network-context weighting profile may bias token attention toward real-time attributes such as congestion, device proximity, and available bandwidth.

In block 1806, the processor may use a transformer model that invokes a LNM to select a configuration algorithm by a similarity score that meets a defined threshold. The transformer may generate a schema-validated configuration patch from the token sequence. Threshold-based selection may ensure that the chosen algorithm fits device capabilities and service targets.

In block 1808, the processor may apply the configuration patch to the network device. The patch may be validated against device grammar prior to application and may be mapped into device syntax as CLI commands, API calls, or controller intents.

In block 1810, the processor may read back device state and telemetry after application. The telemetry may include latency, jitter, packet loss, throughput, and queue depth, encoded as KPI tokens.

In block 1812, the processor may update the configuration patch in response to telemetry that deviates from the service targets. The processor may compute a diff between intended state and the read-back state to identify which parameters require change.

In block 1814, the processor may emit a further patch that modifies only the bounded subset of parameters indicated by the diff, preserving unrelated configuration. This incremental approach avoids service disruption and maintains compliance with service targets.

Conventional network management often relies on static templates or manual configuration changes applied during maintenance windows. Those approaches can be rigid and slow to adapt. By contrast, Method 1800 leverages an AI model to make context-aware adjustments continuously. For example, unlike conventional controllers that might push the same pre-defined settings everywhere, this method selects a configuration algorithm that specifically fits the device's situation by comparing the request against known solutions (using a similarity score threshold). It ensures the change is compatible with the device's capabilities and current goals, rather than one-size-fits-all. Another advantage is avoiding “bulk reloads”-traditionally, updating a router might involve replacing its whole config file, causing downtime. Here, only a small patch is applied, so the network stays up while improvements are made. For all these reasons, method 1800 provides a smarter and more responsive way to manage network devices, reducing downtime and manual effort.

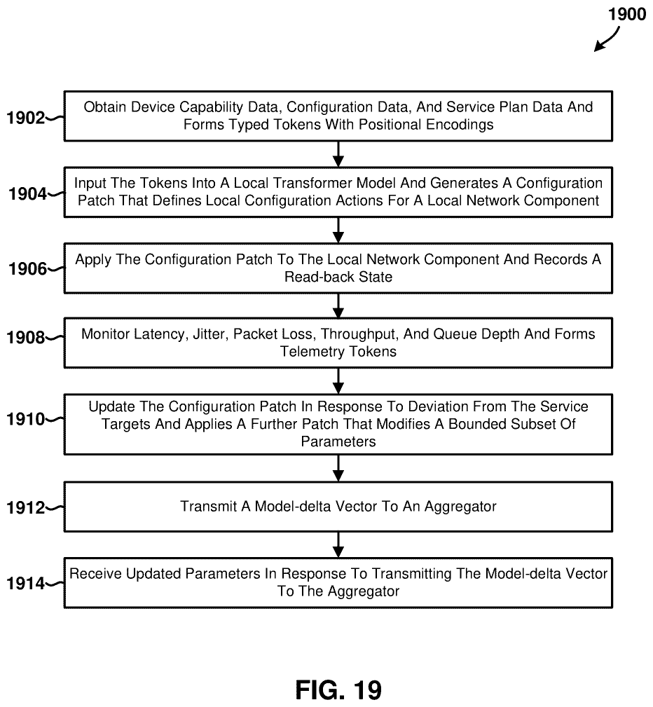

FIG. 19 illustrates a method 1900 performed by an edge device in accordance with some embodiments. Method 1900 may be performed by a processor in an edge device and allow the edge device to autonomously configure itself, refine local behavior through transformer inference, and contribute model updates to a federated system.

In block 1902, the processor in the edge device may obtain device capability data, configuration data, and service plan data and may form a network-context token set with positional encodings. The tokens may include a device-identity token derived from a salted hash of a MAC address.

In block 1904, the processor may input the token set into a local transformer model and may generate a configuration patch that defines local configuration actions for a local network component. Schema-constrained decoding ensures that the patch complies with device grammar.

In block 1906, the processor may apply the configuration patch to the local component and may record a read-back state. Each directive may be logged in a hash-chained tamper-evident record with a timestamp, device identifier, and model version identifier.

In block 1908, the processor may monitor telemetry such as latency, jitter, packet loss, throughput, and queue depth and may form telemetry tokens from the observed values. The edge device may also classify flows with dynamic flow inspection and map flows to slices that enforce the service targets.

In block 1910, the processor may update the configuration patch when telemetry deviates from service targets and may emit a further patch that modifies only a bounded subset of parameters relative to the read-back state.

In block 1912, the processor may transmit a model-delta vector derived from local inference updates to an aggregator.

In block 1914, the processor may receive updated parameters from the aggregator in response to the transmission and may load them into the local transformer to improve subsequent inference.

Conventional edge devices often use configurations pre-set by central controllers or network administrators. Those static configs might not account for real-time local changes or may become outdated. In contrast, Method 1900 allows the device to adapt immediately to local issues. For example, if a certain type of traffic is causing congestion on that device, the device's own AI model may recognize it (through telemetry tokens) and adjust things like queue management or routing on the spot. A conventional setup might require an administrator to notice the issue via an alert and then log in to change settings, or a scheduled policy update from the central controller-which is much slower. Another advantage is the federated learning. Traditional networks rarely learn from device to device; at best, an admin might manually apply a known good setting across many devices. Here, the system does it automatically by merging updates in the aggregator. The edge device contributes model updates to a federated system, meaning improvements are crowdsourced from all devices and redistributed. This yields a network that continuously improves its configuration policies, unlike a traditional network that stays static until a human makes a new template. Additionally, by using schema-constrained patches, the device ensures it doesn't apply incorrect or harmful commands-a safety check that manual configuration might miss. Overall, Method 1900 offers speed, local optimization, and collective intelligence, surpassing the slower, one-size-fits-all approach of conventional network management.

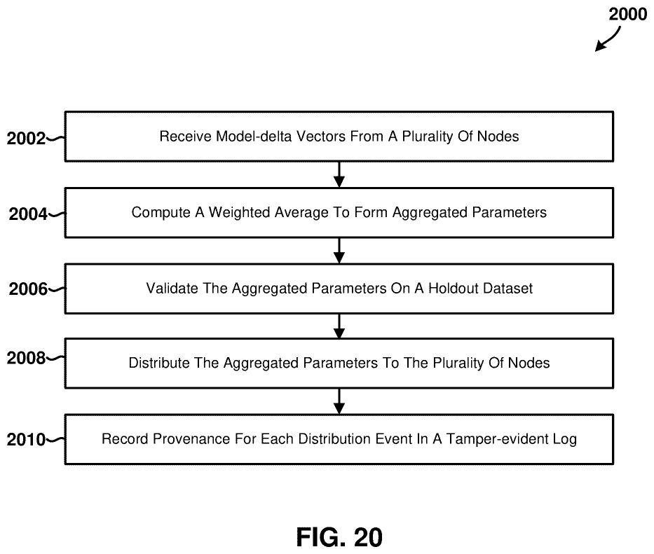

FIG. 20 illustrates a method 2000 performed by an aggregator server in accordance with some embodiments. Method 2000 supports federated learning by combining updates from multiple nodes and distributing validated parameters.

In block 2002, the processor in the aggregator server may receive model-delta vectors from a plurality of nodes.

In block 2004, the processor may compute a weighted average of the received model-delta vectors to form aggregated parameters. Weighting may reflect traffic volume, node reliability, or other operational context.

In block 2006, the processor may validate the aggregated parameters on a holdout dataset. The aggregator may reject an update that fails validation and request a resubmission that excludes an outlier.

In block 2008, the processor may distribute the aggregated parameters to the plurality of nodes to synchronize local models with the global state.

In block 2010, the processor may record provenance for each distribution event in a tamper-evident log. The log may chain entries with cryptographic hashes and may include distribution timestamps, node identifiers, and parameter version identifiers.

Method 2000 provides a systematic, data-driven way to continuously improve network configurations. Conventional network management solutions do not have features comparable to the collective learning features discussed above. In conventional systems, if one router is tuned a certain way by an engineer, that knowledge isn't automatically transferred to other routers, and there is no automated global validation. The embodiments allow the system to leverage scale: the more devices, the more data and scenarios to learn from, which may lead to a more resilient configuration strategy across the network. Another advantage is reliability: by validating updates on a holdout dataset (e.g., simulating changes on test data), the aggregator avoids pushing harmful changes network-wide. In a conventional solution, if an admin makes a configuration script and it has an error or a suboptimal setting, they might roll it out to many devices and only realize later it causes issues. Method 2000 may allow the system to catch those issues beforehand in a simulated environment. The tamper-evident log is another advantage—it provides an audit trail of changes, improving accountability and security (conventional systems might rely on manual record-keeping or none at all). Also, the weighting mechanism allows the system to intelligently pay more attention to updates from more relevant conditions, whereas conventional solutions treat all changes or inputs equally (or simply have no systematic way to merge knowledge).

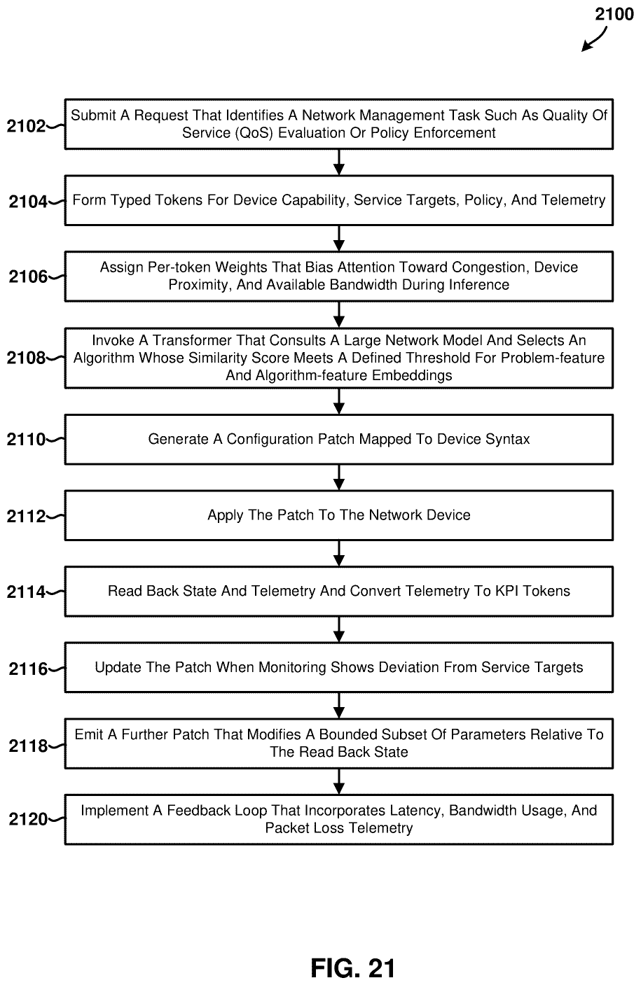

FIG. 21 illustrates a method 2100 of configuring and managing a network device using a transformer model and a NCF under an integrated control path in accordance with some embodiments. Method 2100 combines a transformer model, a LNM, and schema-constrained patches to continuously reconfigure devices across heterogeneous networks, ensuring compliance with service targets while avoiding the outages and rigidity of conventional template-driven controllers. In particular, method 2100 may be performed by a processor or processing system in a NCF to generate schema-constrained configuration patches from tokenized inputs and transformer-based inference, allowing network devices to adapt in real time to telemetry and maintain service targets without the disruption of static templates.

In block 2102, a processor of a NCF may submit a request that identifies a network management task such as quality of service (QoS) evaluation or policy enforcement. For example, the processor may post {task: qos_eval, target: VLAN101, slice: gold, metrics: [latency, loss], deadline: 2025 Oct. 1} to an internal/ncf/tasks endpoint and receive a request identifier. This request may define explicit scope and measurable objectives so that a downstream model may align its configuration patch with the specified service targets, instead of applying a static template that conventional controllers push without regard to real-time conditions.

In block 2104, the processor of the NCF may form typed tokens for device capability, service targets, policy, and telemetry. The processor may include a device-identity token derived from a salted MAC for provenance and may assign positional encodings to device-capability tokens and service-class tokens for selection and decoding.

In block 2106, the processor of the NCF may assign per-token weights that bias attention toward congestion, device proximity, and available bandwidth during inference. For example, the processor may compute weights and scale each token embedding as E′ᵢ=wᵢ·Eᵢ before the attention step. The processor may then attach values such as w_congestion=0.55, w_proximity=0.30, and w_bandwidth=0.15 to the corresponding tokens for the next inference pass. Emphasizing congestion in the weighting may trigger immediate mitigation during a traffic burst.

In block 2108, the processor of the NCF may invoke a transformer that invokes a LNM and selects an algorithm whose similarity score meets a defined threshold for problem feature and algorithm feature embeddings. The processor may locate the transformer on a cloud server or an edge device under common control. For example, the processor may send the ordered token sequence S to/model/infer, may receive candidate algorithms with embeddings, compute similarity between a problem feature vector and each algorithm feature vector, and select WFQ_rebalance when score ≥0.85. When score <0.85 the processor may adjust features and repeat selection. Threshold-based similarity scoring may align chosen algorithms with both hardware limits and service targets.

In block 2110, the processor of the NCF may generate a configuration patch mapped to device syntax. For example, the processor may decode a schema-constrained patch that sets queue weights and shaping on interface ge0/1, such as set queue 1 weight 40, set queue 0 weight 20, and set shape-rate 100M, and may emit the patch as a YANG edit-config or as a CLI transaction that the target device accepts natively. Before emission, a schema-constrained decoder may validate the sequence against the device grammar to confirm that token types, field ranges, and command order match the expected syntax. Converting model outputs into validated device-specific syntax may allow direct enforcement on equipment from diverse vendors.

In block 2112, the processor of the NCF may apply the patch to the network device. For example, the processor may open a NETCONF session, stage the patch in the candidate datastore, call <validate/>, and commit with a guard that checks interface presence and firmware level before activation. Applying configuration patches transactionally with precondition checks may prevent outages that occur when bulk templates overwrite active device states.

In block 2114, the processor of the NCF may read-back state and telemetry and convert telemetry to KPI tokens. For example, the processor may call get-config to confirm queue weights, read/interfaces/state/queue via RESTCONF for depth and drops, run an active latency probe, and encode results as kpi_token {latency_ms: 58, jitter_ms: 7, loss_pct: 0.05, ts: “. . . ”}. Reading back applied state and telemetry may supply verified ground truth for the next inference cycle, whereas conventional dashboards offer passive observation without direct control linkage.

In block 2116, the processor of the NCF may update the patch when monitoring shows deviation from service targets. For example, the processor may compare the KPI token to the service-class token and may detect latency at 58 ms versus a 50 ms target, may construct update tokens delta_queue 1_weight: +10 and delta_best_effort_weight:−10, and request a refined patch. Adaptive patching during a peak may correct drift in real time, avoiding the deferred corrections that conventional systems wait to apply during scheduled maintenance.

In block 2118, the processor of the NCF may emit a further patch that modifies a bounded subset of parameters relative to the read-back state. For example, the processor may compute a diff between intended and observed state and output a patch that adjusts queue weights and a shaping rate while leaving ACL entries and interface bindings untouched. The processor may also include idempotent steps with a rollback guard. Limiting edits to a bounded subset of parameters may reduce configuration churn and shorten commit cycles, unlike full template reloads that disrupt live traffic flows.

In block 2120, the processor of the NCF may implement a feedback loop that incorporates latency, bandwidth usage, and packet loss telemetry and that drives updates under blocks 2116 and 2118. For example, the processor may schedule inference at 30-second intervals with exponential backoff on failure, cap loop jitter at 5 seconds, and publish anonymized model-delta vectors to an aggregator that validates aggregated parameters on a holdout dataset before distribution. Unlike conventional static policies that lag behind changing conditions, the feedback loop may allow the system to maintain service-level compliance across diurnal shifts.

Method 2100 provides a unified process in which a NCF uses transformer-based inference and schema-constrained patches to configure devices in real time, continuously aligning configuration state with live telemetry. By tokenizing device capabilities, service objectives, and policy rules, weighting them according to observed conditions, and applying threshold-based algorithm selection from a LNM, the method delivers device-specific patches that adjust only the parameters that need change. This approach avoids the disruption of static templates, reacts immediately to performance drift, and enforces SLAs across heterogeneous vendors, yielding a system that is more adaptive, reliable, and auditable than conventional network controllers.

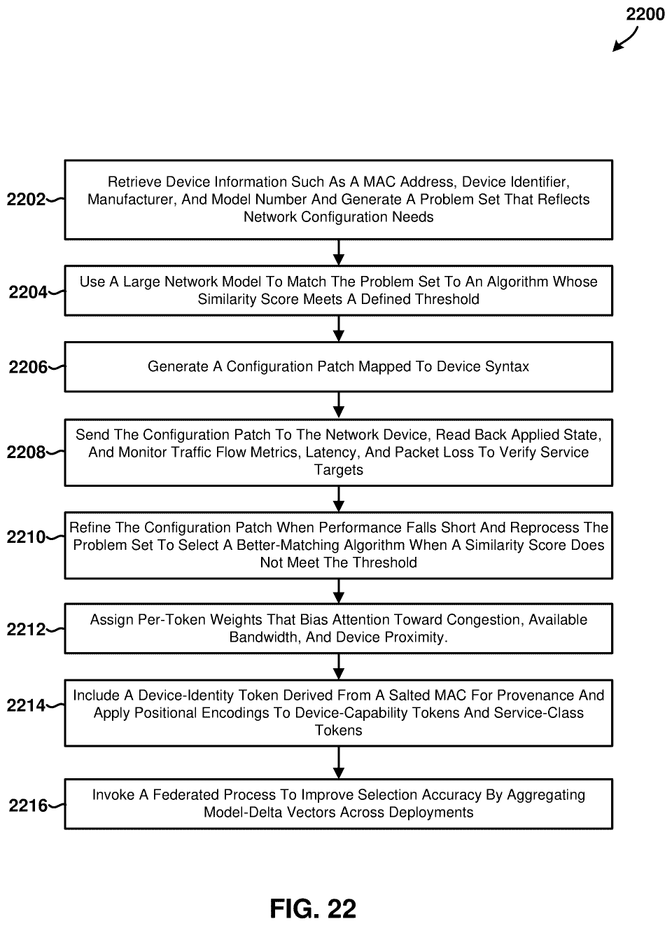

FIG. 22 illustrates a method 2200 of dynamically configuring and managing a network device using a network orchestration transformer model in accordance with some embodiments. Method 2200 may combine tokenized device and service inputs, transformer-based inference, and threshold-based algorithm selection from a LNM to generate schema-constrained configuration patches that adjust live device behavior. Method 2200 may be performed by a processor or processing system in a NCF to retrieve device attributes, generate problem sets, and deliver validated patches that maintain service targets across heterogeneous platforms while avoiding the rigidity of static configuration templates.

In block 2202, a processor in a NCF may retrieve device information such as a MAC address, device identifier, manufacturer, and model number and generate a problem set that reflects network configuration needs. For example, the processor may query DHCP options, SNMP object identifiers, and device certificates to collect model and firmware values, and then encode those values into typed tokens together with requested QoS metrics. Unlike conventional controllers that rely on static device inventories that often drift out of date, this structured retrieval allows subsequent inference to align with the real hardware and service targets.

In block 2204, the processor in the NCF may use a LNM to match the problem set to an algorithm whose similarity score meets a defined threshold. For example, the processor may compare an embedding of the problem set to embeddings of candidate scheduling and shaping algorithms and select one when the cosine similarity exceeds 0.85. Unlike conventional controllers that apply a fixed scheduling policy without context, threshold-based matching may ensure that the selected algorithm fits both device constraints and service targets.

In block 2206, the processor in the NCF may generate a configuration patch mapped to device syntax. Before emission, a schema-constrained decoder may validate the sequence against the device grammar so token types, field ranges, and command order match the expected syntax. For example, the processor may output router commands that adjust queue weights and DSCP mappings and may format the patch as a CLI script or YANG edit so that the device accepts it directly. Schema-constrained decoding prevents syntax errors, and unlike conventional intent-based systems that stop at abstract policy definitions, the direct mapping to device syntax enables immediate enforcement on heterogeneous platforms.

In block 2208, the processor in the NCF may send the configuration patch to the network device, may read back applied state, and may monitor traffic flow metrics, latency, and packet loss to verify service targets. For example, the processor may stream counters from the device, compare observed latency against the gold slice threshold of 50 ms, and encode the results into KPI tokens. For example, continuous monitoring drives corrective action, while conventional dashboards merely report values without feeding them back into configuration logic.

In block 2210, the processor in the NCF may refine the configuration patch when performance falls short and may reprocess the problem set to select a better-matching algorithm when a similarity score does not meet the threshold. For example, the processor may detect packet loss above 0.1%, increase the weight on congestion tokens, and rerun selection to choose a shaping algorithm better suited to current load. For example, adaptive reprocessing ensures timely recovery, in contrast to scheduled reconfigurations in legacy systems.

In block 2212, the processor in the NCF may assign per-token weights that bias attention toward congestion, available bandwidth, and device proximity. For example, the processor may increase the weight for congestion tokens during inference when queue depth rises, so that congestion dominates attention in the model. For example, dynamic weighting allows faster relief under bursty conditions, unlike conventional uniform weighting that delays correction.

In block 2214, the processor in the NCF may include a device-identity token derived from a salted hash of a MAC address for provenance and apply positional encodings to device-capability tokens and service-class tokens. For example, the processor may hash the MAC with a salt to generate a stable but anonymized identity token and may assign positional indices so the model recognizes the relative order of capability and service tokens. Provenance and positional encoding preserve traceability and sequence dependencies. The identity token may carry low weight and may not serve as a positional anchor.

In block 2216, the processor in the NCF may invoke a federated process to improve selection accuracy by aggregating model-delta vectors across deployments. For example, the processor may upload local model updates that reflect observed performance to a cloud aggregator (or an AI slice controller acting in an aggregation role), which validates the aggregate on a holdout dataset before redistributing it. For example, this continuous refinement spreads local learning without sharing raw data, unlike conventional systems that never evolve beyond their initial rule sets.

Method 2200 provides a structured process in which a NCF retrieves device information, tokenizes capabilities and service requirements, and applies transformer-based inference to select algorithms and generate schema-constrained patches. Continuous monitoring and adaptive weighting ensure that patches modify only the parameters that drift from service targets, and federated aggregation of model-delta update(s) improves global performance. Unlike conventional controllers that rely on static rule sets, method 2200 enables dynamic, context-aware reconfiguration that preserves reliability, responsiveness, and consistency across diverse vendors.

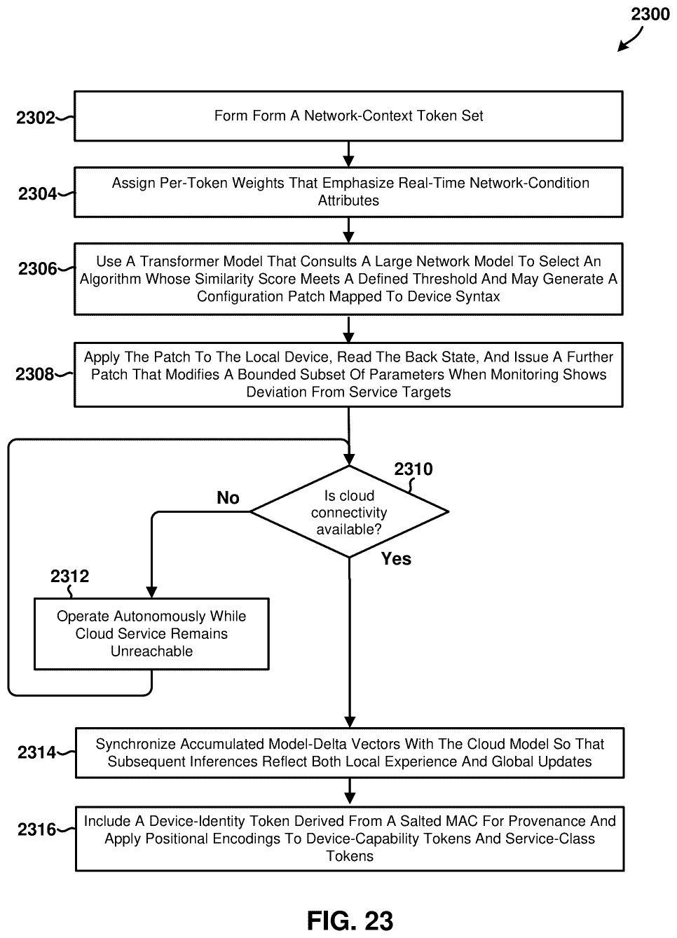

FIG. 23 illustrates a method 2300 of configuring and managing a network device at the edge using a transformer model and a local NCF under an integrated control path in accordance with some embodiments. Method 2300 enables edge controllers to transform device capabilities, service targets, policies, and telemetry into schema-defined tokens, weight those tokens according to observed conditions, and apply transformer-based inference with schema-constrained decoding to generate configuration patches that enforce service targets locally. By permitting autonomous operation when cloud services are unavailable and synchronizing parameters when connectivity is restored, the method provides resilient control across heterogeneous domains.

In block 2302, a processor in a local NCF may form a network-context token set, which may include typed tokens representing device capability, service targets, policy, topology, and telemetry. For example, the edge controller may tokenize port availability, firmware level, SLA latency thresholds, and queue depth counters and package them into an ordered sequence. Unlike conventional edge devices that rely on central templates, forming a network-context token set allows the edge device to perform autonomous inference locally.

In block 2304, the processor in the local NCF may assign per-token weights that emphasize real-time network-condition attributes, such as congestion indicators, device proximity, available bandwidth, or other operational context parameters derived from telemetry. For example, the processor may compute a congestion score from observed queue depths, a proximity score from radio signal strength, and a bandwidth headroom score from link advertisements, normalize them with a softmax function, and scale the corresponding token embeddings (E′ᵢ=wᵢ·Eᵢ). This weighting drives context-aware inference, enabling the model to prioritize mitigation where needed most, whereas conventional systems apply uniform weighting and rely on manual operator intervention.

In block 2306, the processor in the local NCF may use a transformer model that invokes a LNM to select an algorithm whose similarity score meets a defined threshold and may generate a configuration patch mapped to device syntax. For example, the processor may embed the token sequence, query a reduced LNM for candidate algorithms, and select an OFDMA scheduler when the similarity score exceeds 0.9. The transformer may then decode a patch that updates Wi-Fi resource unit assignments. Before emission, a schema-constrained decoder validates the patch against the target device grammar to ensure all fields, ranges, and command sequences are valid. These operations may align algorithm selection and patch generation with current device state.

In block 2308, the processor in the local NCF may apply the patch to the local device, read-back state and telemetry, and issue a further patch that modifies a bounded subset of parameters when monitoring shows deviation from service targets. For example, the processor may confirm that new queue weights were committed, detect jitter above the SLA threshold, and output a delta patch that adjusts only shaping rates without altering ACL entries or unrelated policies. This incremental approach reduces churn and preserves stability, while conventional bulk reloads disrupt service by replacing entire configurations.

In block 2310, the processor may determine if cloud connectivity is and has remained available during the patching and monitoring cycle. In response to determining that cloud connectivity is unavailable during the patching and monitoring cycle (i.e., determination block 2310=No), in block 2312 the processor in the local NCF may continue to operate autonomously using the locally generated network-context token set and weighting profile. For example, the processor may cache KPI tokens and incremental patches during the outage. When connectivity resumes (i.e., determination block 2310=Yes), in block 2314 the processor in the local NCF may synchronize accumulated model-delta vectors with the cloud model so that subsequent inferences reflect both local experience and global updates.

In block 2316, the processor in the local NCF may include a device-identity token derived from a salted hash of a MAC address for provenance and apply positional encodings to device-capability tokens and service-class tokens. For example, the processor may hash the MAC with a salt, embed the resulting token with low weight, and assign indices so capability tokens precede service tokens in the sequence. The inclusion and use of tokens may ensure provenance without using raw identifiers (in contrast to conventional logs that expose unprotected MAC addresses).

Method 2300 provides an edge-centric control framework in which a local NCF tokenizes device and service information, weights tokens according to observed conditions, and generates bounded, schema-validated configuration patches through transformer inference. Read-back validation and incremental updates sustain alignment with service targets even when disconnected from the cloud, while synchronization with a global model propagates improvements across deployments. Unlike legacy edge devices that depend entirely on central controllers, method 2300 delivers autonomy, resilience, and auditable compliance with service targets.

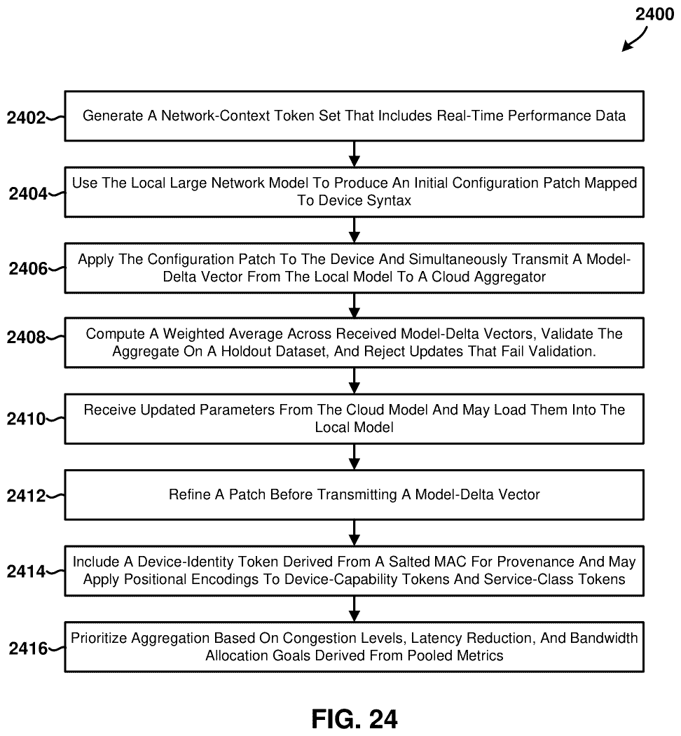

FIG. 24 illustrates a method 2400 of federated learning and dynamic network management in accordance with some embodiments. Method 2400 allows a local processor to tokenize device state and telemetry, generate initial configuration patches using a local LNM, and transmit model-delta update(s) to an AI slice controller. The aggregator computes weighted averages, validates the aggregates against holdout datasets, and redistributes updated parameters. This arrangement enables continuous adaptation without raw data exchange and prevents the stagnation of static configuration systems.

In block 2402, a processor in a local device may generate a network-context token set, which may include typed tokens representing device capability, service targets, policy, topology, and telemetry together with real-time performance data such as latency, jitter, and packet loss. For example, the processor may encode flow counts as KPI tokens, neighbor links as topology tokens, and SLA objectives as service-class tokens, and submit them to a local LNM for inference. These operations may transform raw metrics into structured inputs for inference.

In block 2404, the processor in the local device may use the local LNM to produce an initial configuration patch mapped to device syntax. For example, the model may generate a patch that adjusts VLAN queue depth and Wi-Fi scheduling assignments, format the patch as NETCONF edit-config statements, and validate the sequence against a schema-constrained decoder before emission. Schema-validated patching ensures syntactic correctness (whereas conventional manual adjustments risk misconfigurations and downtime).

In block 2406, the processor in the local device may apply the configuration patch to the device and simultaneously transmit a model-delta vector from the local model to an AI slice controller. For example, the processor may commit the patch to modify shaping rates and upload gradient updates representing changes to attention weights. This dual action may enforce immediate corrections locally and contribute to global learning.

In block 2408, a processor in the AI slice controller may compute a weighted average across received model-delta vectors, validate the aggregate on a holdout dataset, and reject updates that fail validation. For example, the aggregator may assign higher weight to updates from nodes with higher traffic volume, test the aggregate against reserved KPI traces, and discard outliers that degrade accuracy. This may prevent model drift and preserves stability.

In block 2410, the processor in the local device may receive updated parameters from the cloud model and may load them into the local model. The updates may be versioned with provenance metadata. As an example, the edge device may replace its local embeddings and attention weights with aggregated values so that the edge model converges with the fleet-wide model.

In block 2412, the processor in the local device may refine a patch before transmitting a model-delta vector. For example, the processor may detect jitter above SLA bounds, apply a local delta patch to reduce buffer size, and encode only the residual parameter differences into the update vector.

In block 2414, the processor in the local device may include a device-identity token derived from a salted hash of a MAC address for provenance and may apply positional encodings to device-capability tokens and service-class tokens. For example, the processor may hash the MAC address with a salt, embed the result with low weight for audit logs, and assign positional indices so that capability tokens precede service tokens. This preserves provenance and sequence dependencies without exposing raw identifiers (unlike conventional logs that reveal unprotected MACs).

In block 2416, the processor in the AI slice controller may prioritize aggregation based on congestion levels, latency reduction, and bandwidth allocation goals derived from pooled metrics. For example, the aggregator may increase weighting for updates from nodes experiencing high congestion to accelerate convergence.

Method 2400 defines a federated control cycle in which local devices generate and apply schema-constrained patches while sharing anonymized model-delta update(s) with an AI slice controller. Validation on holdout datasets preserves stability, and adaptive weighting ensures that high-impact updates guide convergence. This balances local autonomy with global consistency, unlike conventional controllers that either remain siloed or apply unverified global updates. The result is a network management system that evolves continuously, enforces service targets, and improves with each deployment.

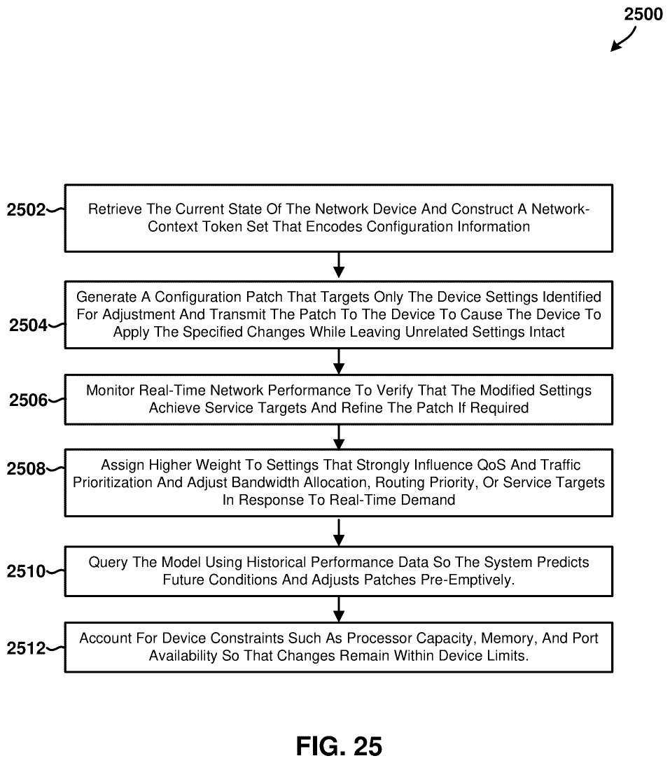

FIG. 25 illustrates a method 2500 of enhancing configuration patches for a network device using weighted information and a LNM in accordance with some embodiments. Method 2500 retrieves device configuration data, identifies settings requiring adjustment, and generates schema-constrained patches that modify only those settings while preserving unrelated ones. The method incorporates real-time monitoring, predictive refinement using historical data, and constraint checks that prevent overload, thereby maintaining compliance with service targets across diverse devices.

In block 2502, a processor in communication with a LNM may retrieve the current state of the network device and construct a network-context token set that encodes configuration information. The network-context token set may include tokens representing quality-of-service (QoS) policies, routing tables, and traffic-prioritization rules, together with tokens for device capabilities, service targets, topology attributes, and real-time telemetry. For example, the processor may parse device counters and configuration files, extract DSCP mappings and queue assignments, combine these with SLA performance thresholds and observed latency values, and encode the results into schema-defined tokens arranged in a structured sequence for inference.

In block 2504, the processor may generate a configuration patch that targets only the device settings identified for adjustment and may transmit the patch to the device to cause the device to apply the specified changes while leaving unrelated settings intact. The configuration patch may be derived from the network-context token set as processed by the LNM and may encode directives in the syntax of the target device. For example, the processor may construct a patch that adjusts queue depth on port ge0/1 while preserving existing ACLs, routing entries, and service mappings, and may validate the patch with a schema-constrained decoder to confirm that command types, parameter ranges, and sequence order comply with the device grammar before emission.

In block 2506, the processor and the model may monitor real-time network performance to verify that the modified settings achieve service targets and refine the patch if required. For example, the processor may observe latency above SLA bounds after a patch is applied, generate KPI tokens encoding the deviation, and adjust shaping rates accordingly. Unlike conventional systems that depend on manual post-change audits, this closed-loop verification may autonomously sustain compliance.

In block 2508, the model may assign higher weight to settings that strongly influence QoS and traffic prioritization and adjust bandwidth allocation, routing priority, or service targets in response to real-time demand. For example, the processor may raise the weight of bandwidth tokens during congestion, biasing inference toward flow rebalancing. This dynamic reweighting may adapt configurations to changing conditions.

In block 2510, the processor may query the model using historical performance data so the system predicts future conditions and adjusts patches pre-emptively. For example, the processor may detect that daily peak demand occurs at 8 pm, encode that recurring pattern in time-series embeddings of KPI tokens, and generate a patch that increases shaping rates before the surge begins. This predictive refinement prevents service degradation, while conventional systems react only after violations occur.

In block 2512, the processor may account for device constraints such as processor capacity, memory, and port availability so that changes remain within device limits. For example, the processor may evaluate CPU headroom before enabling a deep packet inspection rule, skip the rule if capacity is insufficient, and log the skipped update with provenance metadata for audit. This constraint-aware patching prevents overload, unlike conventional template pushes that ignore device limits and risk failure.

Method 2500 provides a patch-enhancement framework in which a processor selectively adjusts only those parameters that affect performance, applies schema-validated patches, weights changes according to QoS importance, and predicts demand using historical KPI data. Constraint-aware patching ensures safe deployment, while continuous monitoring validates improvements against service targets. In contrast to bulk template reloads, method 2500 delivers targeted, efficient, and predictive adjustments that sustain stability and optimize performance across heterogeneous environments.

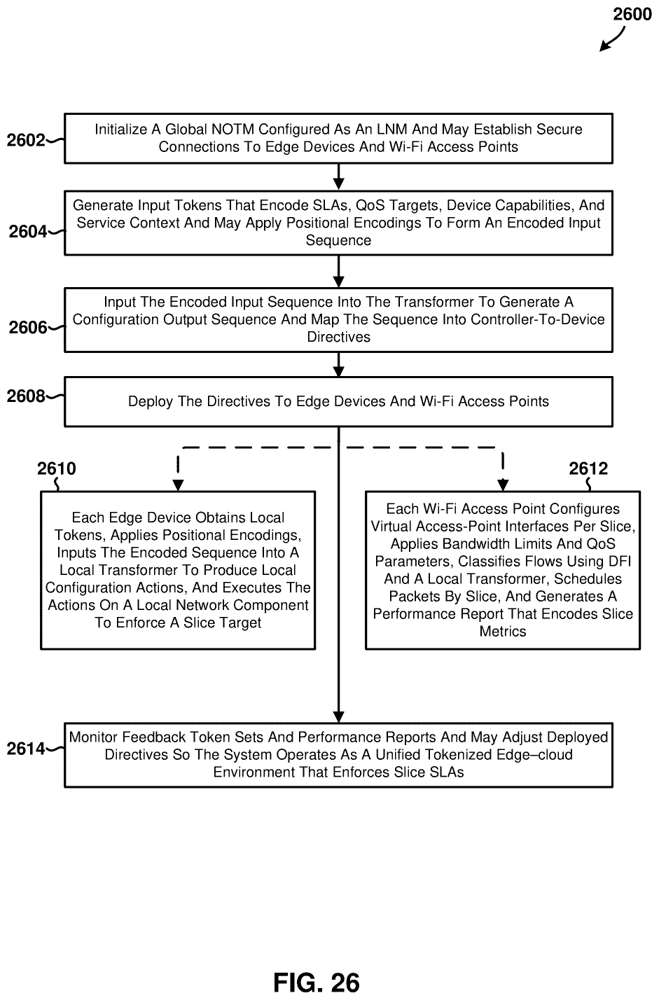

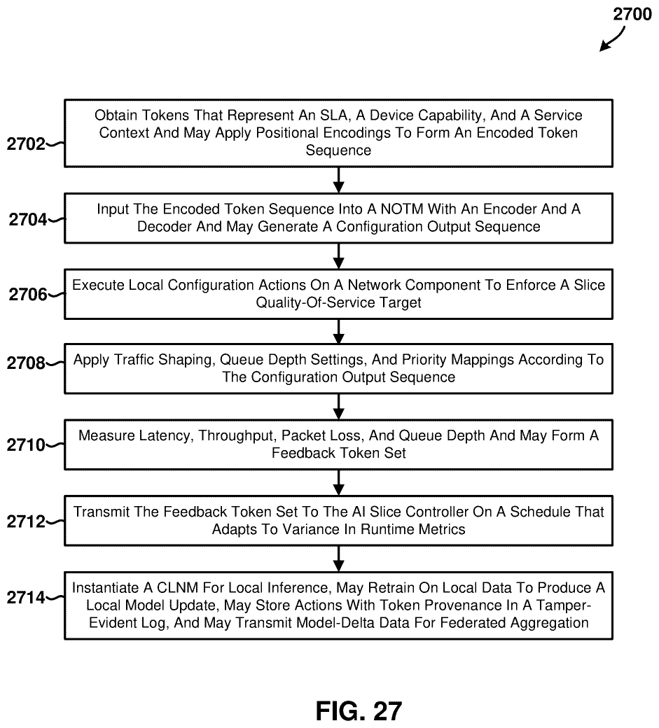

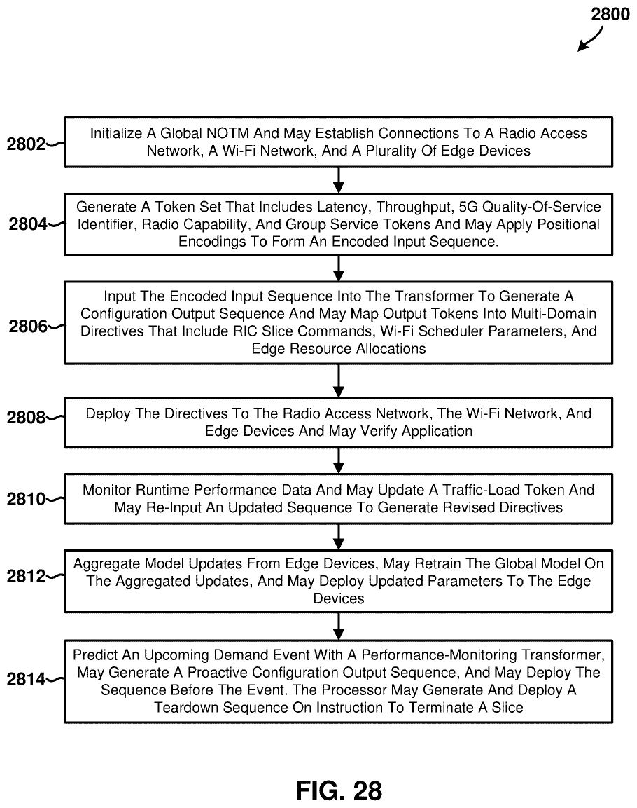

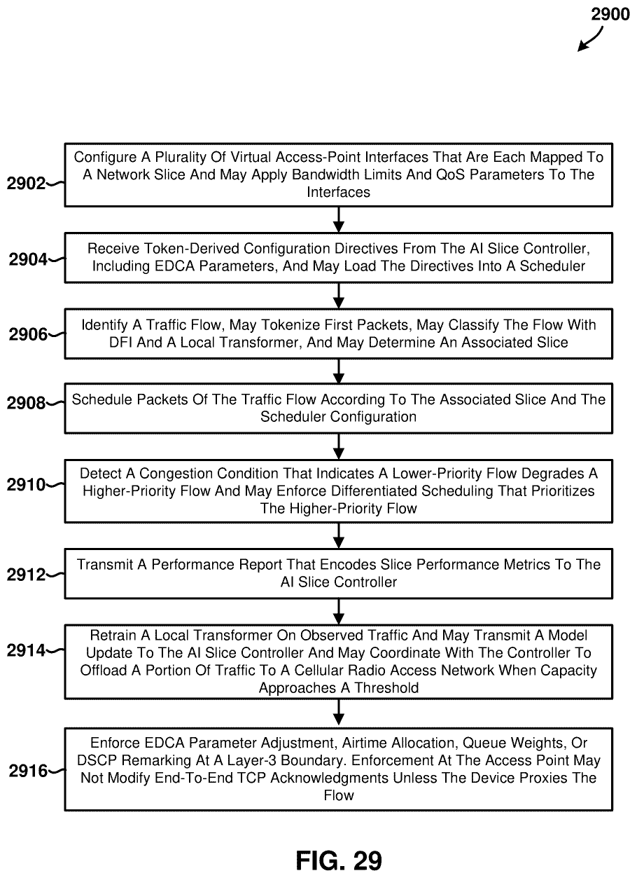

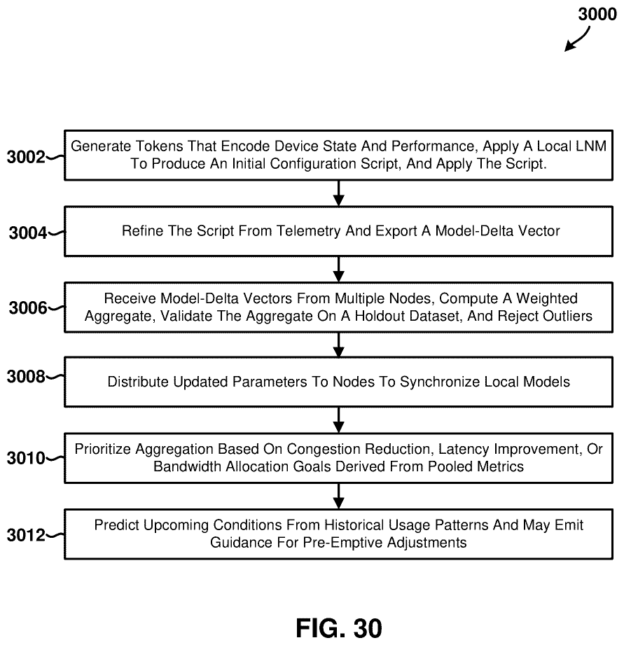

FIG. 26 through FIG. 31 show tokenized orchestration with positional encoding and schema-constrained patching across controller edge devices and Wi-Fi access domains. These flows may reduce control-plane latency and error rate and may improve recovery time under disturbance by closing the loop with feedback tokens and performance reports. FIG. 27 and FIG. 30 show edge autonomy and federated learning with model-delta exchange through the AI slice controller. These flows may sustain service during controller loss and may improve global behavior while preserving data locality at the edge. FIG. 28 and FIG. 29 show cross-domain deployment that maps output tokens into RIC slice commands Wi-Fi scheduler parameters edge allocations DSCP remark rules 5QI alignment and RU assignment. These flows may keep Qos treatment aligned across Wi-Fi, cellular, wireless, wired and non-terrestrial segments and may lower jitter and packet loss.

FIG. 26 illustrates a method 2600 for enforcing slice service targets across heterogeneous network domains in accordance with some embodiments. Method 2600 may be performed by an AI slice controller together with a plurality of edge devices and a plurality of Wi-Fi access points and may enforce slice service targets across domains.

In block 2602, the AI slice controller may initialize a global NOTM configured as an LNM and may establish secure connections to edge devices and Wi-Fi access points.

In block 2604, the AI slice controller may generate input tokens that encode SLAs, QoS targets, device capabilities, and service context and may apply positional encodings to form an encoded input sequence.

In block 2606, the AI slice controller may input the encoded input sequence into the transformer to generate a configuration output sequence and may map the sequence into controller-to-device directives.

In block 2608, the AI slice controller may deploy the directives to edge devices and Wi-Fi access points.

In block 2610, each edge device may obtain local tokens, may apply positional encodings, may input the encoded sequence into a local transformer to produce local configuration actions, and may execute the actions on a local network component to enforce a slice target. Each edge device may form a feedback token set that encodes runtime metrics.

In block 2612, each Wi-Fi access point may configure virtual access-point interfaces per slice, may apply bandwidth limits and QoS parameters, may classify flows using DFI and a local transformer, may schedule packets by slice, and may generate a performance report that encodes slice metrics.

In block 2614, the AI slice controller may monitor feedback token sets and performance reports and may adjust deployed directives so the system operates as a unified tokenized edge-cloud environment that enforces slice SLAs.

FIG. 27 illustrates a method 2700 of autonomously configuring a local network component at an edge device in accordance with some embodiments. Method 2700 may be performed by a processor in an edge device to configure a local network component with transformer inference and to contribute updates to a federated process.

In block 2702, the processor in the edge device may obtain tokens that represent an SLA, a device capability, and a service context and may apply positional encodings to form an encoded token sequence.

In block 2704, the processor may input the encoded token sequence into a NOTM with an encoder and a decoder and may generate a configuration output sequence.

In block 2706, the processor may execute local configuration actions on a network component to enforce a slice quality-of-service target.

In block 2708, the processor may apply traffic shaping, queue depth settings, and priority mappings according to the configuration output sequence. In some embodiments, the processor may enforce per-VLAN shaping on ingress and egress according to the configuration output sequence that references the GST and the mapped VLAN identifier.

In block 2710, the processor may measure latency, throughput, packet loss, and queue depth and may form a feedback token set. In some embodiments, the processor may classify microflows at a port using tokenized flow features and may apply per-flow rate limits under a hierarchical policy that references a slice context, a port context, and a user context.

In some embodiments, the processor in the edge device may classify microflows at a network interface with a local transformer that reads a token set derived from packet size statistics and inter-arrival time and directionality and may assign each microflow a target rate and a queue weight under a hierarchical slice policy. The processor may enforce a per-port ceiling and a per-flow ceiling and may emit a feedback token that records the observed rate, drop count, and queue depth per microflow.

In block 2712, the processor may transmit the feedback token set to the AI slice controller on a schedule that adapts to variance in runtime metrics.

In block 2714, the processor may instantiate a cLNM for local inference, may retrain on local data to produce a local model update, may store actions with token provenance in a tamper-evident log, and may transmit model-delta data for federated aggregation.

FIG. 28 illustrates a method 2800 of orchestrating multi-domain configuration in accordance with some embodiments. Method 2800 may be performed by a processor in an AI slice controller to orchestrate multi-domain configuration across radio access, Wi-Fi, and edge devices.

In block 2802, the processor may initialize a global NOTM and may establish connections to a radio access network, a Wi-Fi network, and a plurality of edge devices.

In block 2804, the processor may generate a token set that includes latency, throughput, 5G quality-of-service identifier, radio capability, and GSTs and may apply positional encodings to form an encoded input sequence. In some embodiments, the processor may include tokens that represent a non-terrestrial domain and map outputs into directives for satellite links together with terrestrial links.

In some embodiments, the AI slice controller may include tokens that represent a non-terrestrial domain and may map output tokens into directives for satellite gateways and terrestrial devices so that a unified slice configuration spans Wi-Fi, wired, cellular, and satellite paths. The processor may monitor KPIs from the non-terrestrial segment and may update the traffic-load token and may re-infer when link state changes. Non-terrestrial domain tokens may represent link state and access constraints for satellite segments and may include latency budget, jitter tolerance, visibility window, and gateway capacity. The AI slice controller may include such tokens in the encoded input sequence so that a transformer may generate directives that address terrestrial and non-terrestrial links in one configuration pass.

In some embodiments, the AI slice controller may include a cross-domain mapping token that unifies DSCP treatment in IP networks with Wi-Fi user priority and with 5G QoS identifiers so that the same service class receives consistent scheduling across domains. The controller may translate output tokens into DSCP remark rules, EDCA parameter sets, and 5QI assignments during deployment.

In block 2806, the processor may input the encoded input sequence into the transformer to generate a configuration output sequence and map output tokens into multi-domain directives that include RIC slice commands, Wi-Fi scheduler parameters, and edge resource allocations.

In some embodiments, the AI slice controller may form a vTBA token that maps a GST to a VPN or VLAN identifier and may include per-direction CIR and PIR values. The controller may deploy a directive that causes a Wi-Fi access point to instantiate a per-slice service set identifier and to apply the CIR and PIR on the radio interface and that causes an edge device to apply the CIR and PIR on a VLAN interface that corresponds to the same mapping. The controller may monitor slice metrics and may adjust the CIR and PIR values by re-inference when a measured load token crosses a threshold.

In block 2808, the processor may deploy the directives to the radio access network, the Wi-Fi network, and edge devices and may verify application.

In block 2810, the processor may monitor runtime performance data and may update a traffic-load token and may re-input an updated sequence to generate revised directives.

In block 2812, the processor may aggregate model updates from edge devices, may retrain the global model on the aggregated updates, and may deploy updated parameters to the edge devices.

In block 2814, the processor may predict an upcoming demand event with a performance-monitoring transformer, may generate a proactive configuration output sequence, and may deploy the sequence before the event. In some embodiments, the processor may generate and deploy a teardown sequence on instructions to terminate a slice.

FIG. 29 illustrates a method 2900 of enforcing per-slice scheduling in a Wi-Fi access point in accordance with some embodiments. Method 2900 may be performed by a processor in a Wi-Fi access point to enforce per-slice scheduling and reporting.

In block 2902, the processor may configure a plurality of virtual access-point interfaces that are each mapped to a network slice and may apply bandwidth limits and QoS parameters to the interfaces.

In block 2904, the processor may receive token-derived configuration directives from the AI slice controller, including EDCA parameters, and load the directives into a scheduler. In some embodiments, the processor may map a GST to a VPN or VLAN identifier and may bind a committed information rate and a peak information rate for downlink and uplink per the mapped identifier (e.g., under a vTBA scheme).

In block 2906, the processor may identify a traffic flow, may tokenize first packets, may classify the flow with DFI and a local transformer, and may determine an associated slice.

In block 2908, the processor may schedule packets of the traffic flow according to the associated slice and the scheduler configuration. In some embodiments, the processor may assign RUs per slice for uplink and for downlink, map a GST to an RU pool, and schedule packets within assigned RUs under the loaded scheduler parameters, and adjust EDCA parameters and queue weights to protect a higher-priority slice under a congestion condition.

In block 2910, the processor may detect a congestion condition that indicates a lower-priority flow degrades a higher-priority flow and may enforce differentiated scheduling that prioritizes the higher-priority flow. In some embodiments, the processor may proxy a TCP flow and adjust an acknowledgment window parameter to protect a higher-priority slice under a detected congestion condition.

In some embodiments, the processor in the Wi-Fi access point may proxy a TCP flow under a detected congestion condition and may adjust an acknowledgment-window parameter to prevent a lower-priority flow from degrading a higher-priority flow. The processor may disable the proxy when the congestion condition clears and may operate without ACK modification when the access point does not proxy the flow.

In block 2912, the processor may transmit a performance report that encodes slice performance metrics to the AI slice controller.

In block 2914, the processor may retrain a local transformer on observed traffic and may transmit a model update to the AI slice controller and may coordinate with the controller to offload a portion of traffic to a cellular radio access network when capacity approaches a threshold.

In block 2916, the processor may enforce EDCA parameter adjustment, airtime allocation, queue weights, or DSCP remarking at a layer-3 boundary. Enforcement at the access point may not modify end-to-end TCP acknowledgments unless the device proxies the flow.

FIG. 30 illustrates a method 3000 for federated learning and synchronizing model parameters across distributed network nodes in accordance with some embodiments. Method 3000 may be performed by a processor in an edge device or Wi-Fi access points and an AI slice controller to synchronize learned parameters across deployments.

In block 3002, a processor in an edge device or Wi-Fi access point may generate tokens that encode device state and performance, may apply a local LNM to produce an initial configuration script, and may apply the script.

In block 3004, the processor may refine the script from telemetry and may export a model-delta vector.

In block 3006, an aggregator may receive model-delta vectors from multiple nodes, may compute a weighted aggregate, may validate the aggregate on a holdout dataset, and may reject outliers.

In block 3008, the aggregator may distribute updated parameters to nodes to synchronize local models.

In block 3010, the aggregator may prioritize aggregation based on congestion reduction, latency improvement, or bandwidth allocation goals derived from pooled metrics.

In block 3012, the aggregator may predict upcoming conditions from historical usage patterns and may emit guidance for pre-emptive adjustments.

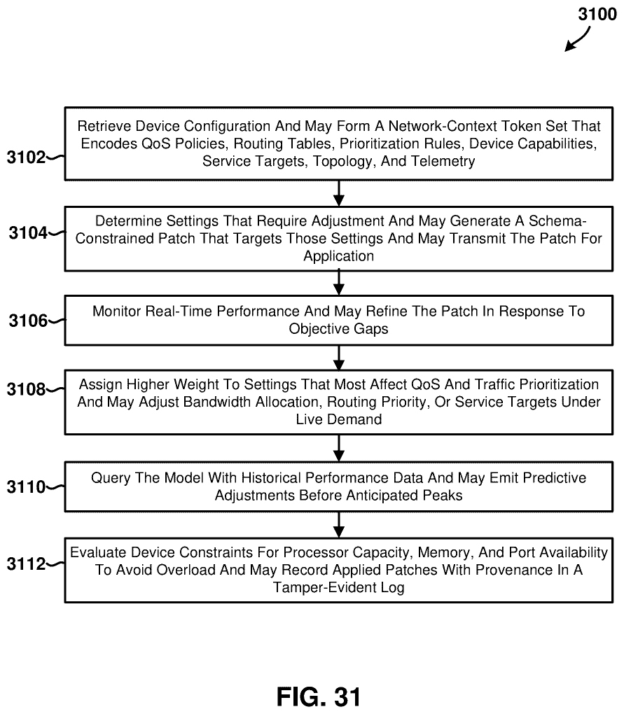

FIG. 31 illustrates a method 3100 for generating selective configuration patches with predictive weighting in accordance with some embodiments. Method 3100 may be performed by a processor in communication with an LNM to generate targeted schema-constrained patches.

In block 3102, the processor may retrieve device configuration and may form a network-context token set that encodes QoS policies, routing tables, prioritization rules, device capabilities, service targets, topology, and telemetry.

In block 3104, the processor may determine settings that require adjustment and may generate a schema-constrained patch that targets those settings and may transmit the patch for application. In some embodiments, the processor may target a subset of per-flow settings and may emit a patch that sets a per-flow committed rate, a burst size, and a queue weight.

In block 3106, the processor may monitor real-time performance and may refine the patch in response to objective gaps.

In block 3108, the model may assign higher weight to settings that most affect QoS and traffic prioritization and may adjust bandwidth allocation, routing priority, or service targets under live demand.

In block 3110, the processor may query the model with historical performance data and may emit predictive adjustments before anticipated peaks.

In block 3112, the processor may evaluate device constraints for processor capacity, memory, and port availability to avoid overload and may record applied patches with provenance in a tamper-evident log.

Some embodiments may include methods that convert service intent and live performance data into device-specific commands without manual translation. A controller or an edge device may encode service plans and telemetry as typed tokens with order and context. A transformer that holds network knowledge may read the tokens and output short patches that a device accepts as commands. The system may check safety and capacity before each change and roll back if a guard triggers. Edge devices may learn from local data and send small model updates to an aggregator that returns improved parameters for the entire fleet. These embodiments allow for consistent treatment across, for example, Wi-Fi, Ethernet, and cellular domains with fast closed-loop correction.

Unlike conventional automation solutions that push static templates or free-form text rules, the embodiments may type network tokens with positional encoding and a schema-constrained decoder that yields vendor-specific directives as transaction-safe patches. The selection operations may treat both problem features and algorithm features as first-class vectors and select a decoding strategy based on a correlation score rather than a fixed rule tree. A cross-domain mapping token may unify DSCP, 5QI, and Wi-Fi user priority under a single learned model so that the same service class receives consistent treatment across domains. Each directive may carry a provenance tag and land in a tamper-evident log that ties the emitted token to the applied action. A federated loop may train on local telemetry and ship compact model-delta vectors rather than raw data. This may preserve privacy while improving global behavior. The specific mix of typed tokens with positional order, schema-constrained decoding, bidirectional algorithm selection, auditable provenance, and federated updates departs from familiar configuration pipelines and template push systems.

Typed tokens may consolidate disparate telemetry and policy into compact inputs that a transformer may process in parallel, reducing control-plane latency. Schema-constrained decoding avoids syntax errors and reduces failed transactions. Delta patches edit a narrow set of parameters, which may lower risk and shorten commit time. Cross-domain mapping keeps quality of service treatment aligned, which may lower jitter and packet loss across Wi-Fi, cellular, Ethernet, etc. Edge autonomy sustains service during controller loss and reduces mean time to repair. Federated learning enhances model quality across deployments without requiring raw data export, potentially improving convergence and reducing bandwidth. The combined effect may enhance throughput and stability, while also shortening recovery time after a disturbance.

Some embodiments may include a system that includes an AI slice controller, a plurality of edge devices, and a plurality of Wi-Fi access points, wherein each component comprises a processor and a memory storing processor-executable instructions. The AI slice controller may initialize a global transformer model or NOTM that is configured as a LNM may establish connections to the plurality of edge devices and the plurality of Wi-Fi access points and may generate input tokens that represent SLAs, QoS targets, network element capabilities, and service context. The AI slice controller may apply position encoding to the input tokens to form an encoded input sequence, may input the encoded input sequence into the AI transformer to generate a configuration output sequence, may map the configuration output sequence into configuration directives, and may deploy the configuration directives to the plurality of edge devices and the plurality of Wi-Fi access points. Each edge device may obtain a set of network tokens that represent a SLA, a network element capability, and a service context, may apply position encoding to the set of network tokens to form an encoded token sequence, may input the encoded token sequence into a transformer model stored in the edge device to generate a configuration output sequence that defines local configuration actions, may execute the local configuration actions on a local network component to enforce a network slice quality-of-service target, and may transmit a feedback token set to the AI slice controller that encodes runtime performance metrics for the network slice. Each Wi-Fi access point may configure a plurality of virtual access point interfaces that are each mapped to a network slice, may apply bandwidth limits and quality-of-service parameters to the plurality of virtual access point interfaces based on tokens received from the AI slice controller, may classify traffic flows using dynamic flow inspection (DFI) and a local transformer model to determine an associated network slice, may schedule packets of the traffic flows according to the associated network slice, may detect congestion conditions that indicate a lower-priority traffic flow degrades a higher-priority traffic flow, may enforce differentiated scheduling that prioritizes the higher-priority traffic flow, and may transmit a performance report that encodes slice performance metrics to the AI slice controller. The AI slice controller may monitor the feedback token sets and performance reports and may adjust the configuration directives based on the monitored runtime performance data so that the system operates as a unified tokenized edge computing environment that enforces network slice SLAs across the plurality of edge devices and the plurality of Wi-Fi access points.

In some embodiments, an edge device (e.g., edge compute node, MEC server, etc.) may include a processor and a memory storing processor executable instructions, and the processor may execute a method that includes obtaining a set of network tokens that represent a SLA, a network element capability, and a service context. The processor may apply position encoding to the set of network tokens to form an encoded token sequence. The processor may input the encoded token sequence into an AI transformer configured as a NOTM that comprises an encoder and a decoder. The processor may generate, by the decoder, a configuration output sequence that defines a set of local configuration actions for a local network component coupled to the edge device. The processor may execute the set of local configuration actions on the local network component to enforce a network slice quality of service target. The processor may produce a feedback token set that encodes runtime performance metrics for the network slice and may transmit the feedback token set to an AI slice controller. The memory may further store instructions that instantiate a cLNM that inputs the encoded token sequence into the AI transformer. The memory may further store instructions that retrain the AI transformer on local data to produce a local model update and transmit the local model update to the AI slice controller for federated learning aggregation.

Some embodiments may include methods of edge device tokenized AI processing include obtaining, by the edge device, a set of network tokens that represent a SLA, a network element capability, and a service context, applying, by the edge device, position encoding to the set of network tokens to form an encoded token sequence, inputting, by the edge device, the encoded token sequence into an AI transformer configured as a NOTM that may include an encoder and a decoder, generating, by the decoder, a configuration output sequence that defines a set of local configuration actions for a local network component coupled to the edge device, executing, by the edge device, the set of local configuration actions on the local network component to enforce a network slice quality of service target, and producing, by the edge device, a feedback token set that encodes runtime performance metrics for the network slice and transmitting the feedback token set to an AI slice controller.

In some embodiments, obtaining, by the edge device, a set of network tokens may include obtaining an SLA token, a network element token, and a GST that identifies a service tier. In some embodiments, executing, by the edge device, the set of local configuration actions on the local network component may include configuring a local virtual switch or VLAN interface to apply a committed information rate and a peak information rate for the network slice. In some embodiments, generating, by the decoder, a configuration output sequence may include emitting an intermediate token set and transmitting the intermediate token set to a second transformer in a federated transformer pipeline. In some embodiments, producing, by the edge device, a feedback token set that encodes runtime performance metrics for the network slice may include encoding latency, throughput, packet loss, and queue depth values measured at the edge device.

Some embodiments may further include receiving, by the edge device, a model parameter update from the AI slice controller and updating, by the edge device, the AI transformer that inputs the encoded token sequence into the AI transformer. Some embodiments may further include retraining, by the edge device, the AI transformer that inputs the encoded token sequence into the AI transformer on local data to produce a local model update and transmitting, by the edge device, the local model update to the AI slice controller for federated learning aggregation. In some embodiments, executing, by the edge device, the set of local configuration actions on the local network component may include allocating compute resources to a containerized application associated with the network slice and pinning the application to a processor set on the edge device. In some embodiments, generating, by the decoder, a configuration output sequence that defines a set of local configuration actions may include generating a slice identifier, a bandwidth share, and a latency budget for the local network component. In some embodiments, inputting, by the edge device, the encoded token sequence into an AI transformer may include computing, by the AI transformer, self-attention across the position encoded tokens to generate the configuration output sequence. Some embodiments may further include storing, by the edge device, the configuration output sequence and the executed local configuration actions in a tamper-evident log that associates each executed local configuration action with a token provenance.

In some embodiments, executing, by the edge device, the set of local configuration actions on the local network component may include applying traffic shaping on a local interface by setting a token bucket rate, a burst size, and a buffer size according to the configuration output sequence. In some embodiments, obtaining, by the edge device, a set of network tokens may include forming the set of network tokens by tokenizing telemetry that may include per flow byte counts, inter arrival time statistics, and radio link quality indicators gathered by the edge device. In some embodiments, applying, by the edge device, position encoding to the set of network tokens may include assigning positional indices that preserve an order across the SLA token, the network element token, and the service context token.

In some embodiments, executing, by the edge device, the set of local configuration actions on the local network component may include applying queue depth settings and priority mappings for the network slice. In some embodiments, producing, by the edge device, a feedback token set that encodes runtime performance metrics for the network slice may include transmitting the feedback token set on a schedule that adapts to variance in the runtime performance metrics.

In some embodiments, an AI slice controller may include a processor and a memory storing processor executable instructions, and the processor may execute a method that includes initializing a global transformer model that is configured as a NOTM and establishing connections to network domains that include a radio access network, a Wi-Fi network, and a plurality of edge devices. The processor may generate a set of input tokens that represent SLAs, quality of service targets, network element capabilities, and service context. The processor may apply position encoding to the set of input tokens to form an encoded input sequence. The processor may input the encoded input sequence into the AI transformer to generate a configuration output sequence. The processor may map the configuration output sequence into configuration directives. The processor may deploy the configuration directives to the radio access network, the Wi-Fi network, and the plurality of edge devices. The processor may monitor runtime performance data from the radio access network, the Wi-Fi network, and the plurality of edge devices and may adjust the configuration directives based on the runtime performance data. The memory may further store instructions that update an input token that represents traffic load and re input the encoded input sequence into the AI transformer to generate an updated configuration output sequence. The memory may further store instructions that aggregate model updates received from the plurality of edge devices, retrain the global transformer model on the aggregated model updates, and deploy the retrained global transformer model to the plurality of edge devices.

Some embodiments include methods of AI slice controller orchestration, which may include initializing, by the AI slice controller, a global transformer model that may be configured as a NOTM and establishing, by the AI slice controller, connections to network domains that include a radio access network, a Wi-Fi network, and a plurality of edge devices, generating, by the AI slice controller, a set of input tokens that represent SLAs, quality of service targets, network element capabilities, and service context, applying, by the AI slice controller, position encoding to the set of input tokens to form an encoded input sequence, inputting, by the AI slice controller, the encoded input sequence into the AI transformer to generate a configuration output sequence, mapping, by the AI slice controller, the configuration output sequence into configuration directives, deploying, by the AI slice controller, the configuration directives to network components in the radio access network, the Wi-Fi network, and the plurality of edge devices, and monitoring, by the AI slice controller, runtime performance data from the network components and adjusting, by the AI slice controller, the configuration directives based on the runtime performance data.

In some embodiments, initializing, by the AI slice controller, a global transformer model that may be configured as a NOTM may include instantiating a cLNM that inputs the encoded input sequence into the AI transformer. In some embodiments, generating, by the AI slice controller, a set of input tokens that represent SLAs, quality of service targets, network element capabilities, and service context may include generating a set of input tokens that include a latency token, a throughput token, a 5G QoS identifier token, a radio unit capability token, and a GST. In some embodiments, mapping, by the AI slice controller, the configuration output sequence into configuration directives may include translating an output token into a slicing command for the radio access network and translating another output token into a scheduling parameter for a Wi-Fi access point. In some embodiments, deploying, by the AI slice controller, the configuration directives to network components may include calling a RIC to create a network slice, instructing an edge device to allocate compute resources, and configuring a Wi-Fi access point to assign a dedicated service set identifier. In some embodiments, monitoring, by the AI slice controller, runtime performance data from the network components may include collecting latency measurements, throughput values, packet loss counts, and device connectivity status, and in which adjusting, by the AI slice controller, the configuration directives based on the runtime performance data may include reallocating bandwidth or reassigning an application to a different edge device.

Some embodiments may further include updating, by the AI slice controller, an input token that represents current traffic load and re inputting, by the AI slice controller, the encoded input sequence into the AI transformer to generate an updated configuration output sequence. Some embodiments may further include aggregating, by the AI slice controller, model updates received from the plurality of edge devices, retraining, by the AI slice controller, the global transformer model on the aggregated model updates, and deploying, by the AI slice controller, the retrained global transformer model to the plurality of edge devices. In some embodiments, generating, by the AI slice controller, a set of input tokens that represent SLAs, quality of service targets, network element capabilities, and service context may further include generating input tokens that represent both a Wi-Fi domain and a cellular domain and in which inputting, by the AI slice controller, the encoded input sequence into the AI transformer to generate a configuration output sequence may include generating a unified cross domain configuration for both the Wi-Fi domain and the cellular domain.

Some embodiments may further include predicting, by the AI slice controller, an upcoming network demand event using a performance monitoring transformer, generating, by the AI slice controller, a proactive configuration output sequence for the upcoming network demand event, and deploying, by the AI slice controller, the proactive configuration output sequence before the upcoming network demand event occurs. Some embodiments may further include receiving, by the AI slice controller, an instruction to terminate a network slice, generating, by the AI slice controller, a teardown configuration output sequence that releases the resources of the network slice, and deploying, by the AI slice controller, the teardown configuration output sequence to the network components

In some embodiments, a Wi-Fi access point may include a processor and a memory storing processor executable instructions, and the processor may execute a method that includes configuring a plurality of virtual access point interfaces that are each mapped to a network slice. The processor may apply bandwidth limits and quality of service parameters to the plurality of virtual access point interfaces based on tokens received from an AI slice controller. The processor may receive token derived configuration directives from the AI slice controller. The processor may load the token derived configuration directives into a scheduler of the Wi-Fi access point. The processor may identify an incoming or outgoing traffic flow. The processor may classify the traffic flow using DFI and a local transformer model to determine an associated network slice. The processor may schedule packets of the traffic flow according to the associated network slice and the scheduler. The processor may detect a congestion condition that indicates a lower priority traffic flow degrades a higher priority traffic flow. The processor may enforce differentiated scheduling that prioritizes the higher priority traffic flow. The processor may transmit a performance report that encodes slice performance metrics to the AI slice controller. The memory may further store instructions that retrain the local transformer model on observed traffic data and transmit a model update to the AI slice controller. The memory may further store instructions that coordinate with the AI slice controller to offload a portion of the traffic flow to a cellular radio access network when the Wi-Fi access point approaches a capacity threshold.

Some embodiments include methods for Wi-Fi access point scheduler integration that include configuring, by the Wi-Fi access point, a plurality of virtual access point interfaces that are each mapped to a network slice, applying, by the Wi-Fi access point, initial bandwidth limits and quality of service parameters to the plurality of virtual access point interfaces based on tokens received from an AI slice controller, receiving, by the Wi-Fi access point, token derived configuration directives from the AI slice controller, loading, by the Wi-Fi access point, the token derived configuration directives into a scheduler of the Wi-Fi access point, identifying, by the Wi-Fi access point, an incoming or outgoing traffic flow, classifying, by the Wi-Fi access point, the traffic flow using DFI and a local transformer model to determine an associated network slice, scheduling, by the Wi-Fi access point, transmission of packets for the traffic flow according to the associated network slice and the scheduler, detecting, by the Wi-Fi access point, a congestion condition that indicates a lower priority traffic flow may be degrading a higher priority traffic flow, enforcing, by the Wi-Fi access point, differentiated scheduling that prioritizes the higher priority traffic flow, and transmitting, by the Wi-Fi access point, a performance report that encodes slice performance metrics to the AI slice controller.

In some embodiments, configuring, by the Wi-Fi access point, a plurality of virtual access point interfaces that are each mapped to a network slice may include instantiating a plurality of service set identifiers and mapping each service set identifier to a network slice. In some embodiments, applying, by the Wi-Fi access point, initial bandwidth limits and quality of service parameters may include applying a committed information rate and a peak information rate to at least one of the plurality of virtual access point interfaces. In some embodiments, receiving, by the Wi-Fi access point, token derived configuration directives from the AI slice controller may include receiving Enhanced Distributed Channel Access parameters that define contention windows for high priority and low priority traffic classes. In some embodiments, identifying, by the Wi-Fi access point, an incoming or outgoing traffic flow may include analyzing, by the Wi-Fi access point, a plurality of first packets of the traffic flow, tokenizing the plurality of first packets, and inferring an application category of the traffic flow using the local transformer model.

Enforcement at a Wi-Fi access point may not modify end-to-end TCP acknowledgments unless the device proxies the flow. Differentiated scheduling may use EDCA parameter adjustment, airtime allocation, queue weights, or DSCP remarking at a layer-3 boundary. A controller may push such parameters through the tokenized interface described in this document.

Some embodiments may further include retraining, by the Wi-Fi access point, the local transformer model on traffic data observed by the Wi-Fi access point and transmitting, by the Wi-Fi access point, a model update to the AI slice controller. Some embodiments may further include coordinating, by the Wi-Fi access point, with the AI slice controller to offload a portion of the traffic flow to a cellular radio access network when the Wi-Fi access point approaches a capacity threshold.

Some embodiments include methods of configuring and managing a network device using a transformer model and network control function (NCF), which may include invoking, by a processor, a transformer model in response to a request from a NCF, in which the request specifies a network management task such as QoS evaluation or policy enforcement, processing, by the transformer model, the input tokens representing network elements and performance data to generate a configuration script, in which the transformer model uses a large network model (LNM) to select the most appropriate algorithm based on the problem set, sending, by the NCF, the generated configuration script to the network device, in which the network device executes the script to adjust its configuration, continuously monitoring, by the NCF, the network device to verify that the configuration changes achieve objectives, in which the objectives include at least performance optimization and traffic prioritization, and updating, by the transformer model, the configuration script in response to determining that the monitoring data indicates that the objectives are not met, in which the updated script may be sent to the network device for reconfiguration. In some embodiments, the NCF operates in a cloud based environment, and the transformer model may be invoked from a cloud based server to process the configuration request and generate the configuration script. In some embodiments, the transformer model refines the configuration script by using a feedback loop that continuously incorporates real time performance data, and the performance data may include at least latency, bandwidth usage, and packet loss statistics. In some embodiments, the NCF prioritizes the processing of input tokens based on environmental factors (e.g., network congestion, device proximity, and available bandwidth, etc.) to dynamically adjust the configuration script. In some embodiments, the LNM uses federated learning to aggregate knowledge from multiple network devices and the aggregated knowledge may be used to improve the accuracy and adaptability of the selected algorithm for future configuration patches. In some embodiments, the transformer model generates selective configuration updates for the network device so that only the specific network parameters needing adjustment are modified (to reduce processing overhead and improve system efficiency). Some embodiments may further include using positional information derived from the network device's MAC address and device identification to select the algorithm for generating the configuration script within the LNM.

Some embodiments include methods of configuring and managing a network device using a transformer model and NCF, which may include invoking, by a processor, a transformer model in response to a request from a NCF, in which the request specifies a network management task such as QoS evaluation or policy enforcement, processing, by the transformer model, the input tokens representing network elements and performance data to generate a configuration script, in which the transformer model uses a large network model (LNM) to select the most appropriate algorithm based on the problem set, sending, by the NCF, the generated configuration script to the network device, in which the network device executes the script to adjust its configuration, continuously monitoring, by the NCF, the network device to verify that the configuration changes achieve objectives, in which the objectives include at least performance optimization and traffic prioritization, and updating, by the transformer model, the configuration script in response to determining that the monitoring data indicates that the objectives are not met, in which the updated script may be sent to the network device for reconfiguration. In some embodiments, the NCF operates in a cloud-based environment, and the transformer model may be invoked from a cloud-based server to process the configuration request and generate the configuration script. In some embodiments, the transformer model refines the configuration script by using a feedback loop that continuously incorporates real-time performance data, and the performance data may include at least latency, bandwidth usage, and packet loss statistics. In some embodiments, the NCF prioritizes the processing of input tokens based on environmental factors (e.g., network congestion, device proximity, and available bandwidth, etc.) to dynamically adjust the configuration script. In some embodiments, the LNM uses federated learning to aggregate knowledge from multiple network devices and the aggregated knowledge may be used to improve the accuracy and adaptability of the selected algorithm for future configuration patches. In some embodiments, the transformer model generates selective configuration updates for the network device so that only the specific network parameters needing adjustment are modified (to reduce processing overhead and improve system efficiency). Some embodiments may further include using positional information derived from the network device's MAC address and device identification to select the algorithm for generating the configuration script within the LNM.

Some embodiments include methods of dynamically configuring and managing a network device in a network environment using a generative AI model, which may include retrieving, by a processor, device information of the network device, in which the device information may include at least a media access control (MAC) address, device identification (ID), manufacturer, and model number, generating, by the processor, a problem set based on the device information and network configuration needs, in which the problem set may include a specific network management task (e.g., such as quality of service (QoS) analysis, etc.), matching, by the processor, the problem set to an algorithm within a large network model (LNM), in which the LNM may be configured to process network tokens representing network elements, performance data, and service requirements, generating, by the LNM, a configuration script based on the matched algorithm and problem set, in which the configuration script may include routing table adjustments, QoS policies, and traffic prioritization rules, sending, by the processor, the configuration script to the network device to implement the configuration adjustments based on the configuration script, monitoring, by the processor, real-time performance data of the network device to verify network objectives are met, in which the real-time performance data may include at least traffic flow metrics, latency, and packet loss statistics, and refining, by the processor, the configuration script in response to determining that the performance data indicates the network objectives are not met, in which the refinement may include reprocessing the problem set and selecting a better-matching algorithm within the LNM. In some embodiments, the problem set may include performing a QoS analysis, and the LNM selects an algorithm tailored to the QoS evaluation based on the manufacturer and model number of the network device. In some embodiments, the LNM may be configured to match the problem set to the algorithm using positional information derived from the MAC address, device ID, and manufacturer of the network device. In some embodiments, the refinement of the configuration script may be performed using a feedback loop that continuously updates the problem set based on real-time network performance data, and the feedback loop iteratively refines the selected algorithm within the LNM to improve network performance. In some embodiments, the environmental factors include at least network congestion, available bandwidth, and device proximity within the network, and the LNM processes the adjustment. In some embodiments, the LNM uses federated learning to improve the accuracy of the selected algorithm, and localized knowledge from multiple network devices may be aggregated in a cloud-based model and shared across the network to enhance configuration patches. In some embodiments, the configuration script may include selective updates to only those network parameters needing adjustment, and the selective updates are prioritized based on the importance of network services.

Some embodiments include methods of federated learning and dynamic network management in a communication network, which may include generating, by a processor, network tokens representing network elements and real-time performance data for a local network device, in which the performance data may include traffic flow, latency, and packet loss, sending, by the processor, the network tokens to a local large network model (LNM) for processing, in which the LNM generates an initial configuration script for the network device based on the local data, sending, by the processor, the configuration script to the network device to implement the configuration adjustments, transmitting, by the processor, localized knowledge from the local LNM to a cloud-based LNM, in which the cloud-based LNM integrates the localized knowledge from multiple local networks for global enhancement, receiving, by the processor, updated configuration information from the cloud-based LNM, in which the updated configuration may be used to further enhance the network device based on aggregated knowledge from the cloud model. In some embodiments, the cloud-based LNM updates the local LNM using a federated learning framework, and the updated configuration information may be sent back to the local network device (to improve performance and synchronization across the network). In some embodiments, the local LNM operates within an edge device in the network, and the localized knowledge may include real-time network performance data for multiple devices within the network environment. In some embodiments, the positional information may be derived from the MAC address, device ID, manufacturer, and model number of the network device. In some embodiments, the local LNM independently refines its configuration script prior to transmitting localized knowledge to the cloud-based LNM. In some embodiments, the cloud-based LNM prioritizes global enhancement tasks based on aggregated performance metrics from multiple local network devices, and the prioritization may be based on at least traffic congestion, latency reduction, and bandwidth allocation. In some embodiments, the localized knowledge transmitted to the cloud-based LNM may include historical performance data and usage patterns of the network device. The cloud-based model uses this localized knowledge to predict future network conditions and pre-emptively adjust configuration patches.

Some embodiments include methods of enhancing configuration patches for a network device using weighted information and an AI-based system, which may include retrieving, by a processor in communication with a large network model (LNM), configuration information for the network device, in which the configuration information may include specific device settings such as QoS policies, routing tables, and traffic prioritization rules, determining, by the processor, whether certain configuration settings need to be updated, in which only the settings identified for adjustment by the LNM are selected for modification, generating, by the processor, a configuration script based on the selected settings, in which the configuration script may include changes for specific ports, services, or QoS settings as processed by the LNM, and sending, by the processor, the configuration script to the network device, in which the network device applies only the specified changes without reconfiguring previously adjusted settings. Some embodiments may further include monitoring, by the processor and the LNM, real-time network performance to verify that the modified settings achieve predefined objectives, and refining the configuration script based on results of the monitoring and updated performance data processed by the LNM. In some embodiments, the LNM determines the weighting of configuration information based on the importance of settings to overall network performance (e.g., with higher weight assigned to settings related to QoS and traffic prioritization, etc.). In some embodiments, the configuration script may include dynamic adjustments to bandwidth allocation, routing priorities, or SLAs based on real-time traffic demands and latency thresholds. Some embodiments may further include using historical performance data to query the LNM and using the query results to predict future network conditions and pre-emptively adjust the configuration script. In some embodiments, the LNM prioritizes services by assigning higher weight to configuration settings that relate to critical services. In some embodiments, the configuration script may be enhanced based on device-specific constraints (e.g., processing power, available memory, port availability, etc.) so that the changes do not overload the network device.

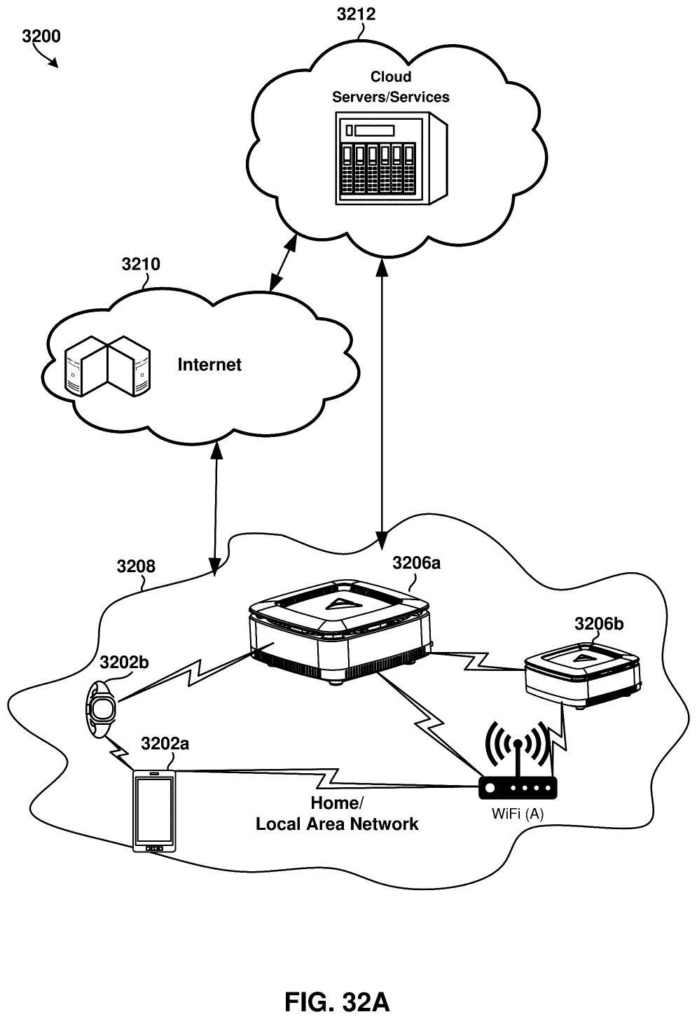

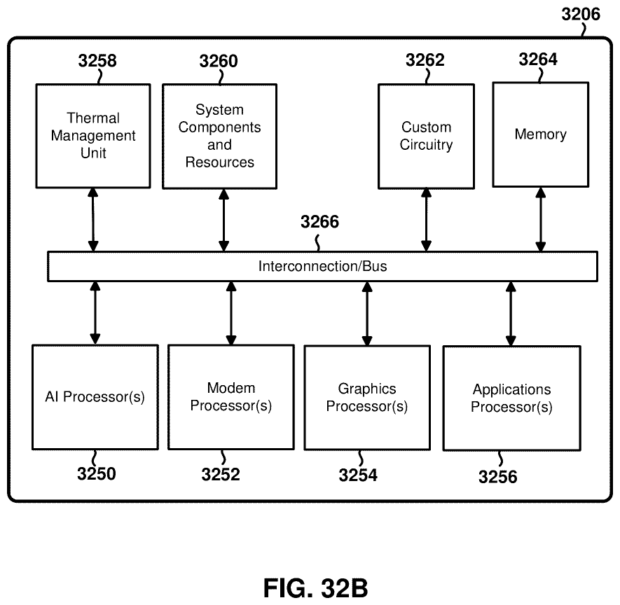

FIG. 32A illustrates an edge computing system 3200 that hosts transformer-driven control for heterogeneous networks. User computing devices 3202a and 3202b exchange traffic with edge devices 3206a to 3206c over a local network 3208 and the network links to Internet 3210 and cloud services 3212. Each edge device may run a network orchestration transformer model (NOTM) and a network control function (NCF) with an optional large network model (LNM). The system may form network-context tokens for device capability service targets policy and telemetry and may generate schema-constrained configuration patches for routers switches and Wi-Fi access points. Cloud services 3212 may host an AI slice controller (AISC) that aggregates model-delta vectors and distributes validated parameters.

Edge computing system 3200 may address processor and memory limits on user computing devices 3202a and 3202b during tokenization and transformer inference. The system may offload token creation inference and patch generation to edge devices 3206a to 3206c or to cloud services 3212. Delegation of NOTM operations may lower latency and energy on user computing devices and may sustain closed-loop control at the edge.

Edge devices 3206a to 3206c may share compute and accelerator resources as a mesh. The mesh may allocate cgroups and device adapters to NOTM pods based on workload and policy. Placement may favor nodes with proximity to traffic sources and available bandwidth and may improve response time for KPI-driven patch emission.

Edge devices 3206a to 3206c may use homogeneous or heterogeneous architectures. Homogeneous nodes may share platform and firmware and heterogeneous nodes may use different operating systems hardware and storage. Some embodiments may group edge devices as a processor cluster with synchronous or asynchronous update cycles for local SLNMs and NOTM runtimes.

FIG. 32B illustrates edge device 3206 with modules that support tokenized control and federated learning at the edge. Modules include an AI processor 3250 a modem processor 3252 a graphics processor 3254 an application processor 3256 memory 3264 custom circuitry 3262 system components and resources 3260 a thermal unit 3258 and an interconnect 3266. The device may conduct arithmetic logic control and I O through these modules. The AI processor may execute embedding attention and constrained decoding for a NOTM and the application processor may host an NCF and device adapters. The modem processor may collect radio KPIs and link state for token generation and the graphics processor may accelerate transformer layers when available. Memory 3264 may store model weights tokens and tamper-evident logs. Interconnect 3266 may implement a NoC for high bandwidth exchange among processors memory and accelerators. The thermal unit 3258 may cap throughput or adjust clocks to sustain inference under load. Custom circuitry 3262 may include security anchors for secure boot and attestation with cryptographic material for container verification.

The AI processor 3250 may include tensor units that accelerate matrix multiplication attention projection and activation functions in transformer blocks. These capabilities may support near real-time anomaly detection natural language processing and object recognition when such functions align with local policy.

In some embodiments the AI processor 3250 may include a neural processing unit or a neural network processing unit or similar accelerators for machine learning. These components may speed local training updates for SLNMs and may lower latency for NOTM decoding.

Processors 3250 3252 3254 and 3256 may include multiple cores that run tasks in parallel. Edge device 3206 may run FreeBSD or Linux or Windows per processor role. The processors may participate in a cluster that supports distributed NOTM and NCF tasks.

Processors 3250 3252 3254 and 3256 may exchange data with memory 3264 system components and resources 3260 custom circuitry 3262 and thermal unit 3258 through interconnect 3266. The interconnect may use a bus or reconfigurable logic or a NoC and may carry token streams model weights and telemetry at high rate.

The thermal unit 3258 may monitor temperature and power draw and may adjust performance of the processors to prevent overheating and to maintain stable inference during peaks.

System components and resources 3260 and custom circuitry 3262 may support sensors conversion and wireless interfaces. Elements may include power amplifiers voltage regulators temperature sensors memory controllers and oscillators. Custom circuitry 3262 may expose interfaces to external peripherals and to secure elements that store provenance anchors for logs.

Edge device 3206 may include an I O module that links to clocks and regulators and these external resources may be shared across internal processors and cores.

Embodiments may deploy on SoCs or SiPs or single processors or multiple processors or multicore processors. These systems may integrate functions described for edge device 3206 and may support token generation transformer inference schema-constrained patching and federated updates in a distributed edge environment.

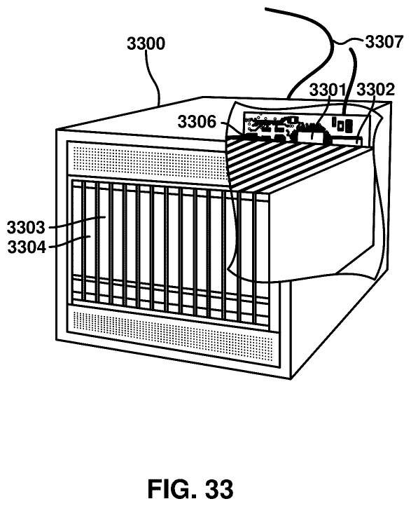

An edge deployment may include multiple edge computing systems joined as a mesh. The environment may be heterogeneous. Devices may differ by CPU type RAM storage radio support wired support kernel features and kernel version. Identical hardware may run different software versions. A role election process may assign a lead node for local aggregation and may rotate the role based on load and health. All or portions of some embodiments may be implemented in the cloud or on a variety of commercially available computing devices, such as the server computing device 3300 illustrated in FIG. 33. The server device 3300 may include a SoC 3300 or one or more processors 3302 (e.g., multi-core processor, etc.) coupled to memory 3304, storage interfaces 3306 such as USB ports and NVMe slots, and network access ports 3308 that allow data connections through a network interface card (NIC) 3310 and a communication network 3312 (e.g., an Internet Protocol (IP) network) connected to other network elements.

All or portions of the embodiments may execute in the cloud on a server device 3300 shown in FIG. 33. Server device 3300 includes a system on chip 3300 or processors 3302 with memory 3304 storage interfaces 3306 and network ports 3308 that link through a NIC 3310 to a network 3312. The server may host a cLNM a NOTM runtime and an AISC that aggregates model-delta vectors validates aggregates on a holdout dataset and distributes updated parameters to edge devices. The server may store tamper-evident logs and model artifacts and may enforce mTLS and container signing.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. may be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor or a combination of processors configured by software instructions to perform functions described in this document. Servers often include multiple processors and may assign dedicated processors for cloud operations, data analytics, or wireless functions. Software applications may reside in internal memory before execution by the processor. Modern processors may include large internal memory augmented with cache memory to store and process application instructions.

As used in this application, terminology such as “component,” “module,” “system,” etc., is intended to encompass a computer related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or may be distributed across multiple processors or cores. In addition, these components may operate based on various non volatile computer readable media that store diverse instructions and/or data structures. Communication between components may take place through local or remote processes, function, or procedure calls, electronic signaling, data packet exchanges, memory interactions, among other known methods of network, computer, processor, or process related communications.

A variety of memory types and technologies, both currently available and anticipated for future development, may be incorporated into systems and computing devices that implement the various embodiments. These memory technologies may include non volatile random access memories (NVRAM) such as magnetoresistive RAM (MRAM), resistive random access memory (ReRAM or RRAM), phase change memory (PCM, PC RAM, or PRAM), ferroelectric RAM (FRAM), spin transfer torque magnetoresistive RAM (STT MRAM), and three dimensional cross point (3D XPoint) memory. Non volatile or read only memory (ROM) technologies may also be included, such as programmable read only memory (PROM), field programmable read only memory (FPROM), and one time programmable non volatile memory (OTP NVM). Volatile random access memory (RAM) technologies may further be utilized, including dynamic random access memory (DRAM), double data rate synchronous dynamic random access memory (DDR SDRAM), static random access memory (SRAM), and pseudostatic random access memory (PSRAM). Additionally, systems and computing devices implementing these embodiments may use solid state non volatile storage mediums, such as FLASH memory. The aforementioned memory technologies may store instructions, programs, control signals, and/or data for use in computing devices, system on chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general purpose processor, a digital signal processor (DSP), an application specific integrated circuit (ASIC), a field programmable gate array (FPGA), a graphics processing unit (GPU), a tensor processing unit (TPU), or other programmable logic devices, discrete gate or transistor logic, discrete hardware components, or any combination thereof, designed to perform the functions described. A general purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non transitory computer readable medium or non transitory processor readable medium. The operations of a method or algorithm disclosed herein may be embodied in a processor executable software module that resides on a non transitory computer readable or processor readable storage medium. Non transitory computer readable or processor readable storage media include any storage media that may be accessed by a computer or processor. By way of example, but not limitation, such non transitory computer readable or processor readable media may include RAM, ROM, EEPROM, flash memory, SSDs, NVMe drives, 3D NAND flash, or any other medium capable of storing program code in the form of instructions or data structures that may be accessed by a computer. Cloud based storage solutions, including infrastructure as a service (IaaS) platforms, may provide scalable and distributed options for storing and accessing program code. In addition, the operations of a method or algorithm may reside as one or more sets of instructions or code on a non transitory processor readable or computer readable medium, which may be incorporated into a computer program product. Emerging technologies, such as quantum computing storage media and blockchain based storage solutions, may enhance data integrity and security. AI and ML optimized hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method executed by one or more processors of a network control function (NCF) that operate an integrated control path for a target network device, the method comprising:
receiving a request that identifies a network management task and associated service targets;
forming a token set comprising schema-defined tokens that represent network context, wherein the network context includes the service targets and at least one or more of device capability, policy, topology, or telemetry;
assigning positional encodings to the token set to generate an ordered token sequence;
invoking a transformer model to process the ordered token sequence and to generate a configuration patch;
validating the configuration patch via a schema-constrained decoder that enforces a device grammar;
applying the configuration patch to the target network device;
reading back applied device state and telemetry from the target network device to obtain a read-back state;
determining whether the telemetry deviates from the service targets; and
generating a further configuration patch that modifies only a bounded subset of parameters relative to the read-back state responsive to determining that the telemetry deviates from the service targets.

2. The method of claim 1, wherein executing the transformer model to process the ordered token sequence and to generate the configuration patch further comprises:
invoking, by one or more processors, a large network model (LNM) that computes embeddings;
computing, by the LNM, embeddings of a problem-feature vector derived from the ordered token sequence and embeddings of a plurality of algorithm-feature vectors maintained by the LNM;
determining, by the LNM, a similarity score between the problem-feature vector embedding and each algorithm-feature vector embedding and selecting a configuration algorithm responsive to determining a similarity score meets a defined threshold; and
generating, by the transformer model, the configuration patch according to the selected configuration algorithm.

3. The method of claim 2, further comprising updating the LNM by receiving validated parameters from an aggregator that computes a weighted average of model-delta vectors and validates on a holdout dataset.

4. The method of claim 1, wherein assigning positional encodings further comprises assigning weighting values that bias attention toward tokens representing congestion, device proximity, or available bandwidth.

5. The method of claim 1, wherein generating the further configuration patch comprises computing a difference between an intended state and the read-back state.

6. The method of claim 1, wherein validating the configuration patch comprises verifying token types, field ranges, and command order against a device grammar.

7. The method of claim 1, wherein the configuration patch comprises an ordered sequence of device-specific commands in a syntax selected from command line interface (CLI), yet another next generation (YANG) data modelling language, JavaScript object notation (JSON) format, or application programming interface (API) calls.

8. The method of claim 1, wherein applying the configuration patch further comprises executing rollback guards responsive to a failed precondition.

9. The method of claim 1, wherein further comprising attaching provenance metadata comprising a hash, timestamp, and model version identifier to each configuration patch.

10. The method of claim 1, wherein the transformer model enforces per-token positional encodings that preserve dependency among device capability, policy, and telemetry tokens.

11. A computing system, comprising:
a processing system comprising one or more processors configured to:
receive a request that identifies a network management task and associated service targets;
form a token set comprising schema-defined tokens that represent network context, wherein the network context includes the service targets and at least one or more of device capability, policy, topology, or telemetry;
assign positional encodings to the token set to generate an ordered token sequence;
invoke a transformer model to process the ordered token sequence and to generate a configuration patch;
validate the configuration patch via a schema-constrained decoder that enforces a device grammar;
apply the configuration patch to the target network device;
read back applied device state and telemetry from the target network device to obtain a read-back state;
determine whether the telemetry deviates from the service targets; and
generate a further configuration patch that modifies only a bounded subset of parameters relative to the read-back state responsive to determining that the telemetry deviates from the service targets.

12. The computing system of claim 11, wherein the processing system is configured to generate the further configuration patch by computing a difference between an intended state and the read-back state.

13. The computing system of claim 11, wherein the processing system is configured to validate the configuration patch by verifying token types, field ranges, and command order against a device grammar.

14. The computing system of claim 11, wherein the processing system is configured to generate the configuration patch by invoking the transformer model to generate an ordered sequence of device-specific commands in a syntax selected from command line interface (CLI), yet another next generation (YANG) data modelling language, JavaScript object notation (JSON) format, or application programming interface (API) calls.

15. The computing system of claim 11, wherein the processing system is configured to apply the configuration patch by executing rollback guards responsive to a failed precondition.

16. A non-transitory processor-readable medium having stored thereon processor-readable instructions configured to cause one or more processors of a network control function (NCF) that operate an integrated control path for a target network device to perform operations, the operations comprising:
receiving a request that identifies a network management task and associated service targets;
forming a token set comprising schema-defined tokens that represent network context, wherein the network context includes the service targets and at least one or more of device capability, policy, topology, or telemetry;
assigning positional encodings to the token set to generate an ordered token sequence;
invoking a transformer model to process the ordered token sequence and to generate a configuration patch;
validating the configuration patch via a schema-constrained decoder that enforces a device grammar;
applying the configuration patch to the target network device;
reading back applied device state and telemetry from the target network device to obtain a read-back state;
determining whether the telemetry deviates from the service targets; and
generating a further configuration patch that modifies only a bounded subset of parameters relative to the read-back state responsive to determining that the telemetry deviates from the service targets.

17. The non-transitory processor-readable medium of claim 16, wherein the stored processor-readable instructions are configured to cause the processing system to perform operations such that generating the further configuration patch comprises computing a difference between an intended state and the read-back state.

18. The non-transitory processor-readable medium of claim 16, wherein the stored processor-readable instructions are configured to cause the processing system to perform operations such that validating the configuration patch comprises verifying token types, field ranges, and command order against a device grammar.

19. The non-transitory processor-readable medium of claim 16, wherein the stored processor-readable instructions are configured to cause the processing system to perform operations such that generating the configuration patch comprises invoking the transformer model to generate an ordered sequence of device-specific commands in a syntax selected from command line interface (CLI), yet another next generation (YANG) data modelling language, JavaScript object notation (JSON) format, or application programming interface (API) calls.

20. The non-transitory processor-readable medium of claim 16, wherein the stored processor-readable instructions are configured to cause the processing system to perform operations such that applying the configuration patch further comprises executing rollback guards responsive to a failed precondition.
